(19) United States
(12) Patent Application Publication
(10) Pub. No.: US 2008/0239957 A1
(43) Pub. Date: Oct. 2, 2008

(54) Ransmission Capacity Allocation Method, Communications Network, and Network Resource Management Device

(76) Inventors: Nobuyuki Tokura, Kanagawa (JP); Keisuke Inoue, Kanagawa (JP); Haruo Yago, Kanagawa (JP)

Correspondence Address: SMITH, GAMBRELL & RUSSELL, 1130 CONNECTICUT AVENUE, N.W., SUITE 1130, WASHINGTON, DC, 20036, US

(21) Appl. No.: 10/562,696

(22) PCT Filed: Jul. 7, 2004
(86) PCT No.: PCT/JP2004/009634

§ 371 Date: Jun. 4, 2008

(30) Foreign Application Priority Data
Jul. 7, 2003 (JP) 2003-271474
Jul. 31, 2003 (JP) 2003-283871
Sep. 26, 2003 (JP) 2003-334662

(51) Int. Cl. G08C 15/00

(52) U.S. Cl. 370/235

(57) ABSTRACT

The invention implements inter-terminal transmission with guaranteed capacity based on the single-path configuration function of networks composed of switching hubs with an MAC address learning function and centralized management of transmission capacity, without control over hubs. The capacity to be used by transmission links on a network is stored in advance and transmission capacity along the path to be used is allocated based on requests from terminals, with the allocation removed using a Terminate Request. At such time, by using transmission links and switching hubs with an MAC address learning function, transmission is limited to single-path transmission.

### TECHNICAL FIELD

The present invention relates to network resource management used to provide real-time services, for which QoS (Quality of Service) is required, such as video communication, voice conversations, streaming, etc. In particular, the present invention relates to allocation of transmission capacity for communication, and to management thereof, performed by deciding the values of the maximum frame (packet) rate and the maximum transmission delay time on Ethernet (registered trademark) networks.

### BACKGROUND ART

The IEEE 802.1Q/p standard for VLANs (Virtual LANs) is used to provide services requiring QoS on Ethernet networks. According to this standard, frames are provided with priority control tags, with each frame classified into eight types of priority: highest-priority Network Management, Voice, Video, Controlled-Load, Excellent Effort, Best Effort, Spare, and lowest-priority Background. The priority is used to perform transmission with priority processing in network nodes such as hubs, bridges, routers, etc., starting from the higher levels. With regard to sequence control, there have been various proposals, including strict priority processing, WFQ (Weighted Fair Queuing), etc.

However, the problem is that when traffic increases only in terms of high-priority traffic and nodes become overloaded, the chosen transmission quality (QoS) is impossible to attain because of impartial processing at the same priority.

To address the issue, the IETF has proposed a method for ensuring QoS through resource reservation based on RSVP (Resource Reservation Protocol: RFC 2205), Intserv (Integrated Service), etc. Although such methods can be used for implementation, they require resource reservation processing in the nodes (at least nodes that may become congested) located along the communication path (with path selection being another problem). At present, due to the need to perform such operations for each call request, these methods are deemed too complex and are not widely used. Similar operations are performed in modern public telephone networks and are seen as complicated even without taking call charge calculation into consideration.

For example, Patent Document 1 describes a method, in which virtual channels are configured between terminals in an ATM network in advance and communication with guaranteed capacity is carried out between the terminals on the virtual channels using a configuration utilizing channel capacity management means deployed at the edge of the network (at the junctions between the network and the terminals) and a link idle capacity database for the virtual channels (centralized configuration). Although this method permits centralized management of idle resources on the network, the need to configure the virtual channels, i.e. the managed objects, in advance creates the problem of managing high-capacity virtual channels or the problem of imposing limitations on correspondents.

Patent Document 1: JP H7-221763A

### DISCLOSURE OF INVENTION

The primary task in eliminating these problems is path discovery on the network. On Ethernet networks, as a result of the tree topology (including path topology), multiple paths are not generated, but network resources are wasted when flooding (frames being relayed to all the transmission links except for the input transmission link) occurs in a node (hub). A second task consists in management of transmission link capacity allocation along the path. It should be noted that this task can be accomplished by deploying buffer capacity that prevents buffer overflow under conditions of concentration in output transmission links in order to avoid node congestion.

Moreover, in a transmission network (composed of transmission links and hubs) linking Ethernet terminals, transmission link (path) management and management of the transmission capacity (frame rate) to be used by the transmission links become necessary in order to set the maximum delay time (the total of the propagation delay of the transmission links and the send latency, when there is no buffer overflow (congestion) in the hub).

The present invention was made in the context of the background outlined above, and an object thereof is to provide a transmission capacity allocation method capable of allocating transmission capacity between terminals without control over hubs, based on the single-path configuration function of Ethernet networks composed of switching hubs with an MAC (Media Access Control) address learning function and centralized management of transmission capacity, a communications network performing such transmission capacity allocation, and a network resource management device performing such transmission capacity allocation on a network.

According to the first aspect of the present invention, there is provided a transmission capacity allocation method for configuring a path with guaranteed transmission capacity between a call request terminal and a call requested terminal via one or more switching hubs learning the respective MAC addresses of the terminals in communication with each other and configuring a single path between the learned terminals, wherein: network resource management means managing the connections between the terminals and the switching hubs, as well as between the switching hubs, and the transmission capacity of the transmission links associated with the connections, is provided on the network; the call request terminal transmits a call request containing information on the transmission capacity whose allocation is requested in order to perform communication, along with its own terminal address and the address of the call requested terminal; the network resource management means, in response to the call request from the call request terminal, makes an assessment as to whether transmission capacity to be used can be assured along the path traversing switching hubs between the call request terminal and the call requested terminal and transmits the call request to the call requested terminal if it can be assured, or transmits an incoming call rejection to the call request terminal if it cannot be assured; the call requested terminal transmits a receive acknowledgement to the call request terminal through the network resource management means if it is itself communication-enabled, and transmits a call rejection if it is itself communication-disabled; the network resource management means, along with forwarding a receive acknowledgement or a call rejection from the call requested terminal to the corresponding call request terminal, releases transmission capacity assured for the call request associated with a call rejection when a call rejection is received from the call requested terminal; the call request terminal, upon receipt of the receive acknowledgement from the call requested terminal, recognizes that communication with guaranteed transmission capacity has been established and initiates transmission of data frames to the call requested terminal; the call request terminal or the call requested terminal, upon completion of communication, transmits a clear request to a peer terminal via the network resource management means; and, upon receipt of the clear request, the network resource management means releases transmission capacity in case transmission capacity corresponding to the clear request has been assured.

It is preferable that, during communication with the call requested terminal, if necessary, the call request terminal should request changes in the transmission capacity of the communication path, and, in response to this request, the network resource management means should change the transmission capacity of the communication path to the extent that the maximum assurable capacity is not exceeded.

It is preferable that, along with the receive acknowledgement, the call requested terminal should request allocation of transmission capacity in the direction of the call request terminal from the call requested terminal, and in response to this request, the network resource management means should make an assessment as to whether the transmission capacity can be assured and notify said call requested terminal of the results.

The call request terminal is preferably a terminal carrying out stream data delivery service, and the call requested terminal, prior to receiving the stream data delivery service, provides a notification regarding completion of preparations for receiving the delivery service using a broadcast frame or a frame destined for the call request terminal, and, in response to the notification, the switching hubs along the path between the call request terminal and the call requested terminal finish learning the MAC address of the call requested terminal.

While communication is in progress, at intervals within the aging time of the MAC address learning function of the switching hubs on the network, the call requested terminal preferably transmits data of at least one frame to the call request terminal, and the switching hubs along the path between the call request terminal and the call requested terminal continue learning the MAC address of the call requested terminal using the data of at least one frame.

The network resource management means manages the usage status of VLAN (Virtual Local Area Network) identifiers represented by TCI (Tag Control Information), and, when a receive acknowledgement is forwarded from the call requested terminal to the call request terminal, along with attaching a VLAN tag containing TCI corresponding to an unused VLAN identifier to the receive acknowledgement, stores the VLAN identifier as being in use; the call request terminal reads the VLAN identifier from the VLAN tag attached to the receive acknowledgement obtained from the network resource management means and, when transmitting a frame to the call requested terminal, attaches a VLAN tag thereto that corresponds to the VLAN identifier that has been read; if a VLAN tag is attached to the received frame, the switching hubs learn the source MAC address and the VLAN identifier as a pair when carrying out MAC address learning for the frame and set the VLAN identifier with a time-out period in the input ports that received the received frame and the output ports selected during forwarding; the call request terminal, in order to maintain the VLAN set up by the switching hubs, transmits one or more frames, to which VLAN tags corresponding to the VLAN are attached, within the time-out period; upon receipt of a frame with a VLAN tag attached thereto from the call request terminal, the call requested terminal reads the VLAN identifier from the VLAN tag, and, when a frame is transmitted to the call request terminal, a VLAN tag corresponding to the VLAN identifier that has been read is attached thereto, and, when the call request terminal or the call requested terminal cuts off communication with the peer terminal, it transmits a clear request to the network resource management means by attaching thereto a VLAN tag corresponding to the VLAN identifier that has been used for communication and stops attaching VLAN tags to frames upon transmission of the clear request; and, upon receipt of the clear request with a VLAN tag attached thereto, the network resource management means can store the VLAN identifier as being unused.

It is preferable to allocate transmission capacity in advance even to currently unused communication paths that may be switched to in the future by the spanning tree protocol, which rebuilds networks so logical loops are not formed even though the physical networks may form loops.

Namely, if the spanning tree protocol is used to avoid loops between the switching hubs, transmission capacity is allocated not only to paths traversing transmission links configured and made available by the spanning tree protocol; in this case, transmission links configured as backup links or all the loop-forming transmission links are allocated the same transmission capacity as the available links. As a result, even if available transmission links are disconnected and converted into backup links, communication with guaranteed maximum transmission capacity is possible and data transmission can be carried out without a decrease in throughput due to changes in topology resulting from elimination, addition, failure, or recovery, etc. of transmission links. Similar resource management is also possible during operation under the multiple spanning tree protocol (IEEE 802.1s), which is adapted for avoiding loops in a VLAN (Virtual LAN) environment. It is possible even if paths in the duplicate portions of the spanning tree form dependency relationships or bridge structures in addition to containment relationships.

When a switching hub detects a transmission link switchover by the spanning tree protocol, the switching hub uses an SNMP trap to inform the network resource management device of the fact that it has detected a transmission link switchover, thereby letting it know about the current transmission link to be used.

When the currently used communication path overlaps with a currently unused communication path that may be switched to in the future, it is preferable to prohibit allocation of transmission capacity to said currently unused communication path. Because data transmission is performed using said currently unused communication path that may be switched to in the future only when data transmission across the currently used communication path becomes impossible, there is no need to allocate transmission capacity to both transmission links. In this manner, allocation of redundant transmission capacity can be avoided, and, as a result, network resources can be efficiently utilized.

When the call request terminal issues a request for multicast communication, it is preferable to assure transmission capacity along the transmission links of each path used for the requested multicast communication.

For address management during multicast delivery of stream data, the network resource management means preferably uses IGMP (Internet Group Management Protocol), GMRP (GARP Multicast Registration Protocol), or GVRP (GARP VLAN Registration Protocol).

To transmit information regarding correspondents, transmission capacity, assurability of capacity, acceptance/rejection of incoming calls, as well as the release of capacity, the network resource management means and the terminals preferably use SIP (Session Initiation Protocol).

Switching hub connection, detection of transmission capacity, switching hub configuration via access by the network resource management means, and notification of the network resource management means by the switching hubs are preferably performed by the network resource management means and the switching hubs based on SNMP (Simple Network Management Protocol), RMON (Remote Network Monitoring), or RMON2 (Remote Network Monitoring MIB Version2).

To permit co-existence of frames with guaranteed maximum transmission capacity and non-guaranteed Best Effort type frames, the call request terminal transmits frames with guaranteed maximum transmission capacity by appending priority markings thereto, such that the call request terminal, the network resource management means, and the call requested terminal can process transmission capacity allocation only for frames, to which the priority markings are appended.

According to a second aspect of the present invention, there is provided a communications network comprising a plurality of terminals, one or more switching hubs that learn the respective MAC (Media Access Control) addresses of the terminals in communication with each other and configure a single path between the learned terminals, and network resource management means configuring a path traversing any one or more of the one or more switching hubs between the call request terminal and the call requested terminal amongst the plurality of terminals, wherein each one of the plurality of terminals comprises: means for transmitting a call request containing information on the transmission capacity whose allocation is requested in order to perform communication, along with its own terminal address and the address of the call requested terminal, when the terminal itself operates as a call request terminal; means for transmitting a receive acknowledgement when it is itself communication-enabled, and a call rejection when it is itself communication-disabled, to the call request terminal associated with a call request via the network resource management means when a call request is received and the terminal itself operates as a call requested terminal; means for recognizing that communication with guaranteed transmission capacity has been established and initiating transmission of data frames to the call requested terminal upon receipt of a receive acknowledgement from the call requested terminal when operating as a call request terminal; and means for transmitting a clear request to the peer terminal via the network resource management means upon completion of communication; and the network resource management means comprises: means for storing the connection between the terminals and the switching hubs, as well as between the switching hubs, and the transmission capacity of the transmission links associated with this connection; means for consulting the storage means in response to a call request from a call request terminal and making an assessment as to whether transmission capacity to be used can be assured along a path traversing switching hubs between a call request terminal and a call requested terminal; means for increasing the transmission capacity to be used in the storage means by an amount corresponding to said assurance and transmitting a call request from said call request terminal to said call requested terminal if, in accordance with the assessment results of the assessment means, it can be assured, or transmitting an incoming call rejection to said call request terminal if it cannot be assured; means for forwarding a receive acknowledgement or a call rejection from the call requested terminal to the corresponding call request terminal; means for releasing transmission capacity assured for the call request associated with the call rejection and withdrawing it from the storage means when a call rejection is received from the call requested terminal; and means for releasing transmission capacity and withdrawing it from the storage means when a clear request is received from the other terminal participating in communication in case transmission capacity corresponding to the clear request has been assured.

The network resource management means is provided in any of the one or more switching hubs; otherwise, the one or more switching hubs are connected to a tree structure, and the means is located in the vicinity of the root (root) of the tree structure.

The plurality of terminals are terminals compliant with frames having guaranteed maximum transmission capacity; on the network, Best-Effort type terminals compliant only with frames having no guaranteed maximum transmission capacity may co-exist therewith, and the terminals compliant with frames having guaranteed maximum transmission capacity can have means for appending priority markings to frames with guaranteed transmission capacity.

In order to accommodate frames without guaranteed maximum transmission capacity as well as frames with guaranteed maximum transmission capacity, each one of the switching hubs preferably comprises means which, whenever input frames have priority markings, sends said input frames to transmission links in preference to input frames without priority markings. Furthermore, it can comprise means which, whenever input frames have priority markings and the destination MAC addresses have been learned, sends said input frames to transmission links in preference to input frames without priority markings. Such switching hubs can comprise means for processing the learning of the MAC addresses of priority-marked frames in preference to frames without priority markings.

The three bits representing priority in TCI can be used for marking priority. In this case, it is preferable to deploy means for attaching or removing TCI from non-TCI-compliant frames in switching hubs at the edge of the network.

Each one of the switching hubs can comprise means for sending a PAUSE frame that halts transmission to the corresponding input transmission links when the buffer size of frames not subject to priority processing is equal to or more than a predetermined value Thmax and sending a PAUSE-OFF frame that disables the suspension of transmission to the transmission links when a predetermined value Thmin (Thmax>Thmin) is reached.

Each one of the switching hubs can comprise means for configuring threshold values for the input frame rates of ports connected to the terminals, either manually or via access by the network resource management means, as well as means for handling frames with priority markings having frame rates exceeding the threshold values as non-priority frames.

Amongst the switching hubs, hubs at the edge of the network preferably comprise means which, upon receipt of a notification regarding source MAC addresses and destination MAC addresses with guaranteed maximum transmission capacity from the network resource management means, activates priority processing markings in frames with these MAC addresses, and, upon receipt of a notification regarding MAC addresses without guaranteed maximum transmission capacity from the network resource management means, removes priority processing markings from frames with these MAC addresses.

According to a third aspect of the present invention, there is a provided a network resource management device for configuring a path traversing one or more transmission links and one or more switching hubs between terminals on a network, wherein the terminals are terminals comprising means for reserving transmission capacity to be used upon a call request, the switching hubs are switching hubs with an MAC address learning function that learn the respective MAC (Media Access Control) addresses of terminals in communication with each other and configure a single path between the learned terminals, and the network resource management device comprises: means for storing connections between the terminals and the switching hubs, as well as between the switching hubs, and the transmission capacity of the transmission links associated with these connections; means for consulting the storage means in response to a call request from a call request terminal and making an assessment as to whether transmission capacity to be used can be assured along a path traversing switching hubs between a call request terminal and a call requested terminal; means for increasing the transmission capacity to be used in the storage means by an amount corresponding to said assurance and transmitting a call request from said call request terminal to said call requested terminal if, in accordance with the assessment results of the assessment means, it can be assured, or transmitting an incoming call rejection to said call request terminal if it cannot be assured; means for forwarding a receive acknowledgement or a call rejection from the call requested terminal to the corresponding call request terminal; means for releasing transmission capacity assured for the call request associated with the call rejection and withdrawing it from the storage means when a call rejection is received from the call requested terminal; and means for releasing transmission capacity and withdrawing it from the storage means when a clear request is received from the other terminal participating in communication in case transmission capacity corresponding to the clear request has been assured.

The processing performed by terminals and the network resource management means and the operation and means of the switching hubs in the first aspect and second aspect of the present invention, as well as the network resource management device of the third aspect, can be implemented by installing computer programs describing such processing on a general-purpose information processing system.

As for the above-described path discovery problem, the use of switching hubs equipped with an MAC address learning function and Ethernet transmission links as a transmission network limits it to single-path transmission. As a result of using switching hubs having such an MAC address learning function, flooding between terminals with learned MAC addresses no longer occurs, and a single path is configured between the terminals. By doing so, end-to-end single-path transmission can be implemented. Therefore, despite the need to send frames used for MAC address learning (learning based on transmission source address) between communication terminals from the receive side to the transmit side in advance, there is no need for advance configuration, as in case of ATM, which is advantageous.

Furthermore, in the present invention, in order to address the problem of management of capacity (frame rate) allocation to transmission links along the path, management of the capacity to be used by transmission links on Ethernet networks is performed by allocating transmission capacity along the path to be used (as described above, a single path can be defined) based on requests (correspondent and transmission capacity) from terminals, which, if possible, are accepted, with the allocation removed using a Terminate Request. By doing so, the utilization of transmission links can be managed to be just under 100% and congestion can be avoided.

The capacity to be used by transmission links on a network is managed so as to be within a designated usable region (less than 100%, because of network monitoring data transmission, ARP (Address Resolution Protocol: RFC 826), etc.), and terminals have to be notified of the results, whereas there is no need to notify or control switching hubs. In this manner, the network resource management device can bring together requests from terminals to manage transmission capacity to be used and processing can therefore be made far simpler than before because it can be implemented using a procedure requiring no communication with switching hubs.

The present invention makes it possible to implement inter-terminal transmission with guaranteed capacity based on the single-path configuration function of networks composed of switching hubs with an MAC address learning function and centralized management of transmission capacity without control over hubs. This provides the advantage of eliminating the need to control hubs along the path and configure paths beforehand, as was the case in the past.

In addition, the issue of full-duplex and half-duplex transmission links can be addressed by managing transmission capacity in the management database used for allocation of capacity to network transmission links in such a manner that the capacity is less than ½ for half-duplex.

### BRIEF DESCRIPTION OF DRAWINGS

FIG. 1 is a block diagram illustrating an embodiment of the present invention.

FIG. 2 is a diagram illustrating the configuration of a database for management of capacity allocation to network transmission links.

FIG. 3 is a diagram illustrating the configuration of a communication connection management database.

FIG. 4 is a sequence diagram illustrating a communication procedure.

FIG. 5 is a sequence diagram illustrating a communication procedure including an incoming call rejection executed on a terminal.

FIG. 6 is a sequence diagram illustrating a communication procedure including rejection of an attempt to start communication by the network resource management device.

FIG. 7 is a diagram used to explain the procedure used by switching hubs to learn request destination MAC addresses.

FIG. 8 is a diagram illustrating the functions and classification of packets used in the communication sequence of a first embodiment.

FIG. 9 is a sequence diagram used to explain the communication procedure of a second embodiment.

FIG. 10 is a diagram used to explain the process of changes in the allocation of transmission capacity.

FIG. 11 is a diagram illustrating the TCI format.

FIG. 12 is a diagram illustrating priority levels according to IEEE 802.1p.

FIG. 13 is a sequence diagram used to explain a communication procedure.

FIG. 14 is a sequence diagram used to explain a communication procedure.

FIG. 15 is a sequence diagram used to explain a communication procedure including a transmit procedure for a multicast group Query.

FIG. 16 is a diagram used to explain the communication procedure of a fifth embodiment including an IGMP Join (GMRP Join) message.

FIG. 17 is a sequence diagram used to explain the communication procedure of the fifth embodiment including an SNMP trap.

FIG. 18 is a diagram illustrating packet classification and functions.

FIG. 19 is a sequence diagram used to explain a communication procedure.

FIG. 20 is a sequence diagram used to explain a communication procedure including a CANCEL transmit procedure executed on a terminal.

FIG. 21 is a sequence diagram used to explain a communication procedure including a CANCEL transmit procedure executed by the network resource management device.

FIG. 22 is a diagram illustrating the SIP method.

FIG. 23 is a diagram illustrating different types of SIP response codes.

FIG. 24 is a diagram illustrating an exemplary capacity management database.

FIG. 25 is a network configuration diagram (with a loop formed by two switching hubs) illustrating an embodiment of the present invention.

FIG. 26 is a diagram illustrating an embodiment in which transmission capacity is allocated to the entire communication path during allocation of transmission capacity to a call request by the network resource management device.

FIG. 27 is a diagram illustrating an example of a capacity management database, wherein transmission capacity has been allocated to a call request.

FIG. 28 is a diagram illustrating an embodiment in which no duplicate transmission capacity is allocated to overlapping communications paths during allocation of transmission capacity for a call request by the network resource management device.

FIG. 29 is a diagram illustrating an example of a capacity management database, in which transmission capacity has been allocated to a call request.

FIG. 30 is a network configuration diagram (with a loop formed by three switching hubs).

FIG. 31 is a diagram illustrating an embodiment, in which the network resource management device allocates transmission capacity to a call request.

FIG. 32 is a diagram illustrating an example of a capacity management database, in which transmission capacity has been allocated to a call request.

FIG. 33 is a network configuration diagram, in which a loop configuration is used.

FIG. 34 is a diagram illustrating an embodiment, in which the network resource management device allocates transmission capacity to a call request.

FIG. 35 is a diagram illustrating an embodiment, in which the network resource management device allocates transmission capacity to a call request.

FIG. 36 is a network configuration diagram illustrating another embodiment of the present invention.

FIG. 37 is a flowchart representing frame processing in a switching hub.

FIG. 38 is a flowchart representing an MAC address learning process.

FIG. 39 is a flowchart representing a forwarding process.

FIG. 40 is a flowchart representing transmit queues in output ports.

FIG. 41 is a flowchart representing transmit queues in output ports, wherein frames are sent to transmission links on a preferential basis only when input frames have priority markings and the destination MAC addresses have been learned.

FIG. 42 is a flowchart representing processing used to add TCI to a frame in a switching hub.

FIG. 43 is a flowchart representing a TCI tagging process.

FIG. 44 is a flowchart representing processing used to delete TCI from a frame in a switching hub.

FIG. 45 is a flowchart representing a TCI tag removal process.

FIG. 46 is a flowchart representing MAC address learning for priority-marked frames.

FIG. 47 is a flowchart representing a case, in which a PAUSE frame is used in the transmit queues of the output ports.

FIG. 48 is a flowchart representing a PAUSE frame transmission process.

FIG. 49 is a flowchart representing a PAUSE-OFF frame transmission process.

FIG. 50 is a diagram illustrating an example representing a threshold value used for transmission of a PAUSE frame set up in a transmit queue.

FIG. 51 is a flowchart illustrating non-priority treatment in the transmit queues of output ports when priority-marked frames exceed a predetermined frame rate threshold.

FIG. 52 is a diagram illustrating an example of a network configuration used for rate measurement in the ports of switching hubs.

FIG. 53 is a diagram illustrating an example of absolute-value sampling according to RMON.

FIG. 54 is a flowchart representing a method for rate measurement in specific ports of switching hubs.

FIG. 55 is a diagram illustrating SNMP operation.

FIG. 56 is a flowchart representing processing that activates the priority markings of frames in the switching hubs of the present invention.

FIG. 57 is a flowchart representing a priority processing marking process.

FIG. 58 is a flowchart representing processing used to remove priority markings from frames in switching hubs.

FIG. 59 is a flowchart representing a priority processing marking removal process.

### DESCRIPTION OF REFERENCE NUMERALS

1 network resource management device
2-1 to 2-8 terminals
3-1 to 3-7 switching hubs with an MAC address learning function
4-1 to 4-17 transmission links
22-2, 22-3, 22-6, 22-7 Best Effort-type terminals
23-1 to 23-7 switching hubs with a priority processing function and an MAC address learning function.

### BEST MODE FOR CARRYING OUT THE INVENTION

Below, embodiments of the present invention are explained with reference to drawings; the following embodiments, however, are used merely to explain the present invention and the present invention is not limited to these embodiments.

### Embodiment 1

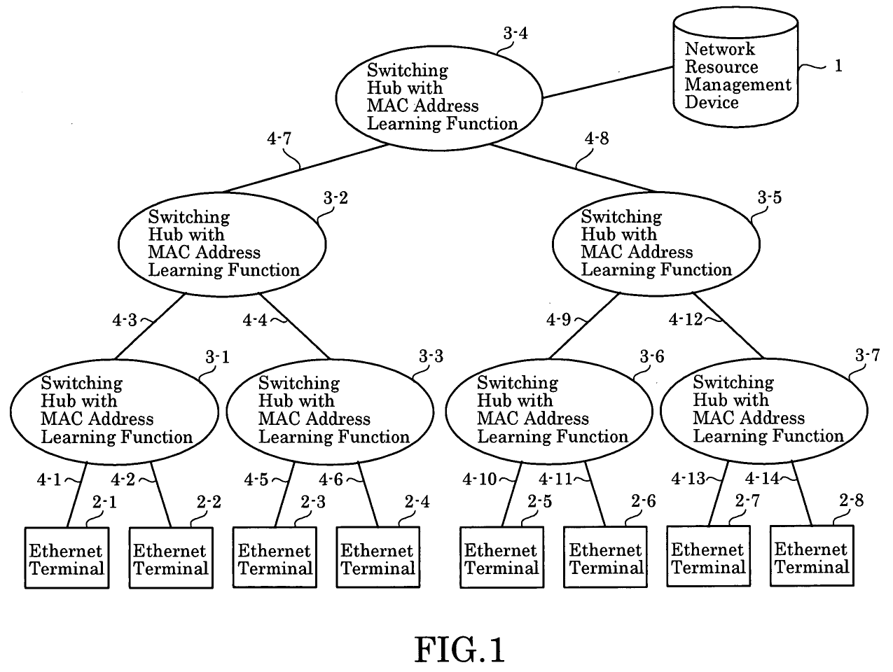

FIG. 1 is a block diagram illustrating an embodiment of the present invention. This network is composed of network resource management device 1, Ethernet terminals (hereinafter referred to simply as “terminals”) 2-1 to 2-8, switching hubs equipped with MAC address learning function 3-1 to 3-7, and Ethernet transmission links (hereinafter referred to simply as “transmission links”) 4.

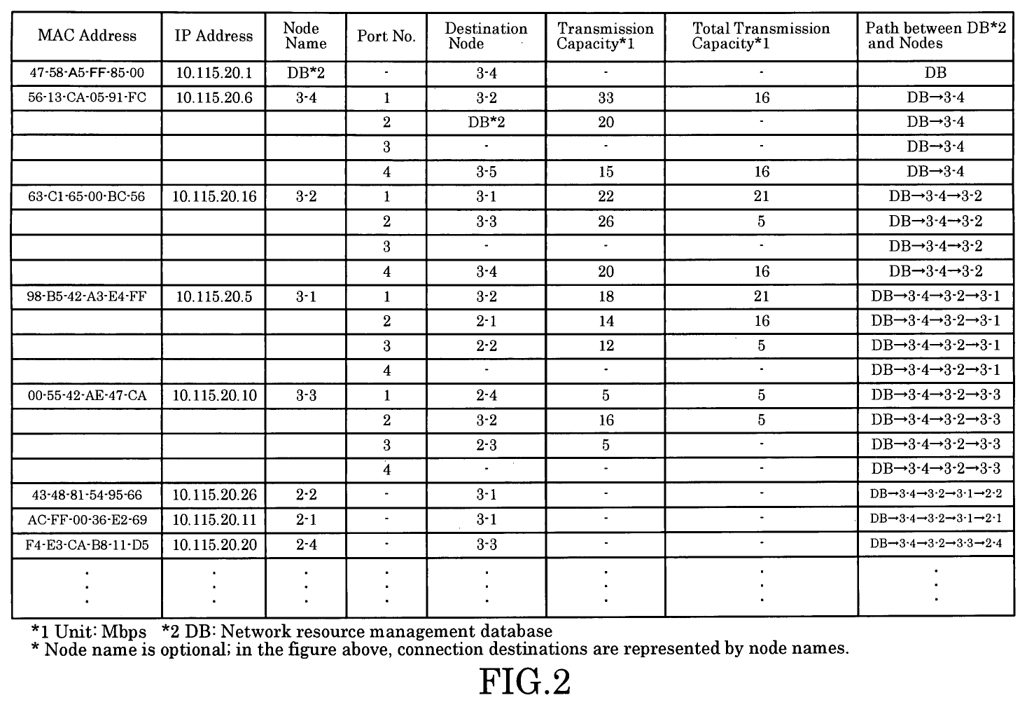

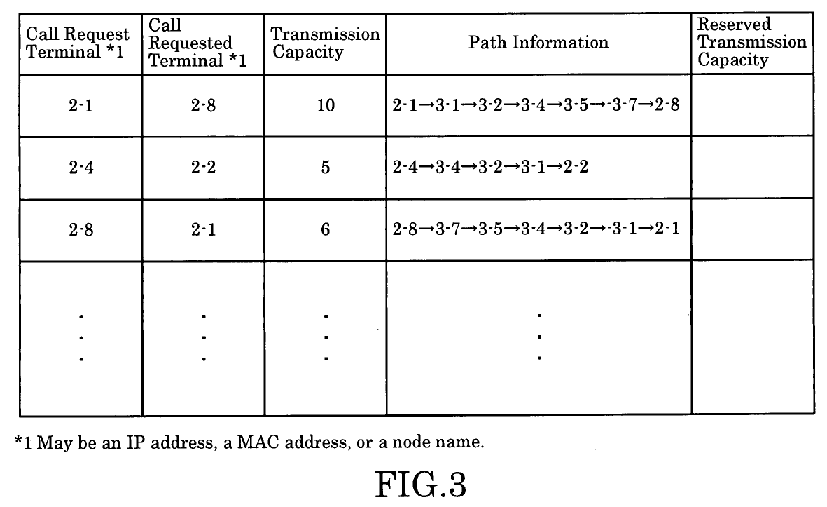

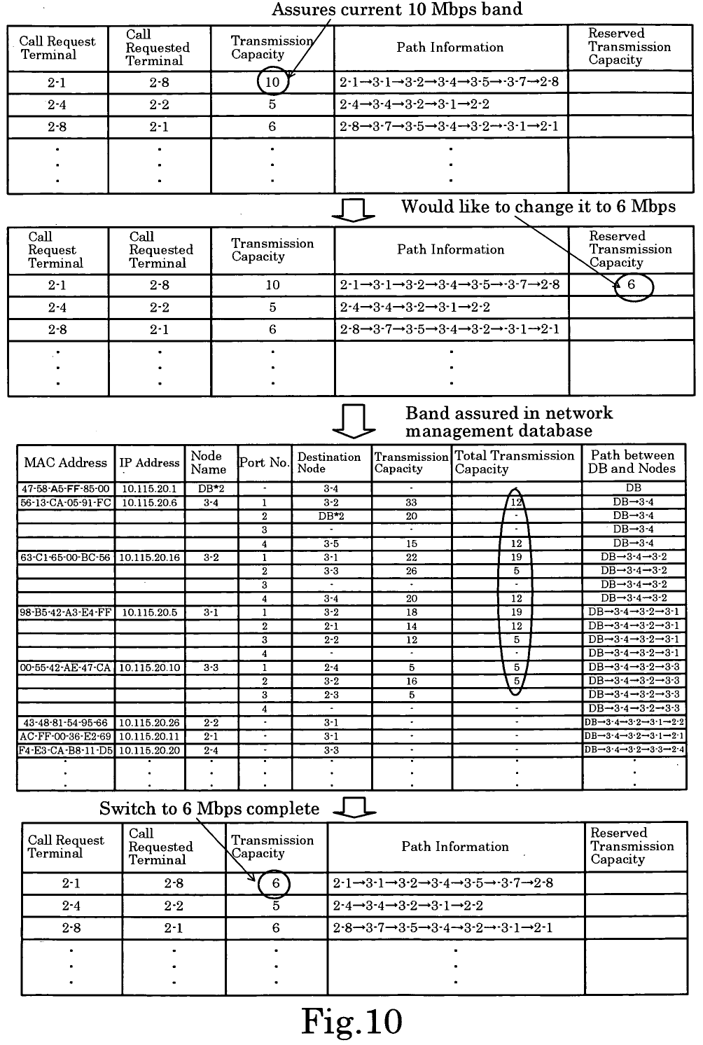

FIG. 2 is a diagram illustrating the configuration of a management database used for capacity allocation to network transmission links (network topology and transmission link capacity allocation). FIG. 3 is a diagram illustrating the configuration of a communication connection management database. The network resource management device has a database for management of capacity allocation to network transmission links, which is illustrated in FIG. 2 and is based on transmission capacity and network topology used for management, and a communication connection management database, which is illustrated in FIG. 3. Although the network resource management device of the present invention is characterized by making path management unnecessary, in this embodiment, in order to render the explanations more understandable, path information is described in FIG. 2, FIG. 3, and FIG. 10. The network resource management device of the present invention is capable of inter-terminal transmission with guaranteed capacity even without such path information.

In the network resource management device, the network is managed and monitored by storing the total transmission capacity allocated to call requests from the terminals, transmission capacity of the ports, connection destination nodes, port numbers for switching, node names, IP addresses, and MAC addresses of the nodes in a database for management of capacity allocation to network transmission links.

The network resource management device receives a call request from a terminal and determines a single path from the database for management of capacity allocation to each network transmission link illustrated in FIG. 2 based on the reserved transmission capacities and addresses of the call request terminal and call requested terminal and assures transmission capacity for the transmission links. It stores it in a communication connection management database, which can store the addresses of the call request terminal and the call requested terminal, currently used transmission capacities, and transmission capacities to be reserved, and performs management of end-to-end communication.

To decide the maximum delay time of the transmission links linking the terminals, the terminals have the ability to manage the transmission capacity (frame rate) to be used by the transmission links. For example, in case of congestion in a switching hub with n ports, in which the transmission capacity of all ports is nearly equal, when frames from all the ports except for one port concentrate in that single port, congestion can be avoided by placing buffers of at least (n−1)×T (sec), where T (sec) is a time interval that determines the frame rate, in the output ports of the switching hubs.

Hubs equipped with an MAC address learning function are used as the switching hubs. The network resource management device can figure out a path from a terminal to the network resource management device using the database for management of capacity allocation to network transmission links illustrated in FIG. 2, into which information is entered manually. End-to-end paths between terminals are obtained by searching for paths from the terminals to the network resource management device or to the root (root) and eliminating the redundant portions. Although they may be calculated, if necessary, in the present embodiment, in order to make the explanations easier to understand, it is assumed that they are stored in the communication connection management database illustrated in FIG. 3. These paths are the same as paths composed of switching hubs, in which flooding doesn't occur after learning the MAC address of the terminal.

Here, the definition of the above-mentioned redundant portion is explained by referring to FIG. 1. In FIG. 1, the path from network resource management device 1 to terminal 2-1 is: network resource management device 1→switching hubs 3-4→3-2→3-1→terminal 2-1. Moreover, the path from network resource management device 1 to terminal 2-8 is: network resource management device 1→switching hubs 3-4→3-5→3-7→terminal 2-8. At such time, the path from terminal 2-1 to 2-8 is: terminal 2-1→switching hubs 3-1→3-2→3-4→3-5→3-7→2-8.

That is, for the communication procedure, a path between the data transmission source or data transmission destination and network resource management device 1 is needed in addition to the path between the data transmission source and the data transmission destination, where the data transmission is actually performed. In the present embodiment, the path between the data transmission source or data transmission destination and network resource management device 1 used for the communication procedure is defined as the redundant portion.

In the example above, the path “network resource management device 1→switching hubs 3-4” is needed for the communication procedure, and, therefore, the path from network resource management device 1→switching hub 3-4 will be the redundant portion. In addition, to give another example, the path from network resource management device 1 to terminal 2-3 is: network resource management device 1→switching hubs 3-4→3-2→3-3→terminal 2-3. At such time, the path from terminal 2-1 to 2-3 is: terminal 2-1→switching hubs 3-1→3-2→3-3→2-3. Therefore, the redundant portion in this case will be network resource management device 1→switching hubs 3-4→3-2.

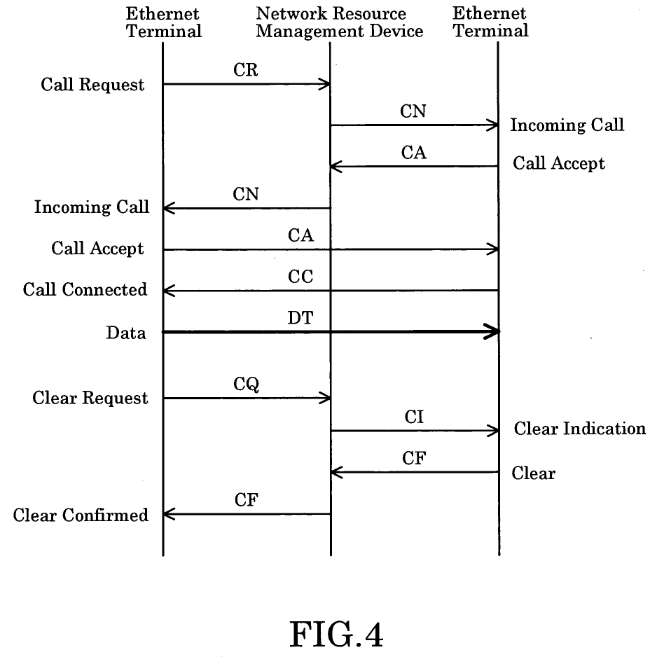

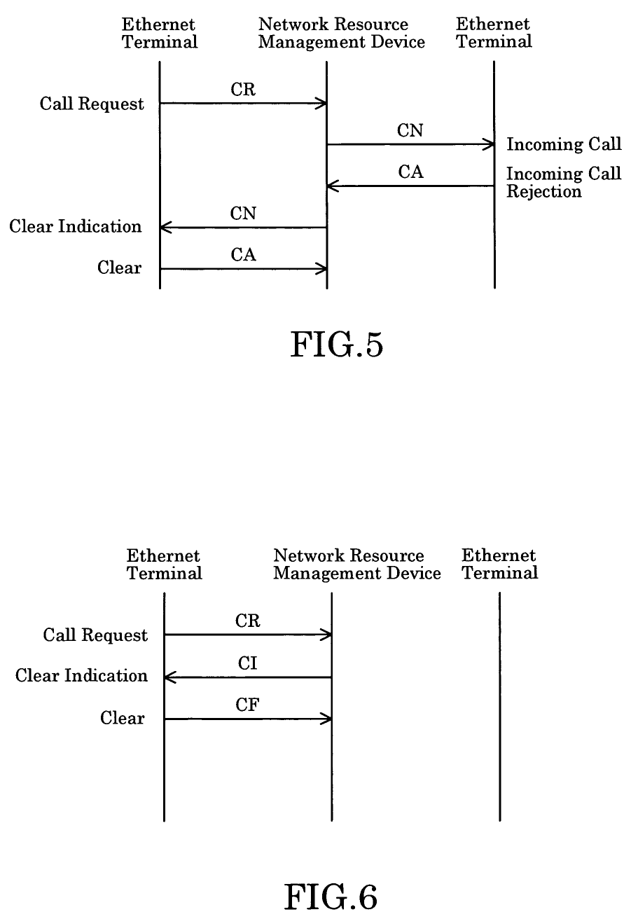

FIG. 4 through FIG. 6 are sequence diagrams illustrating the communication procedure of a terminal, with FIG. 4 illustrating ordinary connection, FIG. 5 illustrating rejection of an attempt to start communication by a call requested terminal, and FIG. 6 illustrating the sequence of call request rejection by the network resource management device. Operation associated with call requests from terminals is explained by referring to these figures and to FIGS. 1-3.

As illustrated in FIG. 1, when terminal 2-1 forwards unidirectional stream data to terminal 2-8, the network management device receives a Call Request (CR) packet from call request terminal 2-1 and learns the MAC address of terminal 2-1 (hereinafter referred to as the request source MAC address), the IP address of terminal 2-1 (hereinafter referred to as the request source IP address), the IP address of terminal 2-8 (hereinafter referred to as the request destination IP address), and the reserved transmission capacity that terminal 2-1 intends to use.

Based on this information, the network resource management device allocates transmission capacity and determines a single path using the database illustrated in FIG. 2 and the communication connection management database illustrated in FIG. 3. If the network resource management device cannot assure transmission capacity for the call request, then, as illustrated in FIG. 6, the call request is rejected using Clear Indication (CI) and Clear Confirmation (CF) packets.

When the requested transmission capacity can be assured, the network resource management device sends an Incoming Call (CN) packet containing a request source MAC address and a request source IP address to call requested terminal 2-8. At such time, the network resource management device instructs call requested terminal 2-8 to return a Call Connected (CC) packet when an Call Accept (CA) is received from call request terminal 2-1. Subsequently, the network resource management device receives information on acceptance/rejection of communication from call requested terminal 2-8 using a Call Accept (CA) packet containing a request destination MAC address and a request destination IP address.

When call requested terminal 2-8 rejects communication, as illustrated in FIG. 4, the network resource management device rejects initiation of communication using Clear Indication (CI) and Clear Confirmation (CF) packets. When call requested terminal 2-8 allows communication, the network resource management device sends an Incoming Call (CN) packet containing a request destination MAC address and a request destination IP address to call request terminal 2-1.

Subsequently, the network resource management device instructs call request terminal 2-1 to transmit an Call Accept (CA) packet to call requested terminal 2-8. Based on it, call request terminal 2-1 sends an Call Accept (CA) packet to call requested terminal 2-8, and call requested terminal 2-8, which receives it, sends a Call Connected (CC) packet to call request terminal 2-1. By doing so, stream data communication is established.

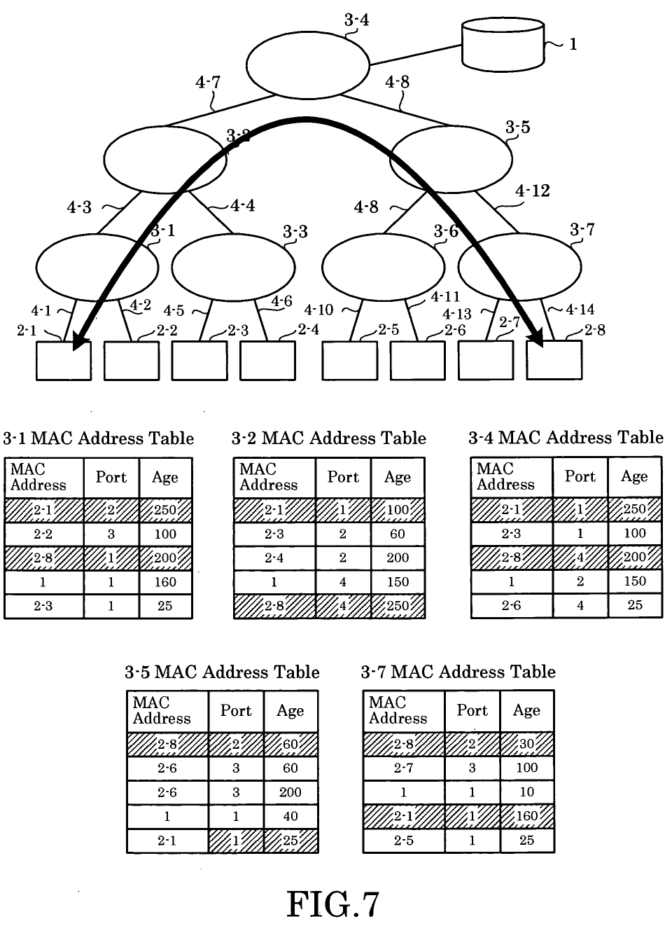

Prior to the start of stream data transfer between the terminals, the call requested terminal transmits a Call Connected (CC) packet to the call request terminal and then starts communication. FIG. 7 is a diagram used to explain the procedure used by switching hubs to learn a request destination MAC address. In response to the Call Connected (CC) packet, as illustrated in FIG. 7, the switching hubs in the end-to-end interval finish the learning of the request destination MAC address. By carrying out these communication sequences before starting the transmission of stream data, stream data flooding can be prevented. It should be noted that the Call Connected (CC) packet may be a broadcast frame.

The address learning function in the switching hub has an aging function (duration of maintaining learned MAC addresses), which is described in the IEEE 802.1.D as being 300 sec by default. Therefore, after establishing stream data communication, the call requested terminal transmits Interrupt (IT) packets when there is no stream data within no more than 300 sec. As a result of the Interrupt (IT) packets being transmitted by the call requested terminal, the switching hubs in the end-to-end interval continue learning the request destination MAC address.

To disconnect from the stream data communication, a Clear Request (CQ), a Clear Indication (CI), and a Clear Confirmation (CF) packets are used (see FIG. 4). Such a communication disconnect may arrive from any of the terminals.

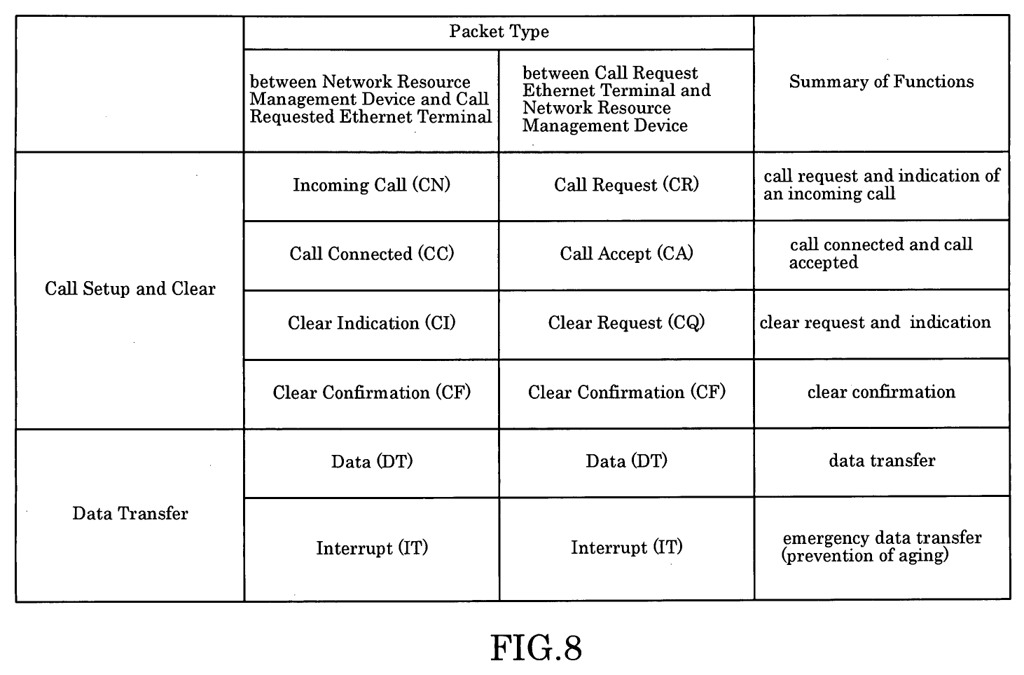

In the procedure illustrated above, communication can be established and disconnected from without communicating with the switching hubs along the path, and, as a result, processing on the network can be simplified. The functions and classification of packets used in this communication sequence are shown in FIG. 8.

### Embodiment 2

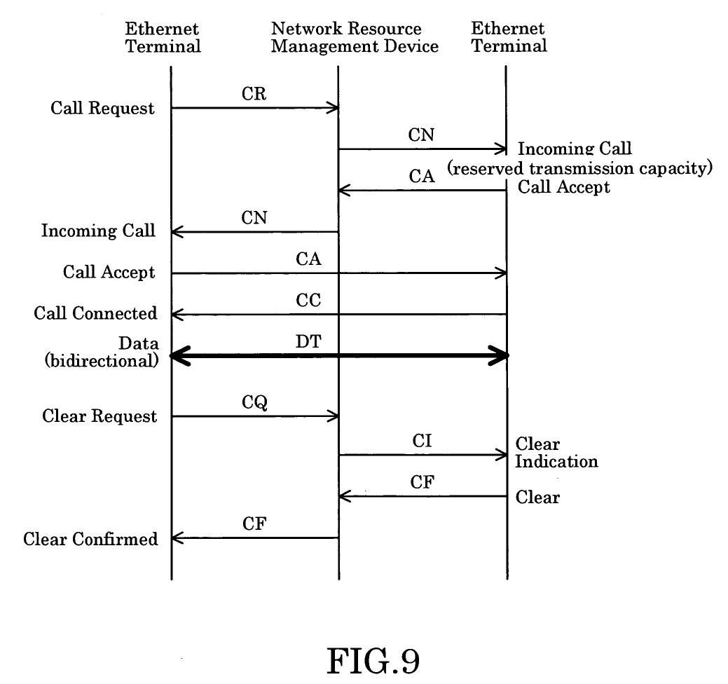

Operation implementing bidirectional communication using a communication sequence leading to the establishment of communication, which is shown in the first embodiment, is explained by referring to FIG. 2, FIG. 3, and FIG. 9.

FIG. 9 is a sequence diagram used to explain the communication procedure of the second embodiment. As illustrated in FIG. 9, when terminal 2-1 establishes bidirectional stream data communication with terminal 2-8, the network management device receives a Call Request (CR) packet from call request terminal 2-1 and learns the MAC address of terminal 2-1 (hereinafter referred to as the request source MAC address), the IP address of terminal 2-1 (hereinafter referred to as the request source IP address), the IP address of terminal 2-8 (hereinafter referred to as the request destination IP address), and the reserved transmission capacity that terminal 2-1 intends to use. Based on this information, the network resource management device allocates transmission capacity and determines a single path using the management database for allocation of capacity to network transmission links, which is illustrated in FIG. 2, and the communication connection management database illustrated in FIG. 3. If the network resource management device cannot assure transmission capacity for the call request, then, as illustrated in FIG. 5, the call request is rejected using Clear Indication (CI) and Clear Confirmation (CF) packets.

When the requested transmission capacity can be assured, the network resource management device sends a Incoming Call (CN) packet containing a request source MAC address and a request source IP address to call requested terminal 2-8. At such time, the network resource management device instructs call requested terminal 2-8 to return a Call Connected (CC) packet when an Call Accept (CA) is received from call request terminal 2-1. Subsequently, the network resource management device receives information on acceptance/rejection of communication sent from call requested terminal 2-8 using a Call Accept (CA) packet containing a request destination MAC address and a request destination IP address. Here, when call requested terminal 2-8 rejects communication, as illustrated in FIG. 6, the network resource management device rejects initiation of communication using Clear Indication (CI) and Clear Confirmation (CF) packets.

If call requested terminal 2-8 allows communication, the network resource management device sends an Incoming Call (CN) packet containing a request destination MAC address and a request destination IP address to call request terminal 2-1. If call requested terminal 2-8 allows communication, then, when sending a Call Accept (CA) packet to the network resource management device, call requested terminal 2-8 simultaneously informs it of the reserved transmission capacity that call requested terminal 2-8 intends to use. The reserved transmission capacity may not necessarily be the same capacity as the reserved transmission capacity specified by the call request terminal.

If the network resource management device cannot assure the transmission capacity that call requested terminal 2-8 requests, the network resource management device terminates the request using a Clear Indication (CI) packet as illustrated in FIG. 5, and inquires call requested terminal 2-8 about the reserved transmission capacity again. At such time, it can inform it of the maximum usable transmission capacity.

If the transmission capacity that call requested terminal 2-8 specifies can be assured by the network resource management device, the network resource management device sends a Incoming Call (CN) packet containing a request destination MAC address and a request destination IP address to call request terminal 2-1 and instructs it to send a Incoming Call (CN) packet to terminal 2-8. Following that, call request terminal 2-1 sends an Call Accept (CA) packet to call requested terminal 2-8, and call requested terminal 2-8, which receives it, sends a Call Connected (CC) packet to call request terminal 2-1. By doing so, bidirectional communication is established.

### Embodiment 3

FIG. 2, FIG. 3, and FIG. 10 are used to explain that once the stream data transfer described in the first embodiment is established, the already assured transmission capacity can be modified thereafter.

Upon establishing the end-to-end communication, the network resource management device receives a Call Request (CR) packet specifying the transmission capacity to be modified and the request destination IP address from the call request terminal that modifies the transmission capacity. Subsequently, the network resource management device records the transmission capacity to be modified in the reserved transmission capacity field of the communication connection management database illustrated in FIG. 3, and assures the transmission capacity recorded under “reserved transmission capacity” by the database for management of capacity allocation to network transmission links illustrated in FIG. 2.

Subsequently, the network resource management device uses a Call Accept (CA) packet to convey the fact that the transmission capacity has been modified to the call request terminal. When transmission capacity for the request cannot be assured, a Clear Indication (CI) packet is transmitted to the call request terminal and the request is rejected.

FIG. 10 is a diagram used to explain the process of transmission capacity allocation. In the example of FIG. 10, the network resource management device assures a 10 Mbps band between call request terminal 2-1 and call requested terminal 2-8. Here, when 6 Mbps is requested as a reserved transmission capacity, the network resource management device allocates 6 Mbps from the assured 10 Mbps band. In the example of FIG. 10, the request could be accepted because the requested band was smaller than the band that the network resource management device had previously assured. If, however, the requested band had been larger than the band that the network resource management device had previously assured, the request would have been rejected.

Thus, transmission capacity modification requests can be issued any number of times without interrupting communication so long as the network resource management device receives no clear requests from any of the communicating terminals upon establishment of communication.

### Embodiment 4

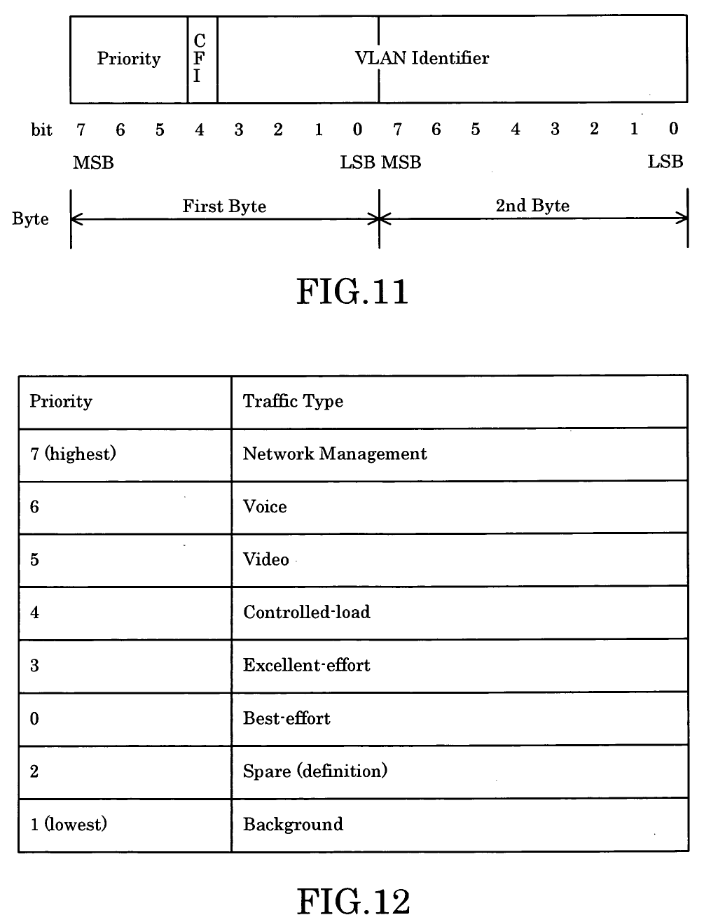

In the embodiment above, a VLAN (Virtual Local Area Network) can be built between the call request terminal and the call requested terminal. To build a VLAN, a VLAN tag, standardized in accordance with the IEEE802.1Q/p, is attached to frames transmitted between the terminals. The VLAN tag is composed of a TPID (Tag Protocol Identifier) and TCI (Tag Control Information). A predetermined value indicating that this is a VLAN tag is set in the TPID, with the frame processed as an ordinary frame at other values. The TCI is composed of priority, TCI (Canonical Format Information), and a VLAN identifier. A VLAN can be built using VLAN identifiers, and therefore using GVRP (GARP VLAN Registration Protocol: IEEE802.1Q) etc. enables removal of unwanted broadcast and unknown unicast traffic as well as allocation of multicast paths. It should be noted that when allocating multicast paths, capacity allocation is necessary for all the paths. The signal format of the TCI is illustrated in FIG. 11 and the priority level is illustrated in FIG. 12.

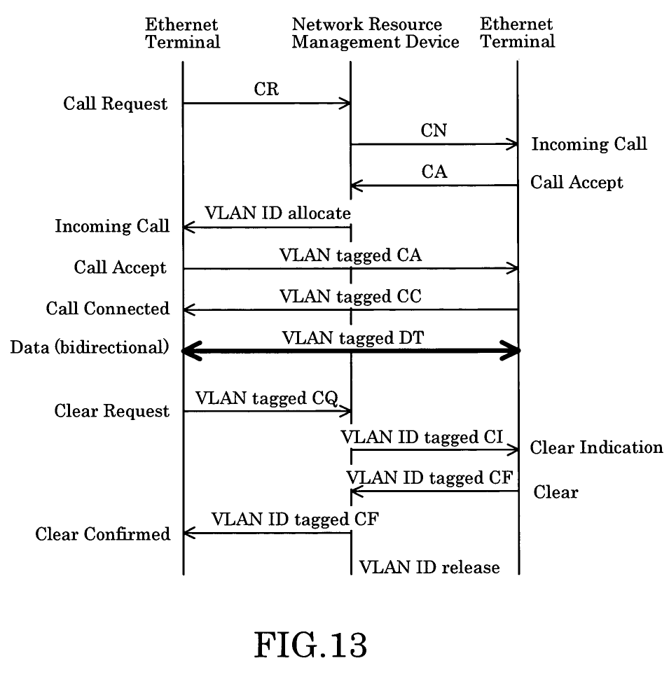

FIG. 13 is a sequence diagram used to explain the communication procedure of the fourth embodiment. The network resource management device manages the usage status of the VLAN identifier represented by the TCI, and, when a receive acknowledgement CN from a call requested terminal is forwarded to a call request terminal, along with attaching a VLAN tag containing TCI corresponding to an unused VLAN identifier to the receive acknowledgement, stores the VLAN identifier as being in use.

The call request terminal reads the VLAN identifier from the VLAN tag attached to the receive acknowledgement CN received from the network resource management device, and, when transmitting frames to the call requested terminal, attaches a VLAN tag thereto that corresponds to the VLAN identifier that has been read.

If a VLAN tag is attached to a received frame, then the switching hubs learn the source MAC address and the VLAN identifier as a pair when carrying out MAC address learning for the frame and set VLAN identifiers with a time-out period in the input ports that received the received frame and the output ports selected during forwarding.

To maintain the VLAN set up by the switching hubs, the call request terminal transmits one or more frames, to which VLAN tags corresponding to the VLAN are attached, within the time-out period.

When the call requested terminal receives a frame with a VLAN tag assigned thereto from the call request terminal, it reads the VLAN identifier from the VLAN tag and, when transmitting frames to the call request terminal, attaches a VLAN tag thereto that corresponds to the VLAN identifier that has been read.

When the call request terminal or the call requested terminal cuts off communication with the peer terminal, it transmits a clear request CQ to the network resource management means by attaching thereto a VLAN tag corresponding to the VLAN identifier that has been used for communication and stops attaching VLAN tags to frames upon transmission of the clear request.

When the network resource management device receives the clear request CQ, to which the VLAN tag is attached, it stores the VLAN identifier as being unused.

### Embodiment 5

In the database for management of capacity allocation to network transmission links illustrated in FIG. 2 of the first embodiment, information is entered manually, but in the fifth embodiment, the network resource management device detects the connection of terminals and their transmission capacity remotely.

The network resource management device collects MIB (Management Information Base) information on the switching hubs using the network management protocols SNMP, RMON, or RMON2 installed on the switching hubs. The MIB (management information base) is a network management standard, wherein agents (equipment as managed objects) maintain various network information and information on the equipment itself in the form of variables. These are collectively called the MIB; the network monitoring manager collects such agents' MIB information using SNMP and can monitor the condition of the network and the equipment (each port of the switching hubs).

As a result, in the network resource management device, the network is managed and monitored by storing the paths between the network resource management device and the nodes, the total transmission capacity allocated to call requests from the terminals, transmission capacity of the ports of the switching hubs, connection destination nodes, port numbers of the switching hubs, IP addresses, and MAC addresses of the nodes in the database for management of capacity allocation to network transmission links illustrated in FIG. 2 and periodically updating the database for management of capacity allocation to network transmission links.

When the network resource management device receives a call request from a terminal, it determines a single path from the database for management of capacity allocation to network transmission links illustrated in FIG. 2, based on the reserved transmission capacities and addresses of the call request terminal and call requested terminal and assures transmission capacity for the transmission links. It stores it in the communication connection management database illustrated in FIG. 3 and carries out end-to-end communication management.

To decide the maximum delay time of transmission links linking the terminals, the terminals require management of the transmission capacity (frame rate) to be used by the transmission links. TCP Vegas is one such example. The commonly used TCP Reno uses segment loss to perform window size adjustment for windows that become too large. Consequently, throughput decreases because window size becomes smaller than necessary immediately upon occurrence of segment loss.

On the other hand, TCP Vegas looks at the RTT (Round Trip Time) of transmitted segments and uses its fluctuations for window size adjustment. Namely, if the RTT becomes longer, it determines that the network is congested and reduces the window size, and, conversely, if the RTT becomes shorter, it increases the window size.

By doing so, the transmission rate can be controlled. It should be noted that this offers the advantage of achieving a reduction in buffer size because using a method involving transmission at frame intervals instead of transmission, during which traffic concentrates within the time period of the window, leads to a reduction in the peak rate.

Hubs equipped with an MAC address learning function are used as the switching hubs that form the network. The network resource management device can figure out a path from a terminal to the network resource management device using the database for management of capacity allocation to network transmission links illustrated in FIG. 2. End-to-end paths between terminals, which are obtained by removing redundant portions from paths leading to the network resource management device, are stored in the communication connection management database illustrated in FIG. 3. These paths are the same as paths composed of switching hubs that have learned the MAC addresses of the terminals.

Moreover, the switching hubs (intelligent switching hubs), on which the above-described MIB is installed, can be remotely controlled via telnet, which is why the terminals have IP addresses as well, in the same manner as the network resource management device. Therefore, in addition to transmission capacity, the network resource management device can perform reliable path probing using the trace route command.

### Embodiment 6

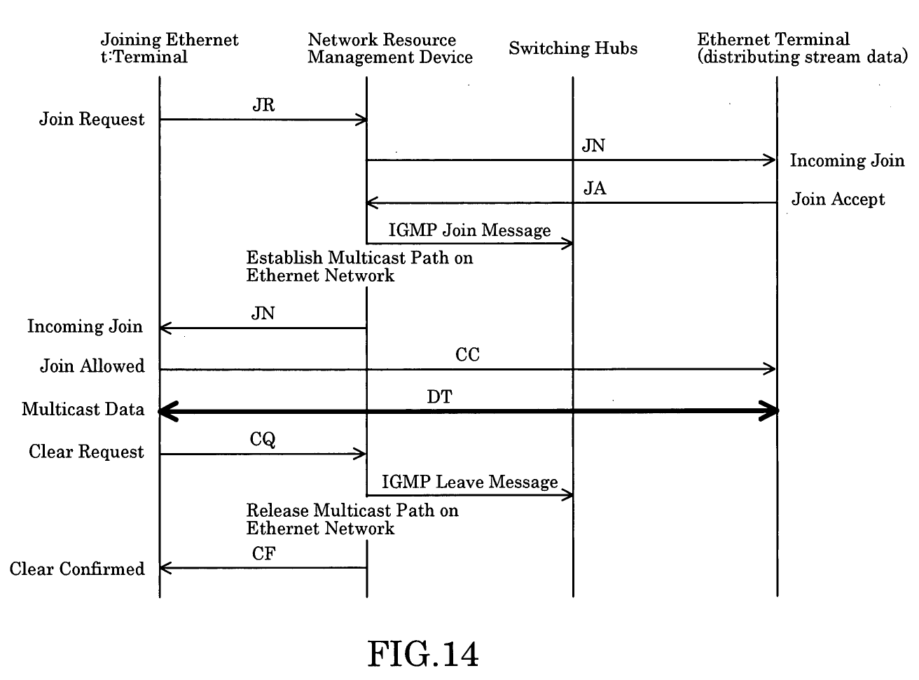

FIG. 14 through FIG. 18 will be now used to provide explanations regarding an example of operation in which, in the first embodiment, a group used for multicast delivery of stream data is subjected to advance network resource management.

The components of IGMP run on both the network resource management device and the switching hubs. When a terminal joins a multicast group or leaves a group using an IGMP packet, the switching hubs receive a notification from the network resource management device, which supports IGMP.

FIG. 14 is a sequence diagram used to explain the communication procedure of the sixth embodiment. As shown in FIG. 14, the network resource management device receives a Join Request (JR) packet containing the MAC address and IP address of terminal 2-5 being allowed to join from terminal 2-1, which has information on terminal 2-5 requesting to be allowed to join multicast delivery, or from terminal 2-5 requesting a join to multicast delivery. Subsequently, the network resource management device searches for the path to terminal 2-5 being allowed to join multicast delivery and, in order to determine whether a capacity increase for terminal 2-5, which is going to join, can be assured within the transmission capacity currently used for multicast delivery, for idle capacity on the transmission links of all paths used for multicast delivery using the communication connection management database and the database for management of capacity allocation to transmission links. If it is possible to assure transmission capacity, transmission capacity along the transmission links of the multicast paths is assured in its entirety in the database for management of capacity allocation to network transmission links. If transmission capacity for the join request cannot be assured, the call request is rejected using a Clear Indication (CI) and a Clear Confirmation (CF) packet.

Upon updating the databases, the network resource management device sends terminal 2-1, which is carrying out stream data delivery, a JOIN CALL (JN) packet containing the MAC address and IP address of terminal 2-5 requesting a join. Subsequently, the network resource management device receives information on acceptance/rejection of communication from terminal 2-1, which is carrying out stream data delivery, using a Join Accept (JA) packet containing the MAC address and request destination IP address of terminal 2-1, which is carrying out stream data delivery.

Here, the network resource management device rejects the join of terminal 2-5 using a Clear Indication (CI) and a Clear Confirmation (CF) packet when terminal 2-1, which is carrying out stream data delivery, rejects communication. If terminal 2-1, which is carrying out stream data delivery, allows communication, the network resource management device searches for the path to terminal 2-5, which is allowed to join, and sends an IGMP Join message, which contains the request type, multicast group address, and the MAC address of terminal 2-5, to the switching hubs, thereby automatically modifying the forwarding tables of the switching hubs.

After that, the network resource management device sends terminal 2-5 a JOIN CALL (JN) packet containing the MAC address and IP address of terminal 2-1, which is carrying out stream data delivery. At such time, the network resource management device instructs terminal 2-5 to send a JOIN COMPLETE (CC) packet to terminal 2-1, which is carrying out stream data delivery. Following that, terminal 2-5 sends a JOIN COMPLETE (CC) packet to terminal 2-1, which is carrying out stream data delivery, and multicast communication is established.

When terminal 2-5 leaves the multicast group, upon receipt of a Clear Request (CQ) from terminal 2-5 by the network resource management device, the network resource management device releases transmission capacity on all transmission links within the multicast path by the amount of transmission capacity assured by terminal 2-5 and sends an IGMP Leave message to the switching hubs. By doing so, terminal 2-5 is allowed to leave the multicast path established on the network.

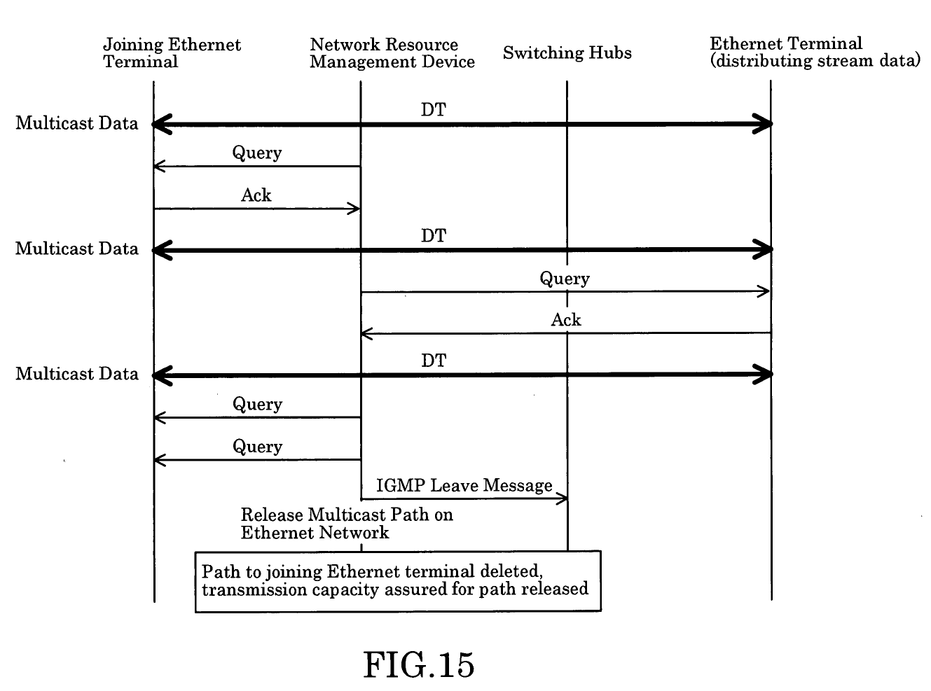

Now, FIG. 15 is a sequence diagram used to explain the communication procedure of the sixth embodiment, including a transmit procedure for a multicast group Query. When the multicast path illustrated in FIG. 14 is established, as shown in FIG. 15, the network resource management device periodically transmits a multicast group Query to the terminals. If a terminal responds to the multicast group Query, the network resource management device does not require the switching hubs to delete the group from the forwarding table. The terminal that leaves the multicast group does not respond to the Query from the network resource management device. If several Queries receive no response from a terminal belonging to the multicast group, the network resource management device releases the path and transmission capacity assured along the path to the terminal and sends an IGMP Leave message to the switching hubs. By doing so, the network resource management device requests that the switching hubs delete the terminal that does not respond to the Queries from the multicast group in the forwarding table.

In addition, the components of GMRP, whose operation relies upon GARP, run on both the switching hubs and the terminals. On the terminals, GMRP is used in combination with IGMP. The switching hubs receive both Layer 2 GYP traffic and Layer 3 IGMP traffic from the terminals. In the switching hubs, the received GMRP traffic is used to limit multicasting on the network, to which the terminals are connected in Layer 2.

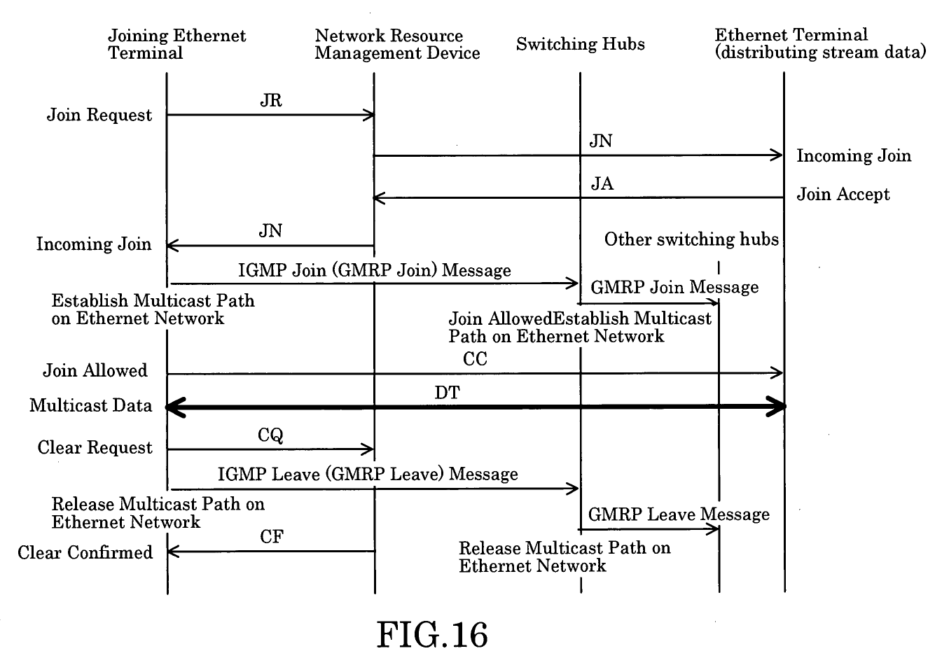

FIG. 16 is a diagram used to explain the communication procedure of the sixth embodiment, which includes an IGMP Jion and a GMRP Join message. When terminal 2-5 illustrated in FIG. 16 joins a multicast group, the network resource management device uses a Join Request (JR) packet, a JOIN CALL (JN) packet, a Join Accept (JA) packet, and a JOIN CALL (JN) packet to assure a multicast path and transmission capacity for the multicast path and authorize the join of terminal 2-5 to the multicast group. At such time, the network resource management device instructs terminal 2-5 to send a JOIN COMPLETE (CC) packet to terminal 2-1, which is carrying out stream data delivery. Terminal 2-5, whose join to the multicast group has been authorized, sends an IGMP Join message to switching hub 3-6. Based on the IGMP Join message, the switching hub that receives the IGMP Join message from terminal 2-5 generates a GMRP Join message to inform the other switching hubs of the fact that terminal 2-5 has joined the multicast group. After that, terminal 2-5 sends a JOIN COMPLETE (CC) packet to terminal 2-1, which is carrying out stream data delivery, and multicast communication is established.

When terminal 2-5 leaves the multicast group, upon receipt of a Clear Request (CQ) packet from terminal 2-5 by the network resource management device, the network resource management device releases the path to terminal 2-5 and the transmission capacity assured for the path and transmits a Clear Confirmation (CF) packet to terminal 2-5, allowing terminal 2-5 to leave the multicast group. After terminal 2-5 has transmitted a Clear Request (CQ) packet to the network resource management device, terminal 2-5 transmits an IGMP Leave message to a switching hub. Based on the IGMP Leave message, the switching hub that receives the IGMP Leave message from terminal 2-5 generates a GMRP Leave message to inform other switching hubs of the fact that terminal 2-5 has left the multicast group.

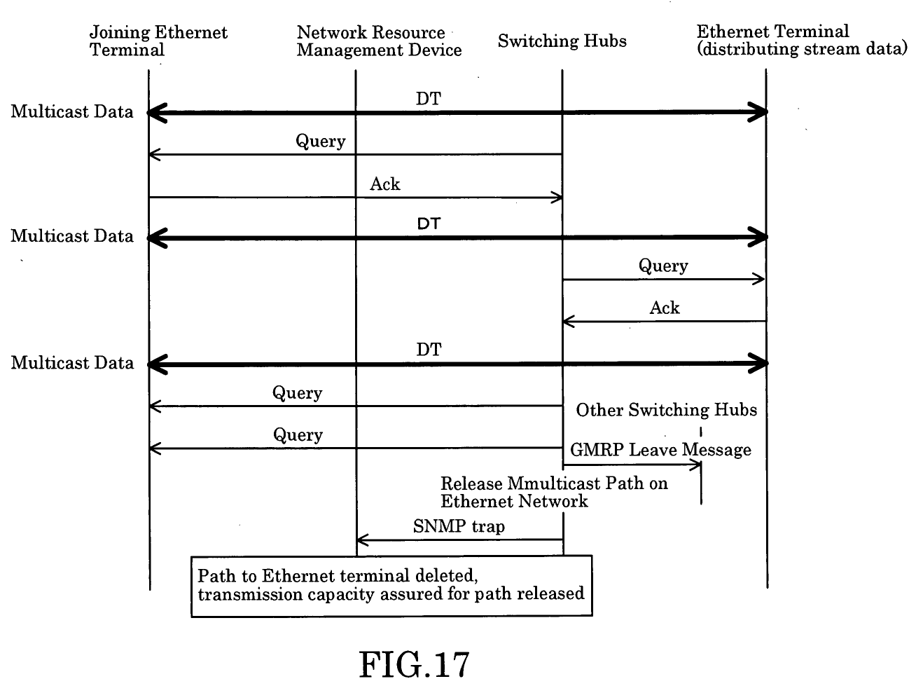

Now, FIG. 15 is a sequence diagram used to explain the communication procedure of the sixth embodiment, including an SNMP trap. When the multicast path illustrated in FIG. 16 is established, as shown in FIG. 17, the switching hubs periodically transmit a multicast group Query to the terminals. When a terminal responds to the multicast group Query, the switching hubs don't do anything. The terminal that leaves the multicast group either transmits a Leave message or does not respond to the Queries from the switching. If no response is received from a terminal belonging to the multicast group after a number of Queries sent from the switching hubs, the switching hubs allow the terminal to leave the multicast group using a GMRP Leave message. At such time, the network resource management device is notified by an SNMP trap of the fact that a GMRP Leave message has been issued by the switching hubs and the terminal's MAC address to be deleted. The network resource management device, upon receipt of the SNMP trap containing the MAC address of the terminal that is allowed to leave, reduces the capacity allocated to all the multicast paths by the amount allocated to the terminal leaving the multicast group.

As described above, when multicast delivery is carried out using terminals, switching hubs and a network resource management device supporting IGMP and GMRP, multicast delivery is carried out using IGMP and GMRP.

In addition, the transmission capacity assured by the network resource management device may be equal to the transmission capacity guaranteed between terminal 2-1 and terminal 2-8 along the path obtained by removing redundant portions from the path from terminal 2-1 to terminal 2-5 and the path from terminal 2-1 to terminal 2-8.

For instance, if terminals belonging to an existing multicast group have been communicating with one another at 10 Mbps, and a terminal that has just joined the multicast group desires to perform data transmission at 2 Mbps, 2 Mbps are added to the transmission capacity of 10 Mbps, at which the terminals belonging to the existing multicast group has been communicating, and the capacity is increased to 12 Mbps. By doing so, all the terminals belonging to the multicast group can transmit data to one another.

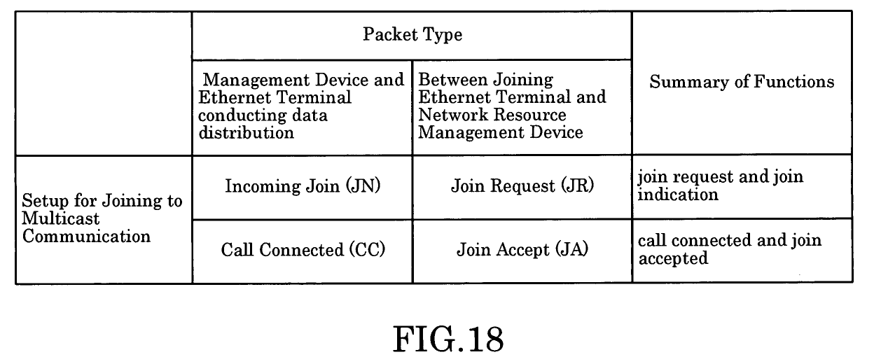

In a addition, when using GVRP, whose operation is similar to that of GMRP, a single path decided based on MAC address learning between terminals along multicast paths or end-to-end is assured by forming a dynamic VLAN and unwanted broadcast or unknown unicast traffic can be eliminated. The functions and classification of packets used in this communication sequence are shown in FIG. 18.

### Embodiment 7

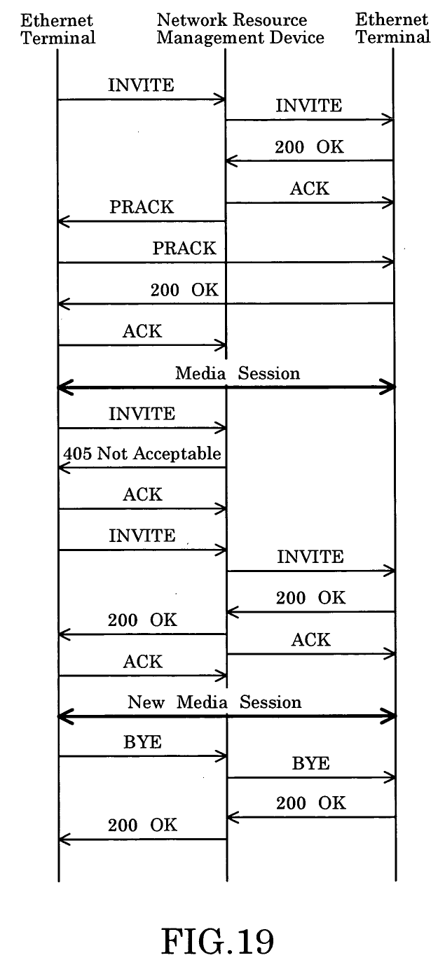

The call processing illustrated in the first embodiment can be based on the use of other protocols. As an example, FIG. 2 and FIG. 3, as well as FIG. 19 through FIG. 23 are used to provide explanations regarding a case, in which bidirectional stream data transmission is carried out using SIP (Session Initiation Protocol: RFC 2543), which is widely used for IP telephony, etc.

When terminal 2-1 forwards stream data to terminal 2-8, the network resource management device receives an INVITE request from call request terminal 2-1 and learns the request source IP address, request destination IP address, and the reserved bandwidth it intends to use. Based on this information, the network resource management device allocates transmission capacity and determines a single path using the database illustrated in FIG. 2 and the communication connection management database illustrated in FIG. 3.

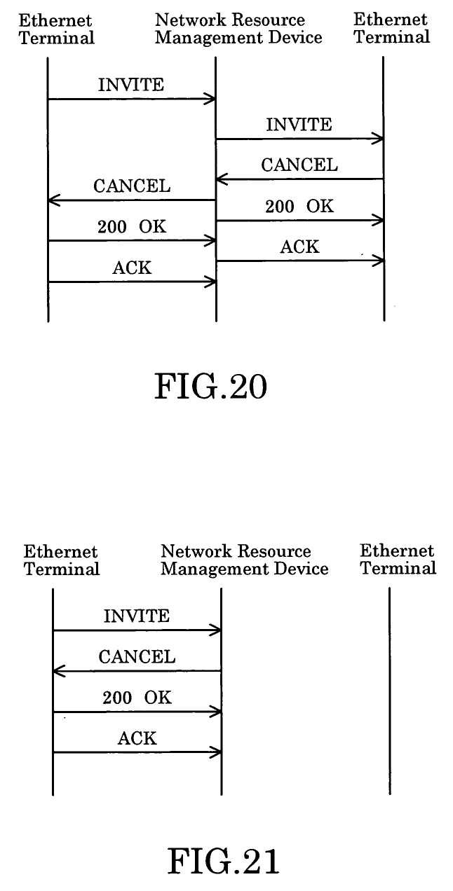

FIG. 19 is a sequence diagram used to explain the communication procedure of the seventh embodiment. In addition, FIG. 20 is a sequence diagram used to explain the communication procedure of the seventh embodiment, including a CANCEL transmit procedure used by a terminal. If the network resource management device cannot assure bidirectional transmission capacity for the call request, then the call request is rejected using an SIP-method CANCEL.

As shown in FIG. 19, if the network resource management device can assure the requested bidirectional transmission capacity, it transmits an INVITE request containing the IP address of call request terminal 2-1 (hereinafter referred to as the request source IP address) and the IP address of the call requested terminal (hereinafter referred to as the request destination IP address) to call requested terminal 2-8. Subsequently, the network resource management device receives information on acceptance/rejection of communication from the call requested terminal 2-8 using an SIP response code.

FIG. 21 is a sequence diagram used to explain the communication procedure of the seventh embodiment, including a CANCEL transmit procedure used by the network resource management device. Here, when call requested terminal 2-8 rejects communication, as illustrated in FIG. 21, initiation of communication is rejected using CANCEL. When call requested terminal 2-8 allows communication, the network resource management device sends a PRACK request containing a request destination IP address and a request destination IP address to call request terminal 2-1. At such time, the network resource management device instructs call request terminal 2-1 to forward a PRACK request to call requested terminal 2-8. Following that, call request terminal 2-1 forwards a PRACK request to call requested terminal 2-8, and call requested terminal 2-8, which receives it, sends an SIP 200OK response code to call request terminal 2-1, thereby establishing bidirectional communication with equal transmission capacity.

In response to the final 200OK response code, the switching hubs in the end-to-end interval terminate the process of learning of the request destination MAC address.

In addition, it is possible to modify an established session later by executing an INVITE/200/ACK sequence once again. As long as an SIP request of a certain type is not completed, no requests of the same type can be sent again. In addition, the media session is continued uninterrupted so long as no BYE is received from any of the terminals. A communication disconnect is carried out using an SIP-method BYE. It can be executed from any terminal.

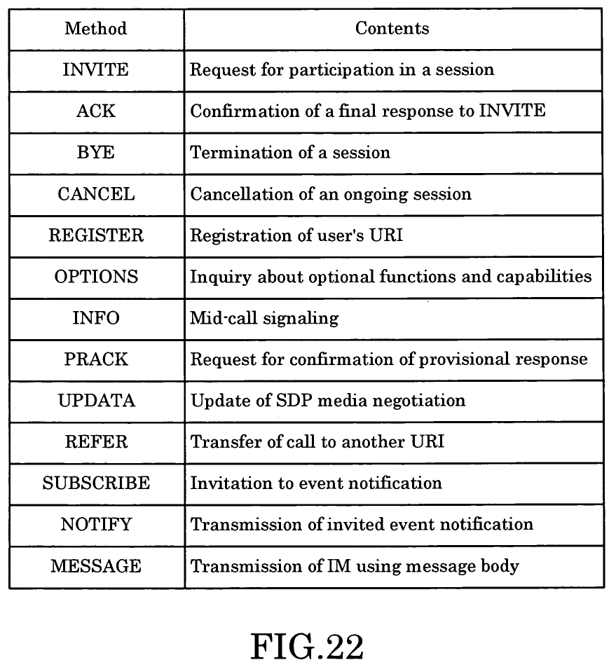

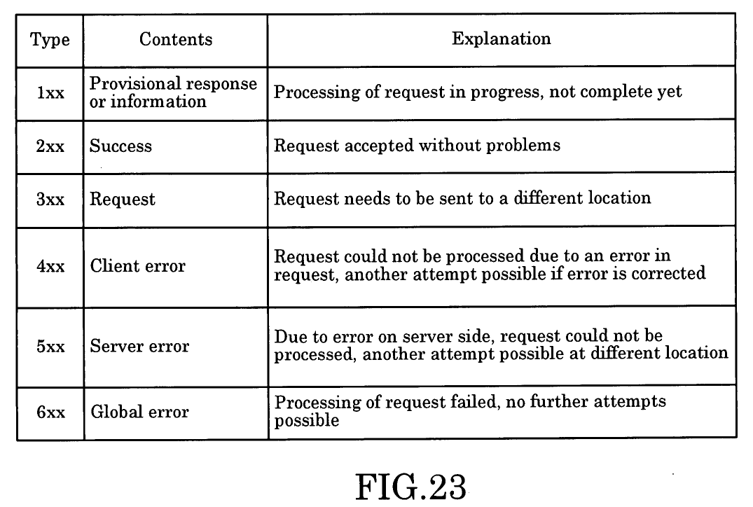

As illustrated above, implementations based on communication sequences used in SIP are also possible. Here, the SIP method is illustrated in FIG. 22 and SIP response code classification is illustrated in FIG. 23.

In the seventh embodiment, SIP was used as an example, but H.323 may be applicable to for call processing in a similar manner.

### Embodiment 8

The network resource management device is placed such that it is either connected to a switching hub, which is connected to high-speed transmission links, or incorporated into such a switching hub. When it is connected to high-speed transmission links, as in this embodiment, even if the traffic used for the communication procedure tends to be concentrated in one area, adverse effects can be reduced. However, it is preferably arranged in the vicinity of the root (root) of the tree structure used for building the network, as shown in FIG. 1. By doing so, uneven concentration of the traffic used for the communication procedure in specific branches of the tree topology can be avoided.

### Embodiment 9

In order to avoid communication troubles due to failure or elimination of transmission links, switching hubs are sometimes connected in a loop. When loops occur on a network, loops can be avoided through the application of the spanning tree protocol (IEEE 802.1D) between the switching hubs. Here, the term “spanning tree protocol” refers to a technology for rebuilding a network so that loops are not formed logically even though the physical network does form loops.

Changes in the topology of the network occur as a result of elimination, addition, failure, or recovery of transmission links configured using the spanning tree protocol. Depending on which transmission links are modified, there may be changes in the end-to-end communication paths with guaranteed transmission capacity. In such a case, because it traverses transmission links, for which no transmission capacity is allocated in the network resource management device (transmission links initially configured as backup links in the spanning tree or newly added transmission links), it becomes impossible to guarantee the maximum end-to-end transmission capacity between a pair of terminals if changes in topology made by the spanning tree protocol occur during communication with guaranteed maximum transmission capacity.

Below, explanations are provided regarding an embodiment, in which a network can be provided that ca guarantee maximum transmission capacity even in a network environment where the spanning tree protocol is used.

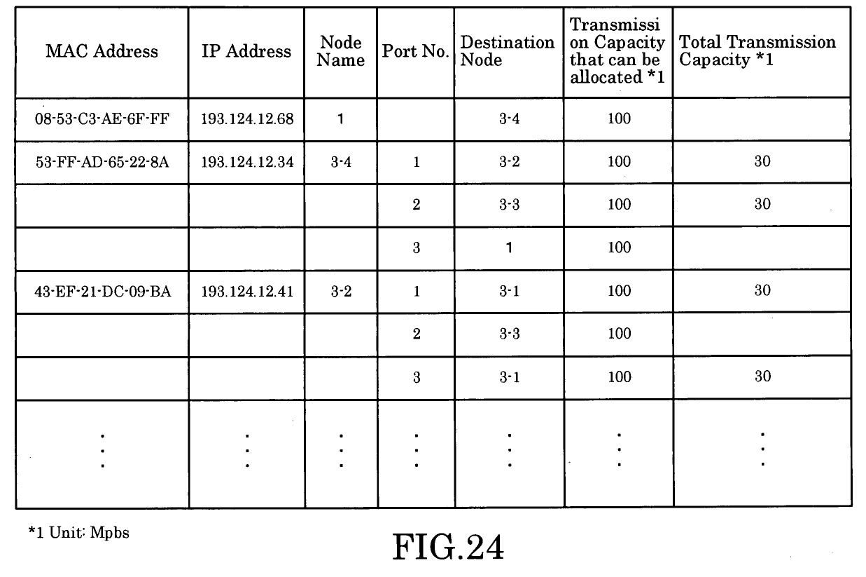

In a network composed of switching hubs with an MAC address learning function and a network resource management device that guarantees the maximum transmission capacity, the network resource management device uses call processing performed at the start of end-to-end communication between the network resource management device and terminals in order to allocate transmission capacity for a single path in a capacity allocation management database that stores the total transmission capacity allocated to call requests from the terminals, port transmission capacity, connection destination nodes, port numbers of the switching hubs, node names, IP addresses, and MAC addresses of the nodes, as illustrated in FIG. 24. Detailed explanations are omitted here because they have been provided in the fifth embodiment.

As was explained in the fifth embodiment, to decide the maximum delay time of the transmission links that link the terminals, the terminals require management of the transmission capacity (frame rate) to be used by the transmission links. TCP Vegas is one such example. The commonly used TCP Reno makes use of segment loss to perform window size adjustment for windows that become too large. Consequently, throughput decreases because window size becomes smaller than necessary immediately upon occurrence of segment loss. On the other hand, TCP Vegas looks at the RTT (Round Trip Time) of transmitted segments and uses its fluctuations for window size adjustment.

Namely, if the RTT becomes longer, it determines that the network is congested and reduces the window size, and, conversely, if the RTT becomes shorter, it increases the window size. By doing so, the transmission rate can be controlled. It should be noted that this offers the advantage of achieving a reduction in buffer size because using a method that involves transmission at frame intervals instead of transmission, during which traffic concentrates within the time period of the window, leads to a reduction in the peak rate. Another preferable protocol is UDP (User Datagram Protocol), which limits the peak rate by controlling the frame interval. In the present embodiment it is a pre-requisite for each terminal to perform such management of the transmission capacity to be used by the transmission links.

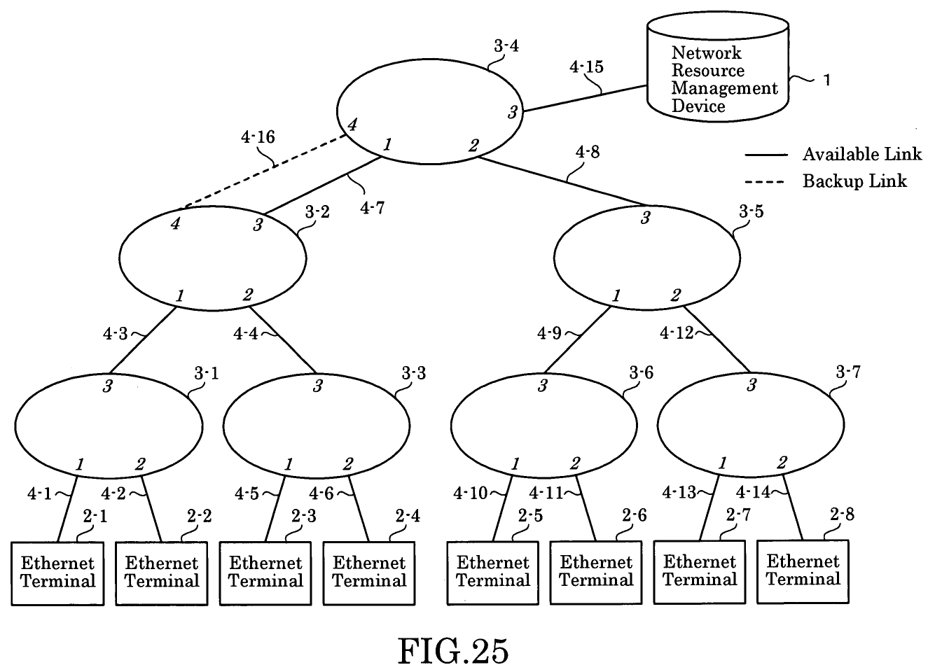

In a network composed of such switching hubs with an MAC address learning function and a network resource management device that ensures the maximum transmission capacity, the spanning tree protocol is used for avoiding loops between the switching hubs. At such time, the network resource management device allocates transmission capacity to all communication paths that may be switched to by the network resource management device in connection with call requests used to guarantee transmission capacity for transmission links configured in accordance with the spanning tree protocol, which makes communication with guaranteed maximum transmission capacity possible even if available links are cut off and converted into backup links, which will be explained with reference to FIGS. 25 to 27.

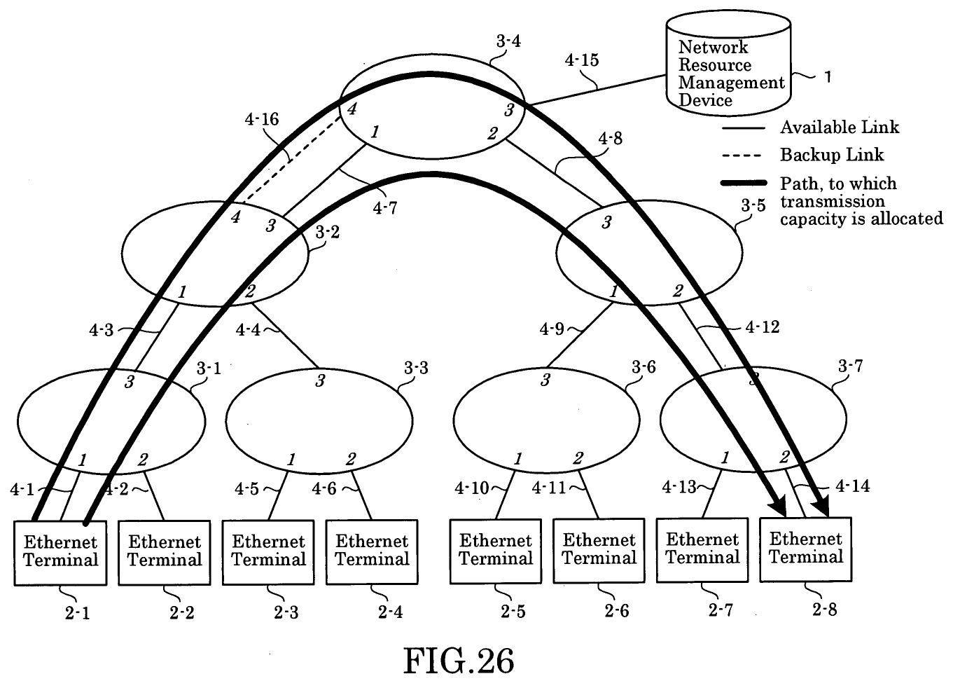

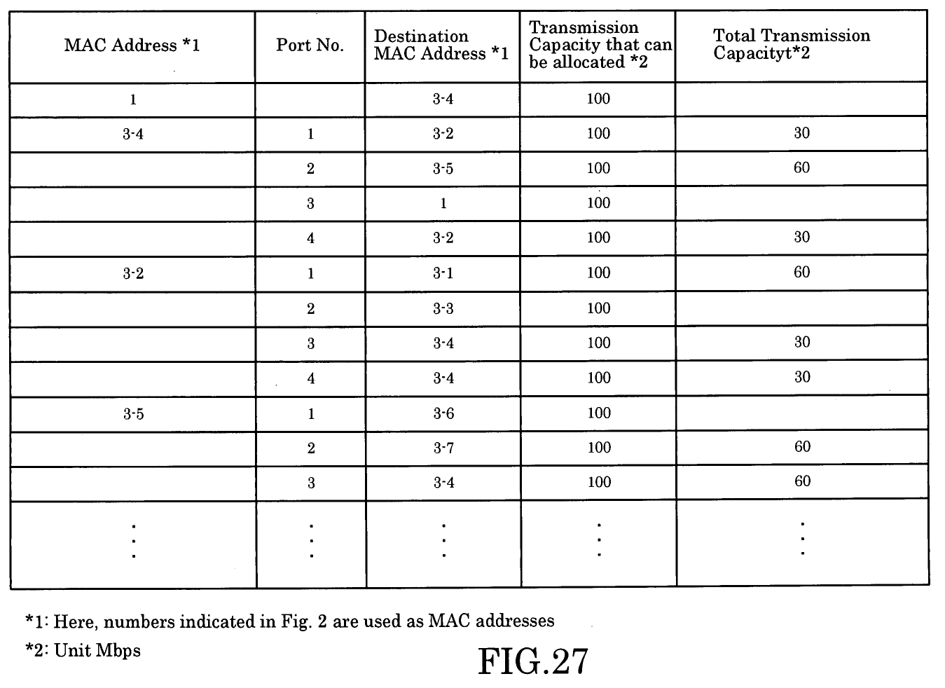

FIG. 26 is a block diagram illustrating an embodiment of the present invention. While the basic configuration is the same as in the first embodiment, the spanning tree protocol initially configures the transmission links as available links (Available Links) and backup links (Backup Links). In FIG. 26, available links are shown with solid lines and backup links are shown with dotted lines. In addition, the numbers shown in the switching hubs illustrated in FIG. 26 represent the port numbers of the switching hubs.

When transmission links 4-7 and 4-16 create a double connection between switching hubs 3-4 and 3-2, which are shown in FIG. 26, a loop is generated between switching hubs 3-4 and 3-2. To avoid the loop, the spanning tree protocol operates between the switching hubs and forms a topology that avoids the loop.

In the network, in which loops are avoided using the spanning tree protocol (transmission link 4-7 is an available link), the network resource management device allocates transmission capacity at the time of a call request to all end-to-end paths decided based on call requests from terminals. By doing so, data transmission can be conducted without a decrease in throughput even if available links are converted into backup links as a result of elimination or failure.

For instance, in FIG. 25, when terminal 2-1 and terminal 2-8 establish communication with a guaranteed maximum transmission capacity of 30 Mbps, the capacity allocation database in the network resource management device, as illustrated in FIG. 26 and FIG. 27, allocates 30 Mbps to the end-to-end paths “transmission links 4-1→4-3→4-7→4-8→4-12→4-14” and “transmission links 4-1→4-3→4-16→4-8→4-12→4-14”, respectively. However, because in the actual network the transmission link 4-7 is configured as an available link, communication is initiated using the path “transmission links 4-1→4-3→4-7→4-8→4-12→4-14”.

If transmission link 4-7 is disconnected in the process of establishing communication between terminal 2-1 and terminal 2-8 and communication is rendered impossible along the end-to-end path managed by the network resource management device, switching hub 3-2, based on the spanning tree protocol, switches the available link from transmission link 4-7 to transmission link 4-16. With respect to data traveling along “transmission links 4-1→4-3→4-7→4-8→4-12→4-14”, data transfer can be continued using “transmission links 4-1→4-3→4-16→4-8→4-12→4-14”, to which transmission capacity has been allocated in advance. Here, in the capacity allocation management database illustrated in FIG. 24, the MAC addresses of the nodes are represented by node (network resource management device, switching hubs, and terminals) numbers illustrated in FIG. 26, and only the portions related to the explanations are shown. Moreover, node names and IP addresses have been omitted.

As a result of allocating transmission capacity in advance to all the communication paths that the network resource management device may switch to, data transmission can be performed without a decrease in throughput even if such spanning tree protocol-induced changes in topology do take place.

However, it is possible that a switch to these transmission links may trigger a period, during which MAC addresses will remain unlearned. The failure recovery time required in case of a spanning tree for switching from the available link (Available Link) to a backup link (Backup Link) as a result of disconnection, etc. of a transmission link, would be several dozen seconds (about 50 sec); however, using the rapid spanning tree protocol (IEEE 802.1w) can shorten the failure recovery time to within several seconds (about 50 msec). In addition, after the recovery from the transmission link switch, MAC address learning by the switching hubs is not yet complete. Therefore, assuming that switching hubs according to prior Application B will process frames with the maximum assured transmission capacity as non-priority until the switching hubs finish MAC address learning (communication without guaranteed capacity), a temporary degradation in quality may occur, but because there is no longer need for re-allocation of transmission capacity to transmission links by the network resource management device, changes in topology during communication with guaranteed maximum transmission capacity can be promptly addressed.

### Embodiment 10

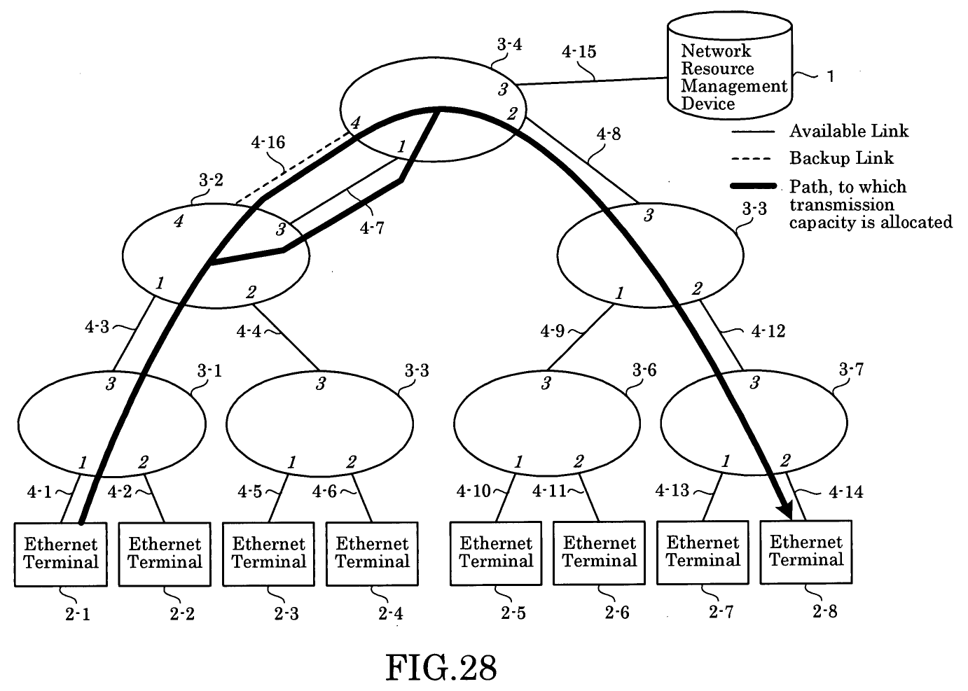

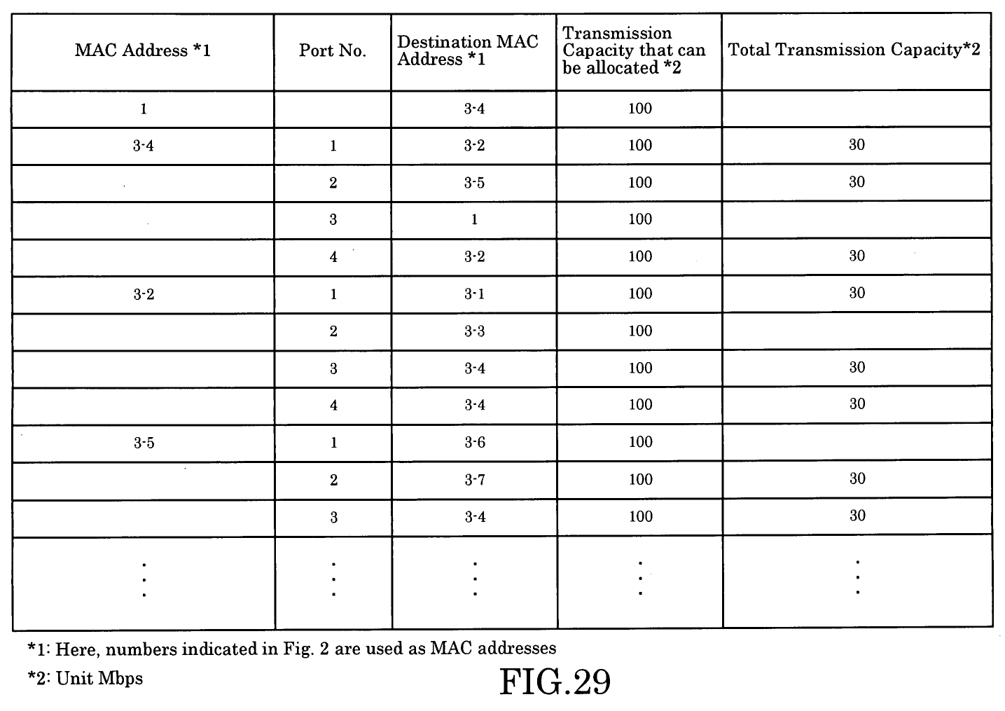

FIG. 25, FIG. 28, and FIG. 29 are used to explain that, in the first embodiment, when transmission capacity is allocated to all the communication paths the network resource management device may switch to in connection with a call request regarding guaranteed transmission capacity for a transmission link configured based on the spanning tree protocol, transmission capacity allocation is not duplicated for paths where communication paths overlap.

Namely, in the ninth embodiment, duplicate transmission capacity (60 Mbps) does get allocated to paths where communication paths overlap because transmission capacity is allocated to each communication path associated with a call request (30 Mbps) regarding guaranteed transmission capacity, as shown in FIG. 27, but in the present embodiment, resource management is carried out in such a manner that there is no duplicate allocation to paths traversing backup links (Backup Link) and paths traversing available links (Available Link) configured based on the spanning tree protocol and even if the available links are converted into backup links due to elimination or failure, data transmission can be performed without a decrease in throughput.

For example, in FIG. 25, the network resource management device performs resource management of transmission link 4-7 and transmission link 4-16 in a similar manner. However, on the network, based on the spanning tree protocol, only transmission link 4-7 is available.

When terminal 2-1 and terminal 2-8 establish communication with a guaranteed maximum transmission capacity of 30 Mbps, the capacity allocation database of the network resource management device allocates 30 Mbps to the end-to-end path “transmission links 4-1→4-3→4-7→4-8→4-12→4-14”. At such time, as illustrated in FIG. 28 and FIG. 29, 30 Mpbs is allocated to transmission link 4-16, which is configured as a backup link based on the spanning tree protocol, in the same manner as to transmission link 4-7. That is, the amount allocated to transmission links 4-8→4-12→4-14 and transmission links 4-1→4-3, where paths overlap, is 30 Mbps and not 60 Mbps. If transmission link 4-7 is disconnected in the process of establishing communication between terminal 2-1 and terminal 2-8 and communication is rendered impossible along the end-to-end path managed by the network resource management device, switching hub 3-2, based on the spanning tree protocol, switches the available link from transmission link 4-7 to transmission link 4-16. At such time, data traveling through transmission link 4-7, as illustrated in FIG. 28 and FIG. 29, can continue being forwarded through transmission link 4-16, which has the same maximum transmission capacity allocated thereto in advance as transmission link 4-7. Here, in the capacity allocation management database illustrated in FIG. 29, the MAC addresses of the nodes are represented by node (network resource management device, switching hubs, and terminals) numbers illustrated in FIG. 28, and only the portions related to the explanations are shown. Moreover, node names and IP addresses have been omitted.

Because available links and backup links are subjected to identical resource management in advance, data transmission can be performed without a decrease in throughput even if there are changes in topology due to the spanning tree protocol. Moreover, even though in the first embodiment duplicate transmission capacity does get allocated to overlapping paths as a result of performing resource management for each end-to-end path separately, in this embodiment, as a result of identical resource management for available links and backup links, there is no need to allocate duplicate transmission capacity to overlapping paths and it is sufficient to allocate transmission capacity corresponding to the call request. This permits efficient use of network resources.

### Embodiment 11

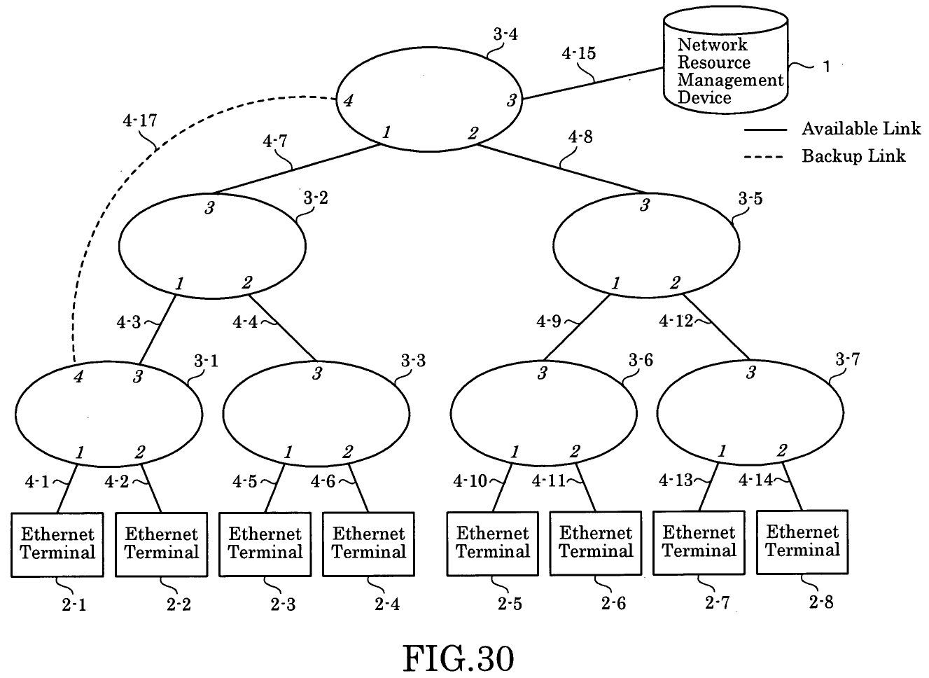

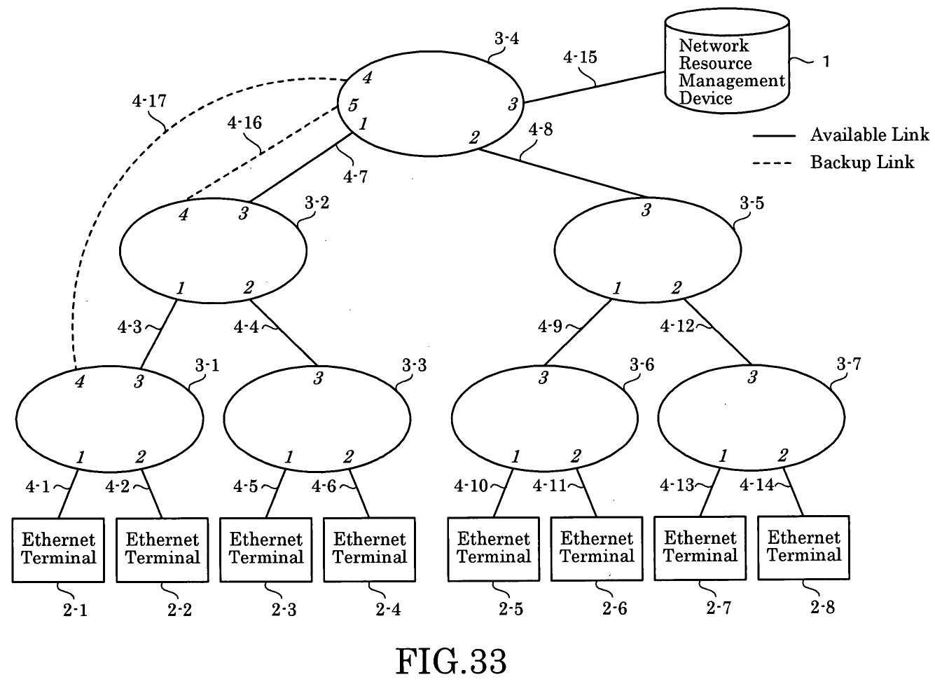

In order to explain an example of a plurality of spanning tree protocols operating together, the operation of the spanning tree protocol in a location different from FIG. 25 is illustrated in FIG. 30 (in this configuration, a loop is formed by switching hubs 3-4, 3-2, and 3-1 and by transmission links 4-3, 4-7, and 4-17). Moreover, FIG. 33 illustrates a case (as an example of a containment relationship), in which loop architectures of FIG. 30 and FIG. 25 are used.

In the present embodiment, FIG. 30 through FIG. 35 are used to explain network resource management, in which allocation of the same transmission capacity as the one requested in a call request to all loop-forming transmission links in case loops are discovered in the path by the spanning tree protocol when the network resource management device receives a call request from a terminal and allocates transmission capacity to an end-to-end path corresponding to the call request makes it possible to carry out communication with guaranteed maximum transmission capacity even if transmission links get disconnected and changes in topology are made by the spanning tree protocol.

In FIG. 30, the network resource management device performs resource management for transmission links 4-3, 4-7, and 4-17 in a same manner. Here, based on the spanning tree protocol on the network, transmission links 4-3 and 4-7 are configured as available links (Available Link) and transmission link 4-18 is configured as a backup link (Backup Link).

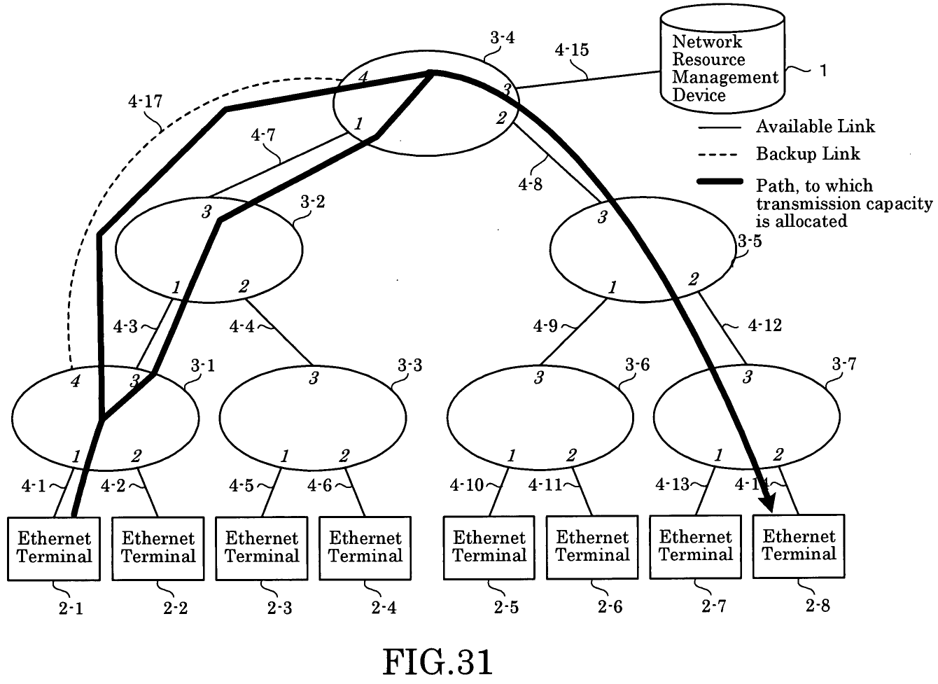

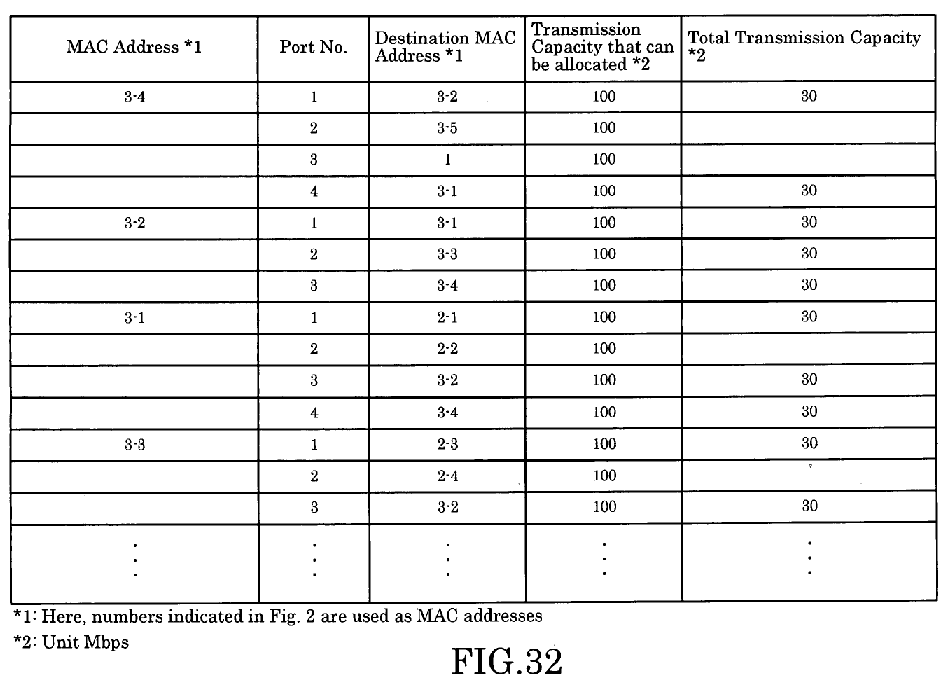

When terminal 2-1 and terminal 2-8 establish communication with a guaranteed maximum transmission capacity of 30 Mbps, the capacity allocation database of the network resource management device allocates 30 Mbps to the end-to-end path “transmission link 4-1→4-3→4-7→4-8→4-11→4-14”. At such time, the network resource management device also allocates 30 Mbps to transmission link 4-17, which is configured as a backup link based on the spanning tree protocol, as illustrated in FIG. 31 and FIG. 32. By doing so, transmission capacity is allocated to all transmission links configured based on the spanning tree protocol between terminal 2-1 and terminal 2-8, as illustrated in FIG. 32, and, as a result, communication with guaranteed maximum transmission capacity is made possible between terminal 2-1 and terminal 2-8 even if there are changes in topology due to disconnection etc. of transmission links.

Next, in FIG. 33 (containment relationship), where the loop architecture of FIG. 25 and FIG. 30 is used, the network resource management device performs resource management for transmission links 4-3, 4-7, 4-16, and 4-17 in the same manner. Here, based on the spanning tree protocol on the network, transmission links 4-3 and 4-7 are configured as available links and transmission links 4-16 and 4-17 are configured as backup links.

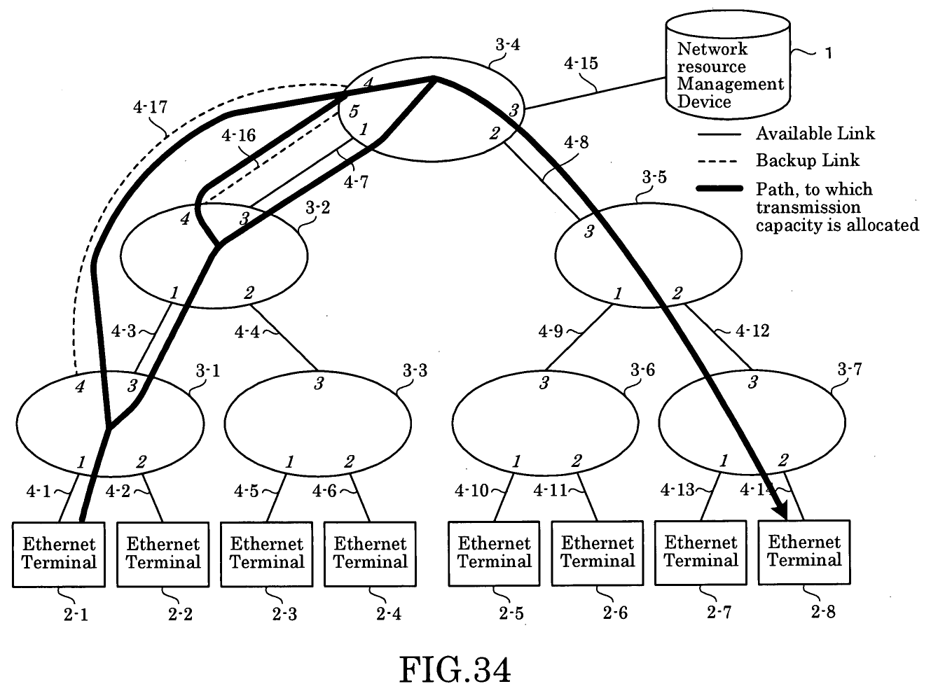

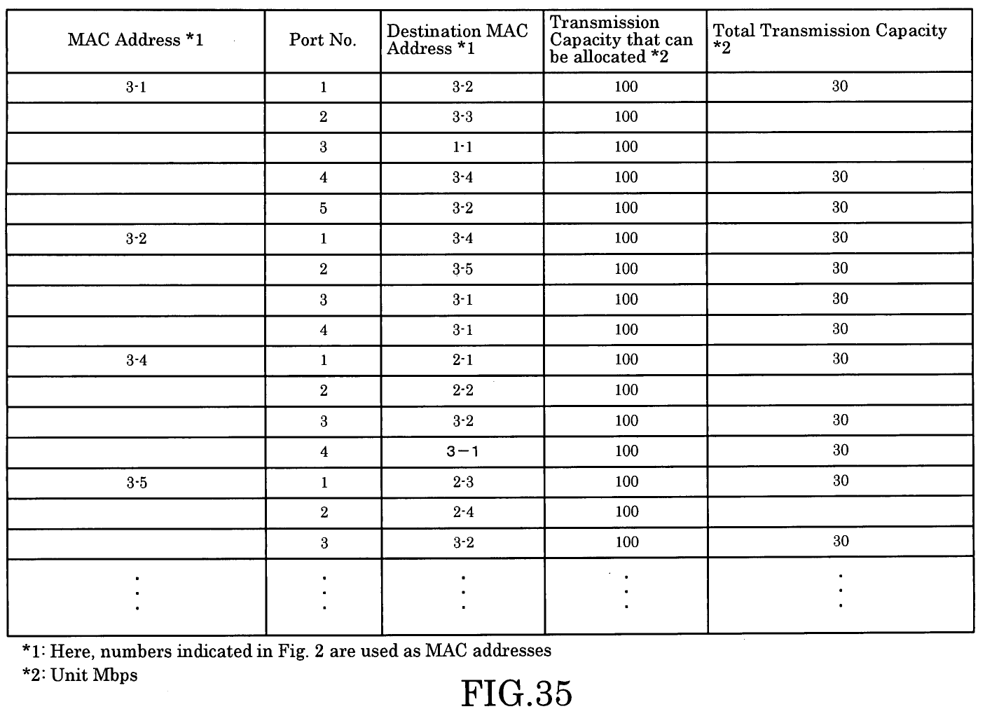

When terminal 2-1 and terminal 2-8 establish communication with a guaranteed maximum transmission capacity of 30 Mbps, the capacity allocation database of the network resource management device allocates 30 Mbps to the end-to-end path “transmission link 4-1→4-3→4-7→4-8→4-12→4-14”. At such time, the network resource management device also allocates 30 Mbps to transmission link 4-17, which is configured as a backup link based on the spanning tree protocol, as illustrated in FIG. 34 and FIG. 35. Moreover, in the same manner, 30 Mbps is allocated to transmission link 4-16, which forms a loop together with transmission links 4-3, 4-7, and 4-17, without duplicate transmission capacity allocation to the overlapping-path portion “transmission links 4-1→4-3 and transmission links 4-8→4-12→4-14”. By doing so, transmission capacity is allocated to all transmission links configured based on the spanning tree protocol between terminal 2-1 and terminal 2-8, and, as a result, communication with guaranteed maximum transmission capacity is made possible between terminal 2-1 and terminal 2-8 even if there are changes in topology due to disconnection etc. of transmission links.

As described above, when the network resource management device receives a call request from a terminal and allocates transmission capacity along an end-to-end path corresponding to the call request, it allocates the same transmission capacity as the one requested in the call request to all the loop-forming transmission links on the network, and thereby enables communication with guaranteed maximum transmission capacity even in case of changes in topology due to disconnection of transmission links.

### Embodiment 12

The embodiments above are premised on all the terminals on the network having guaranteed maximum transmission capacity and are not applicable to networks where such terminals co-exist with conventional Best Effort-type terminals because of the influence exerted by their traffic. Furthermore, there is the condition (avoidance of flooding) that the switching hubs finish MAC address learning by the start of communication, and, as a way of achieving that, frames used for MAC address learning (send address-oriented learning) by the switching hubs have been sent in advance between the terminals, from a receive-side terminal to a transmit-side terminal.

Below, explanations are provided regarding an embodiment, in which network resources are allocated such that the maximum transmission capacity is guaranteed for specific terminals on a network, on which they co-exist with conventional Best Effort type terminals.

In order permit co-existence of conventional Best Effort type terminals and terminals with guaranteed maximum transmission capacity on a network, priority processing is included in the processing performed by the switching hubs, with frames pertaining to communication between terminals with guaranteed maximum transmission capacity sent to transmission links in a preferential manner. In other words, influence on traffic between terminals with guaranteed maximum capacity is avoided by handling the processing of conventional Best Effort terminals on a non-priority basis.

While the above-described application examples were premised on completion of MAC address learning by the start of communication, in this embodiment, when input frames have priority markings, they are processed and sent to transmission links in a preferential manner. As a result, even if there are frames with unlearned MAC addresses at the start of communication, the flooding is the same type of non-priority flooding as in case of frames transmitted by conventional terminals, and does not affect communication between already communicating terminals with guaranteed maximum transmission capacity, which are subject to priority processing. However, the maximum transmission capacity can be guaranteed if only the switching hubs of the present embodiment are located along the path between the terminals, and including previously existing hubs results in a Best-Effort transmission.

Moreover, adding completion of destination MAC address learning as a precondition of sending frames to transmission links in a preferential manner results in the same type of non-priority flooding as in case of conventional Best Effort-type frames even if there are frames with unlearned MAC addresses at the start of communication and makes it possible to avoid adverse influence on communication between already communicating terminals with guaranteed maximum transmission capacity, which are subject to priority processing.

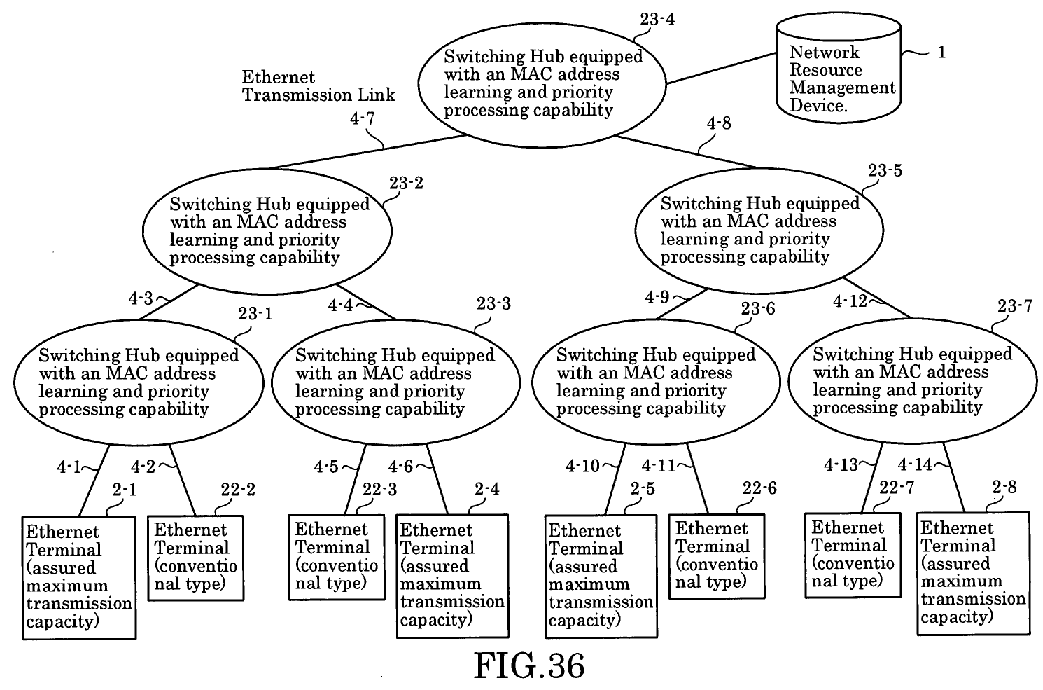

FIG. 36 through FIG. 40 are used to explain the operation of switching hubs on a network, on which communication with guaranteed maximum transmission capacity co-exists with Best Effort type communication.

The network illustrated in FIG. 36 is composed of network resource management device 1, terminals with guaranteed maximum transmission capacity 2-1, 2-4, 2-5 and 2-8, Best Effort type terminals 22-2, 22-3, 22-6 and 22-7, switching hubs with an MAC address learning function and priority processing function 23-1 to 23-7, and transmission links 4-1 to 4-14.

In this network, the network resource management device assures transmission capacity along a single path by means of call processing performed at the start of end-to-end communication between the terminals and the network resource management device. To decide the maximum delay time of the transmission links that link the terminals, the terminals carry out management of the transmission capacity (frame rate) to be used by the transmission links, as explained in the fifth embodiment. In this embodiment, it is a prerequisite that the terminals perform management of the transmission capacity to be used by the transmission links.

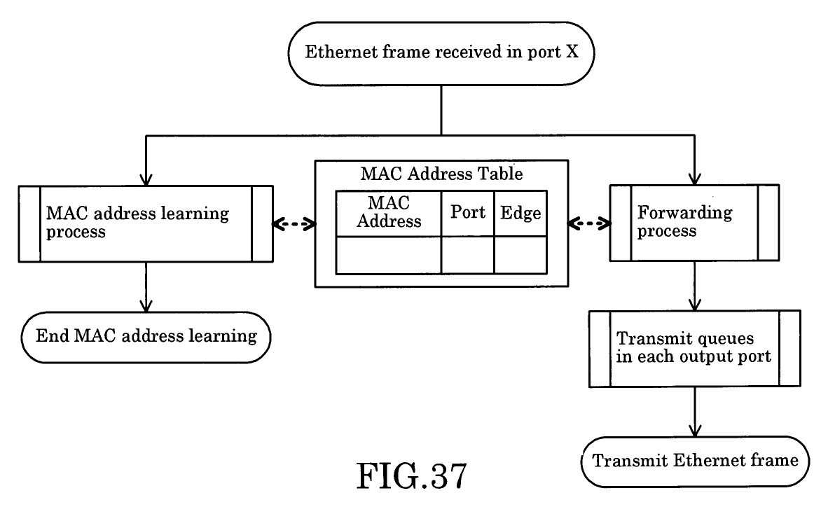

During such call processing, as shown in FIG. 37, the switching hubs learn the MAC addresses of the call requested terminals using an MAC address learning process used for MAC address learning based on source MAC addresses, as a result of which source terminals can carry out data transmission without causing flooding.

Also, when terminal 2-1 and terminal 2-4 illustrated in FIG. 36 perform communication with guaranteed maximum transmission capacity and terminal 22-2 and terminal 22-7 perform Best Effort type communication, the transmit queues of switching hubs 23-1, 23-2, 23-4, 23-5, and 23-7 may overflow as a result of increased traffic and the communication with guaranteed maximum transmission capacity may be affected by the Best Effort communication.

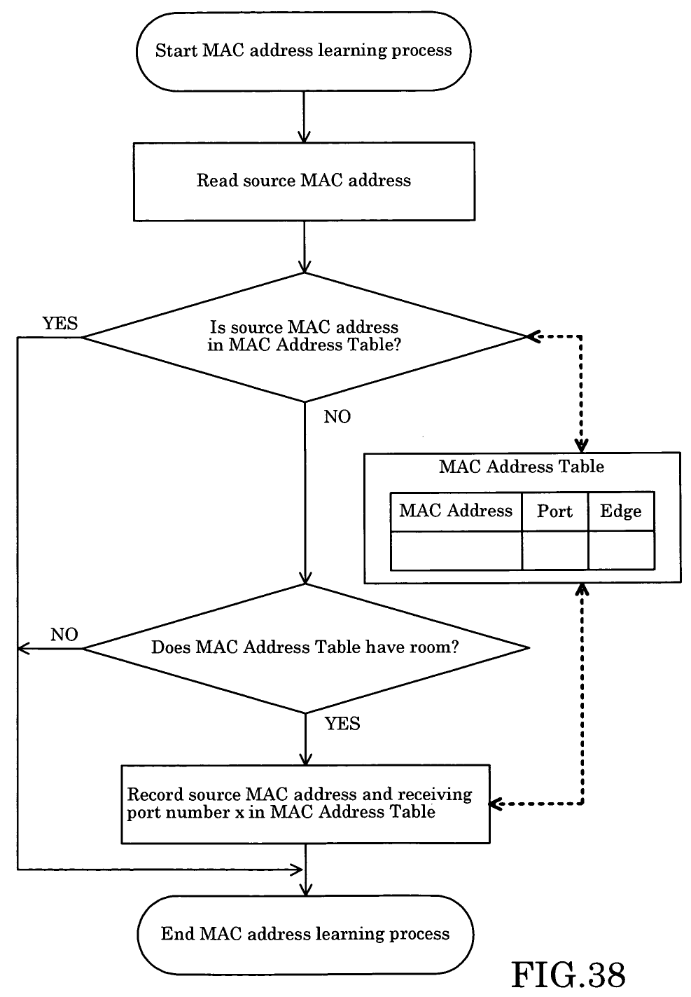

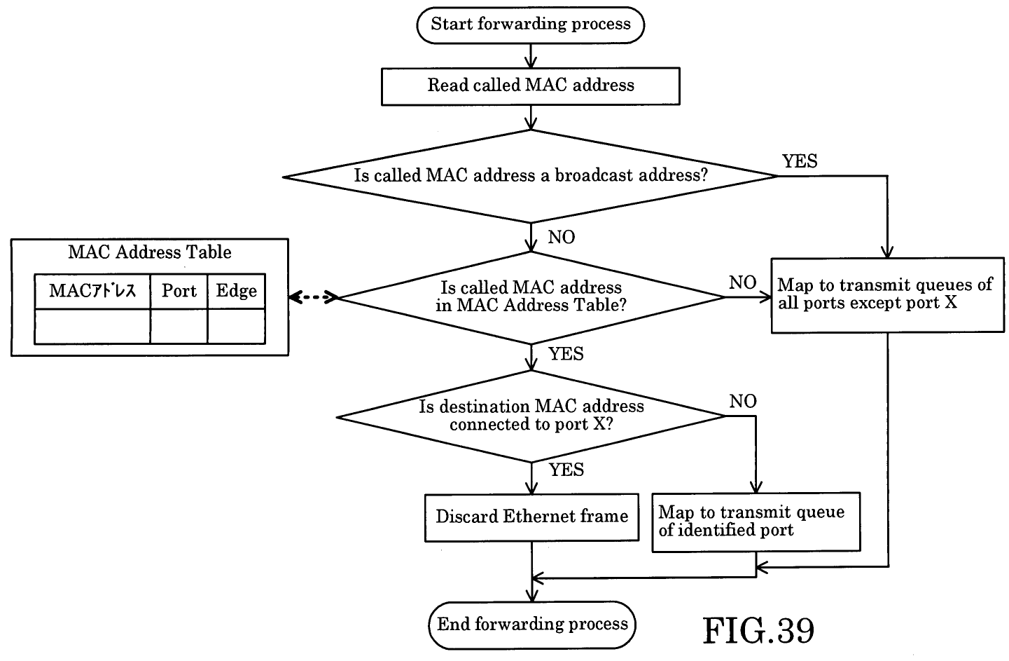

By providing a network, on which communication with guaranteed maximum transmission capacity co-exists with Best Effort type communication, with switching hubs that send frames to transmission links in a preferential manner only when frames operating as illustrated in FIG. 37 through FIG. 40 have priority markings, the adverse influence of the Best Effort type terminals can be avoided and it is possible to determine the maximum delay time (propagation delay of the transmission links and send latency of frames in the switching hubs) of the transmission network linking the terminals (which is made up of transmission links and switching hubs). It should be noted that the dotted arrows in FIG. 37, FIG. 38, and FIG. 39 refer to the operation “Record in or Consult MAC Address Table”.

As illustrated in FIG. 38, upon receipt of a frame, source MAC address-based MAC address learning is performed using the MAC address learning process in order to learn the source MAC address of the received frame. Namely, the source MAC address is read and, if the source MAC address is not in the MAC Address Table, the source MAC address and the number x of the receiving port are recorded in the MAC Address Table if the MAC Address Table has enough room.

By consulting the MAC Address Table, in accordance with the forwarding process illustrated in FIG. 39, the received frame is assessed as to whether to the frame should be scrapped or sent to an output port. The forwarding process directs the switching hub to read the destination MAC address. At such time, if the destination MAC address is a broadcast address (FF-FF-FF-FF-FF-FF), the switching hub maps the frame to the transmit queues of all ports except the receiving port. If it is not a broadcast frame, the hub checks whether its destination MAC address is in the MAC Address Table. If the destination MAC address is not in the MAC Address Table, flooding (mapping to the transmit queues of all ports except for the receiving port) is performed. If the destination MAC address is in the MAC Address Table, then, when the destination MAC address is connected to the receiving port, the frame is discarded, and when it is connected to another port, it is mapped to the transmit queue of that port.

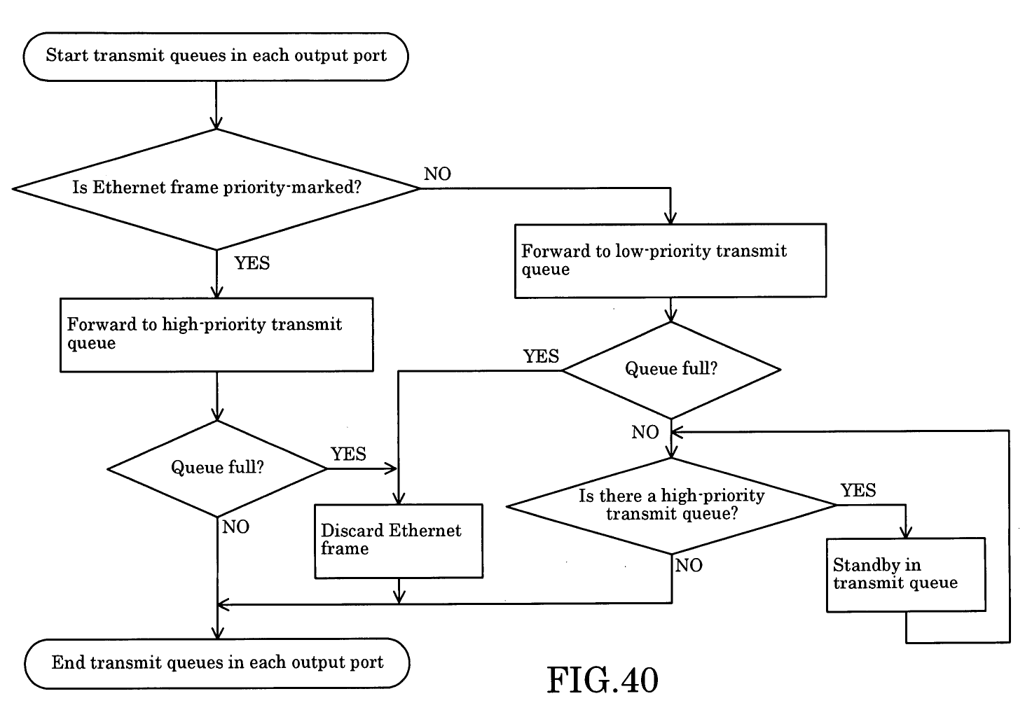

In the transmit queue of the output port determined by this forwarding process, as illustrated in FIG. 40, when a frame has a priority marking, the priority-marked frame is mapped to the transmit queue that corresponds to it. If a non-priority queue is being transmitted, adverse influence can be eliminated by interrupting the non-priority queue and immediately transmitting the priority queue. When traffic is sent to transmission links, priority is given to traffic with priority markings. However, the non-priority frames that were being transmitted need to be resent, which decreases the efficiency of non-priority transmission. In order to avoid such a decrease, they may be sent after sending one frame. In other words, this method can be used when the maximum allowable delay is the time required for a single frame.

As can be seen from the above, the characteristics of priority-marked frames can be the same as when there are no non-priority frames.

### Embodiment 13

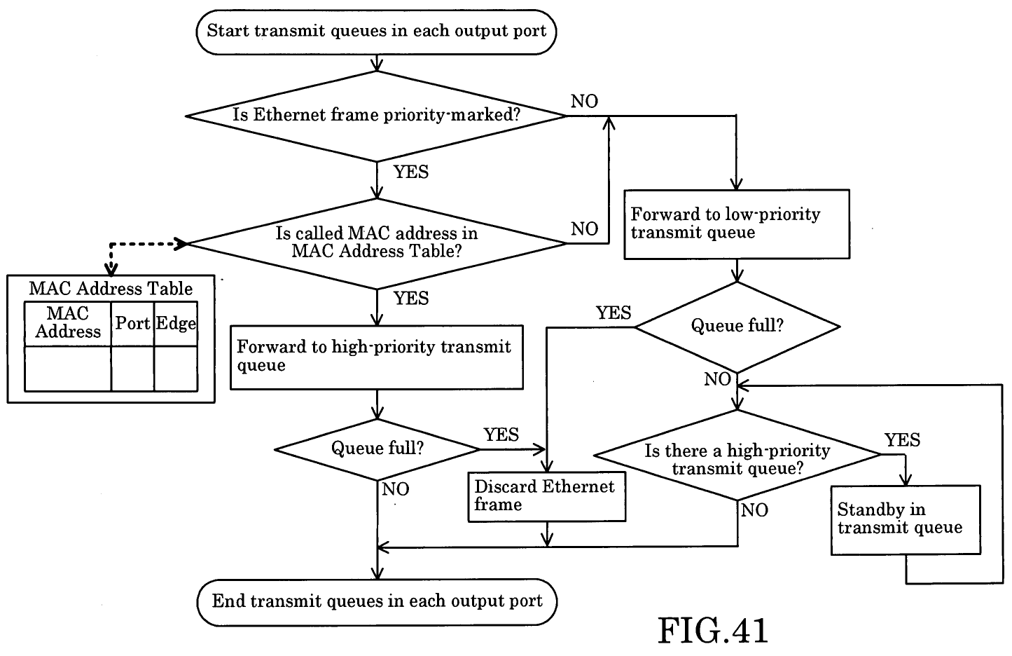

During communication described in the twelfth embodiment, flooding occurs and traffic with guaranteed maximum transmission capacity is affected if destination MAC addresses have not been learned for some reason at the start of communication with guaranteed maximum transmission capacity. As explained, this can be avoided if, in addition to the priority marking condition, processing on a preferential basis and sending to transmission links is performed only if MAC address learning is complete. FIG. 41 is used to explain the operation of the switching hubs, whereby frames are sent to transmission links in a preferential manner only when input frames have priority markings and the destination MAC address has been learned. It should be noted that the dotted arrow in FIG. 41 refers to the operation “Record in or Consult MAC Address Table”. Specifically, the present embodiment is characterized by comprising means for sending said input frames to transmission links when the input frames have priority markings and the destination MAC addresses have been learned.

As illustrated in FIG. 41, the frames, whose output port has been decided by the forwarding process, are read in order to determine whether the frames have priority markings. In case of priority-marked frames, the switching hub forwards them to the high-priority transmit queue only if the destination MAC addresses of the frames are in the MAC Address Table (if they have been learned). Otherwise (if they have not been learned), the priority-marked frames are forwarded to the low-priority transmit queue.

As a result, even if there are frames with unlearned MAC addresses at the start of communication, the flooding is the same as the non-priority flooding in case of frames from conventional terminals, and does not affect communication between already communicating terminals with guaranteed maximum transmission capacity subject to priority processing. This is a safety measure designed for handling possible unlearned addresses. However, the maximum transmission capacity can be guaranteed if only the switching hubs of the present invention are located along the path between the terminals, and including previously existing hubs results in Best-Effort forwarding.

### Embodiment 14

FIG. 11 and FIG. 12 are used to explain that the above-described TCI can be used for frame priority marking in the switching hubs described in the twelfth embodiment and thirteenth embodiment.

In the TCI, 3 bits are allocated to priority, and when all the VLAN identifier field values are zero (0x000), the TCI tag does not represent relevance to a VLAN and the frames can be processed by devices (switching hubs) in a preferential manner. Such TCI tag-based priority is assigned to frames. By doing so, the frames can be processed by the switching hubs in a preferential manner, depending on the type of traffic.

For instance, when received frames are mapped to two transmit queues, frames of Level 5 or higher, which are illustrated in FIG. 12 (network management, audio, video, data with guaranteed transmission capacity), are allocated to a queue corresponding to high priority, and frames below Level 5 are allocated to a queue corresponding to low priority. However, to guarantee maximum transmission capacity, it is necessary that management is performed by the network resource management device. In addition, when Priority Level 5 and higher (Levels 5, 6, 7) are processed as a single priority queue, differences in priority between them disappear and they are handled as one level.

Based on such TCI tag-based priority marking, frames can be processed by switching hubs and sent to transmission links in a preferential manner. It should be noted that priority-marked frames, which are described below, are allocated to Priority Level 5 or higher while other (Best Effort-type) frames are allocated to levels below Priority Level 5.

### Embodiment 15

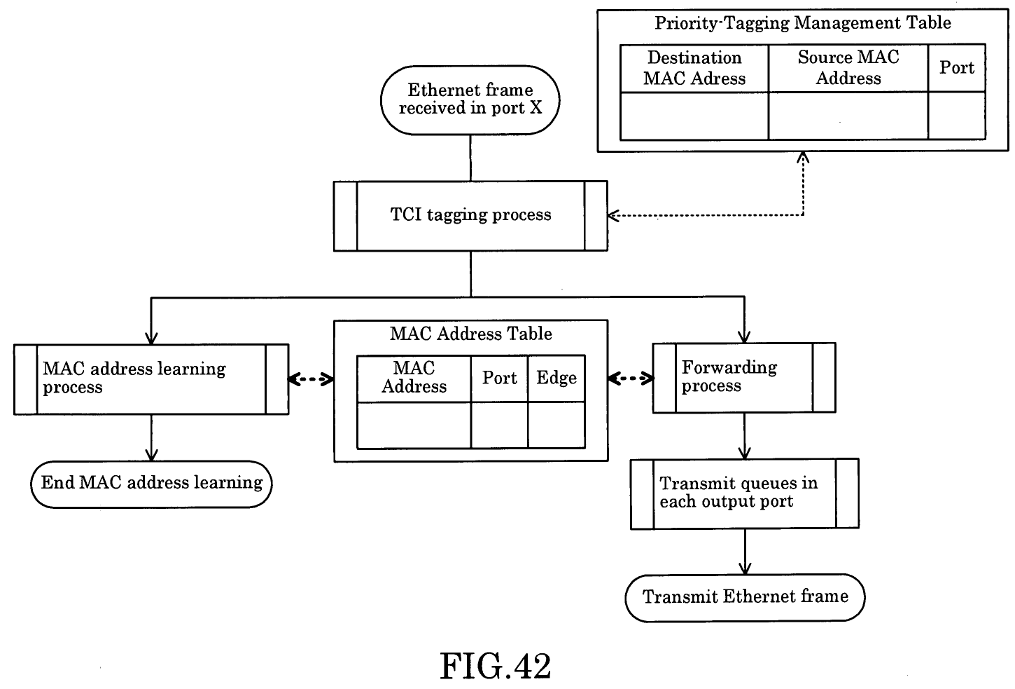

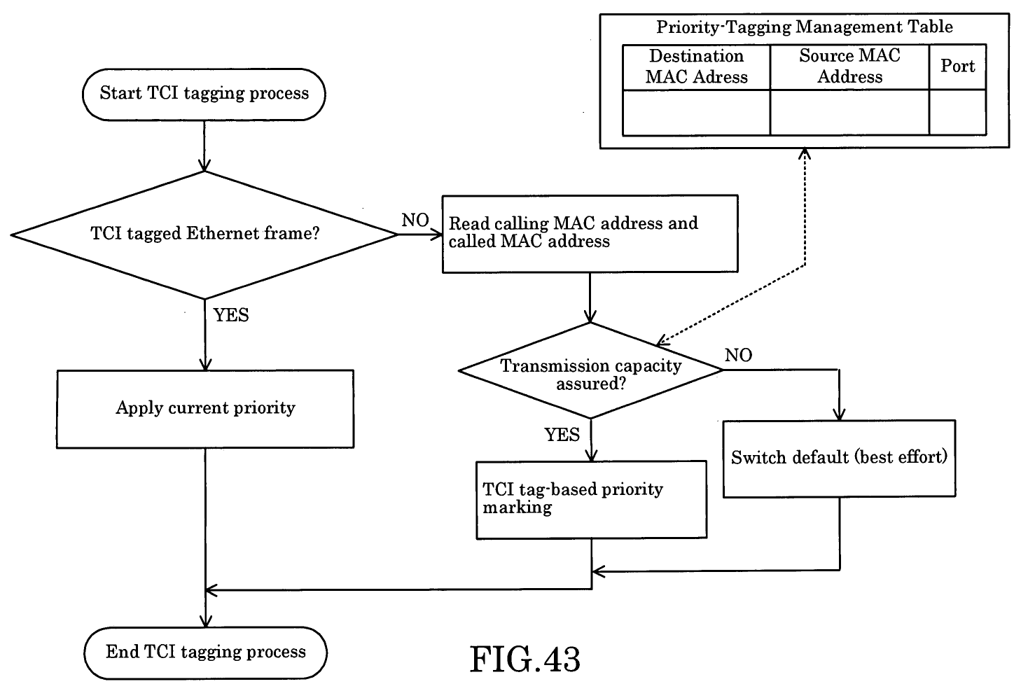

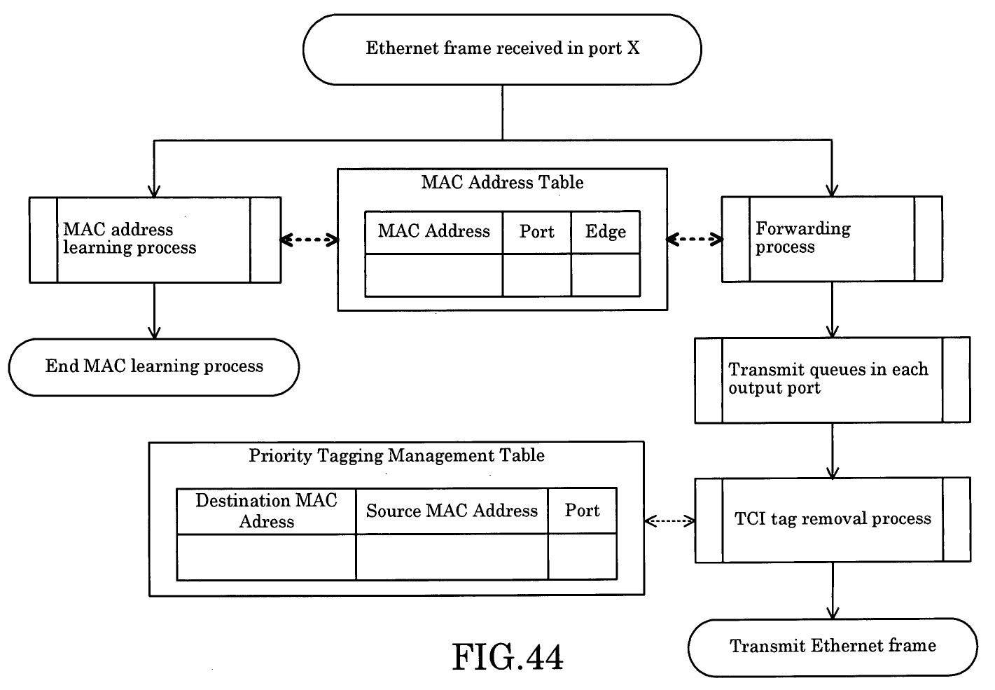

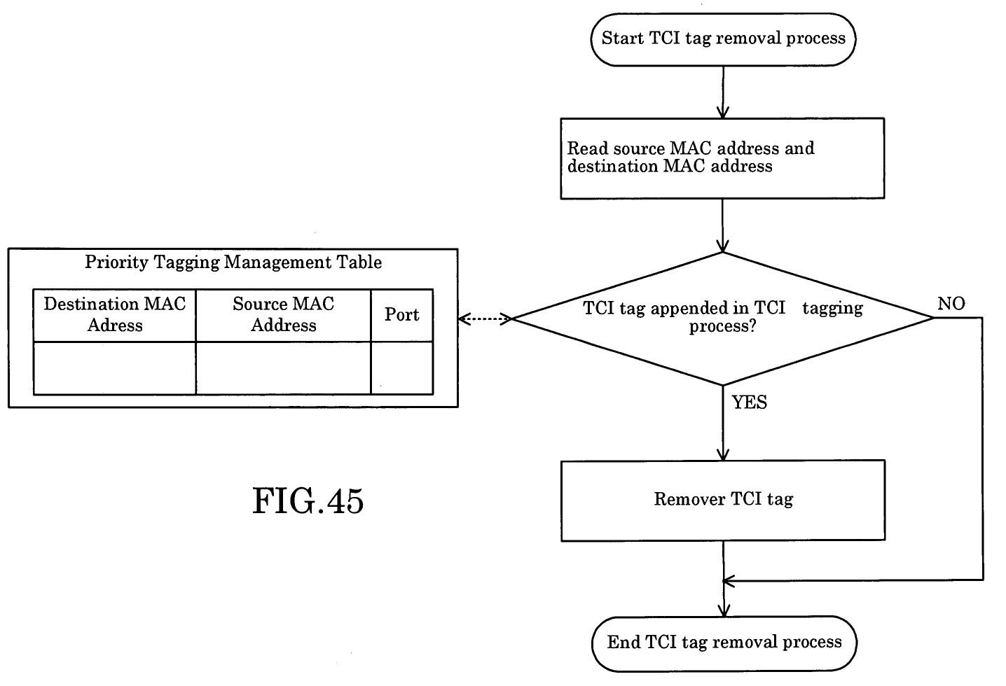

FIG. 36 and FIG. 42 through FIG. 45 are used to explain the operation of switching hubs in a fourteenth embodiment, wherein TCI is attached or removed in switching hubs at the edge of the network in order to guarantee maximum transmission capacity for frames traveling to and from terminals that are not-TCI compliant. The thin dotted arrows (thin lines) in FIG. 42 and FIG. 44 refer to the operation “Consult Priority Tagging Management Table” and the thick dotted arrows (thick lines) refer to the operation “Record in or Consult MAC Address Table”. In addition, the dotted arrows in FIG. 43 and FIG. 45 refer to the operation “Consult Priority Tagging Management Table”. Specifically, in the present embodiment, TCI is attached or removed at the edge of the network in order to accommodate non-TCI compliant terminals.

If a terminal depicted in FIG. 36 is not a TCI-compliant terminal, switching hubs 23-1, 23-3, 23-6, and 23-7 at the transmit-side network edge, upon receipt of a frame from the terminal, read it to determine whether a TCI tag is attached thereto, as illustrated in FIG. 42 and FIG. 43. If a TCI tag is attached, they use the priority indicated on the TCI tag. If no TCI tag is attached, they check whether the frame is used for inter-terminal communication with guaranteed maximum transmission capacity by reading the destination MAC address and source MAC address of the frame and consulting a Priority Tagging Management Table, which stores input ports, source MAC addresses and destination MAC addresses of terminals that intend to establish end-to-end communication with guaranteed maximum transmission capacity.

For instance, a pair of MAC addresses of terminals (terminal 2-1 and terminal 2-8), for which maximum transmission capacity has to be guaranteed, are recorded by switching hub 23-11 in the Priority Tagging Management Table. The switching hub attaches a TCI tag to indicate priority only in case of frames used for communication with such terminals. Frames, for which maximum transmission capacity is not guaranteed (not recorded in the Priority Tagging Management Table), are handled as Best Effort type (switch default) frames.

As a result, when frames are sent for communication with non-TCI compliant terminals, the maximum transmission capacity can be guaranteed by attaching a TCI tag thereto in the switching hubs.

Based on the MAC address learning process, the switching hubs learn the source MAC addresses of frames that have a TCI tag attached thereto from the MAC Address Table. Because the output port of a received frame is determined by the forwarding process during MAC address learning, the switching hub maps it to the transmit queue corresponding to the priority assigned to the frame and forwards it to the next node.

When switching hub 23-7 at the receive-side network edge illustrated in FIG. 36 sends a frame transmitted from terminal 2-1 to terminal 2-8, as illustrated in FIG. 44 and FIG. 45, after picking the frame from the transmit queue in switching hub 23-7, the TCI tag attached to the frame, in the same manner as in the switching hubs at the transmit-side network edge, is examined to determine whether this frame is used for communication between terminals with guaranteed maximum transmission capacity.

For instance, a pair of terminal MAC addresses (terminal 2-1 and terminal 2-8), for which maximum transmission capacity has to be guaranteed, and the ports to which the terminals are connected, are recorded by switching hub 23-7 in the Priority Tagging Management Table. Switching hubs remove the TCI tags from TCI-tagged frames only in case of frames used for communication with such terminals. All other frames are transmitted as is.

As can be seen from the above, even in case of frames used for non-TCI compliant terminals, switching hubs can guarantee maximum transmission capacity by pre-recording MAC addresses used for non-TCI compliant terminals in the Priority Tagging Management Table.

### Embodiment 16

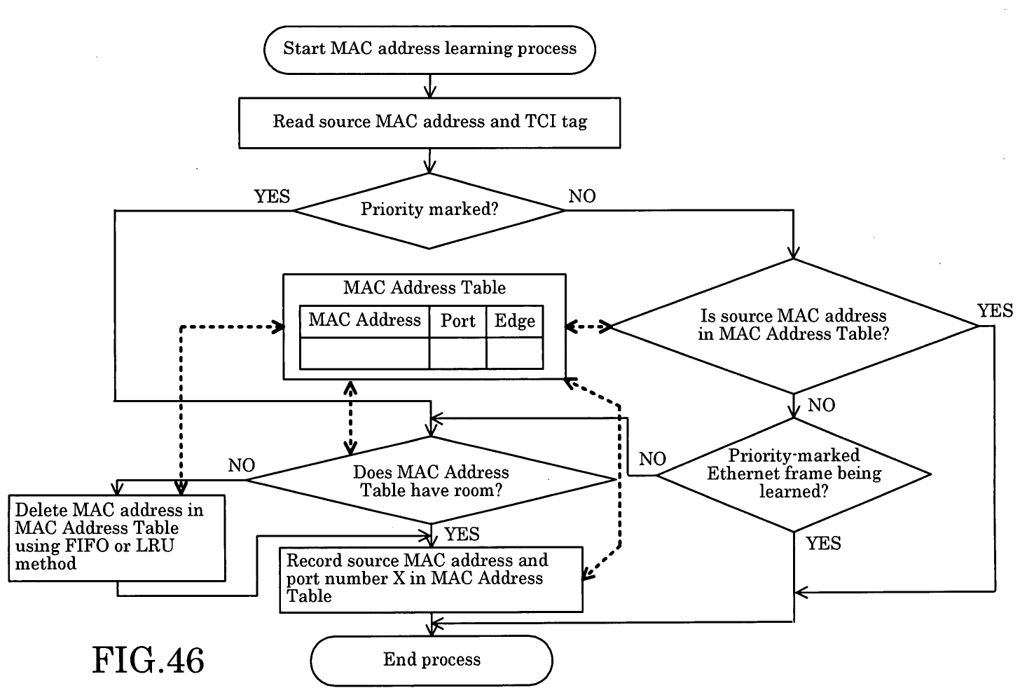

FIG. 36 and FIG. 46 are used to explain an example of operation wherein, in the switching hubs of the twelfth embodiment and thirteenth embodiment, the chances of flooding during communication with guaranteed maximum transmission capacity are reduced based on preferential processing of learning of source MAC addresses of frames assigned a high priority. It should be noted that the dotted arrow in FIG. 46 refers to the operation “Record in or Consult MAC Address Table”. Namely, in this embodiment, the MAC address learning of priority-marked frames is carried out in preference to frames bearing no priority markings.

When communication from terminal 2-1 to terminal 2-8 is initiated, switching hub 23-1 receives a TCI-tagged priority-marked frame from terminal 2-1.

Switching hub 23-1, which receives the TCI-tagged frame in port #X, reads the destination MAC address, the source MAC address, and the TCI tag, as illustrated in FIG. 46.

Regardless of whether they have been learned or not, frames with priority markings are learned on a preferential basis in accordance with the MAC address learning process illustrated in FIG. 46 using the MAC Address Table of the switching hub. In case of frames without priority markings, completion of learning based on the MAC Address Table causes the MAC address learning process to terminate, and, if it is not complete, source MAC addresses are recorded in the MAC Address Table only when priority-marked frames are not being learned.

Because the frame sent from terminal 2-1 bears a priority marking, switching hub 23-1 learns the MAC address of terminal 2-1 on a preferential basis.

In conventional MAC address learning, an address does not necessarily have to be learned at the time of frame reception. While communication is not rendered impossible if it is not learned, flooding occurs instead of communication being directed to a specific port. The address is learned when the peak of the traffic passes and the switching hub has time to learn. With respect to frames bearing a marking of high priority, incomplete learning of MAC addresses is prevented by conducting preferential MAC address learning illustrated in FIG. 46. In addition, when there is no room in the MAC Address Table, source MAC addresses are learned in the MAC Address Table on the FIFO (First In First Out) or LRU (Least Recently Used) basis, without waiting for the previously learned MAC address to age.

As indicated above, frames with guaranteed maximum transmission capacity are sent to transmission links by assigning them a priority marking, so that the source MAC addresses of the frames can be learned in the MAC Address Table in a preferential manner.

### Embodiment 17

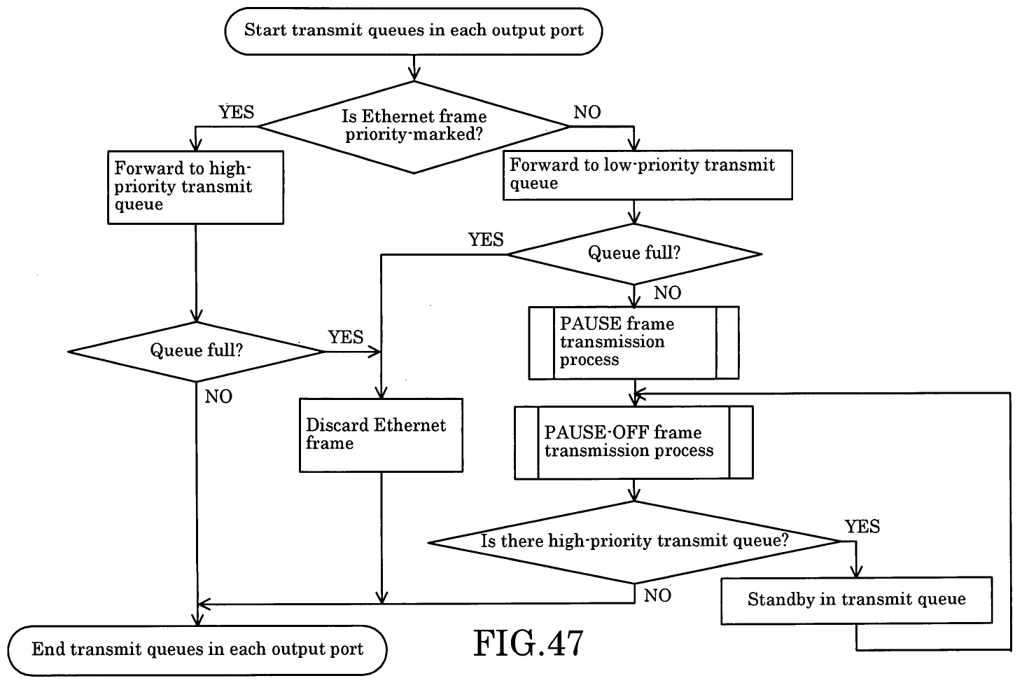

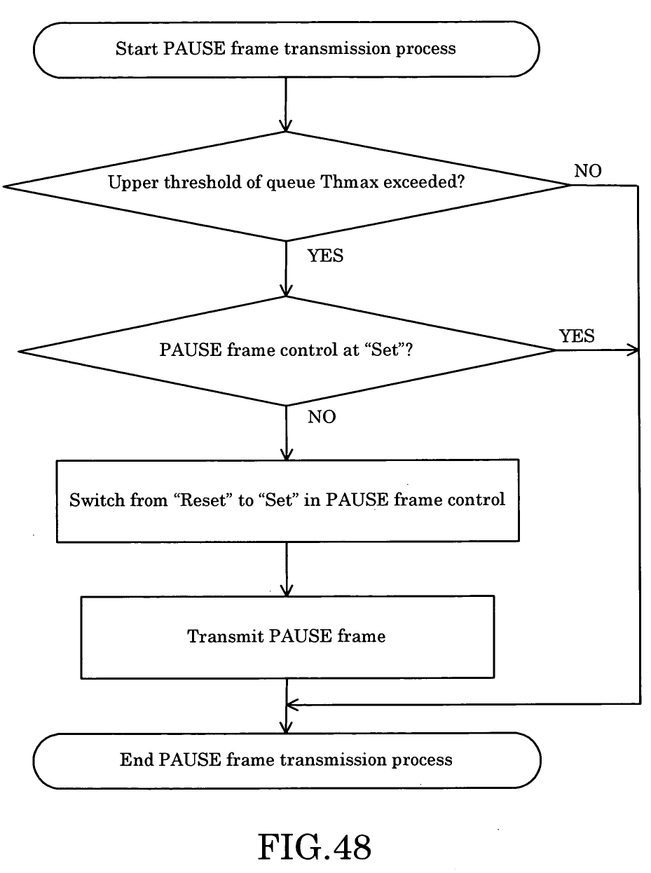

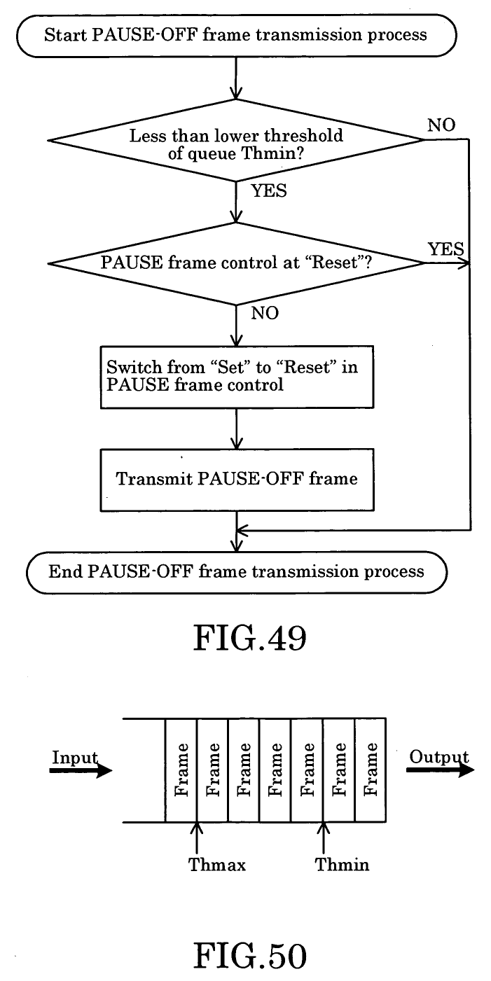

As communication traffic with guaranteed maximum transmission capacity increases, the Best Effort (non-priority) communication queue inside a switching hub increases in size and frames start getting dropped. FIG. 47 through FIG. 50 are used to explain operation wherein, in order to avoid this, switching hubs described in the twelfth embodiment and thirteenth embodiment use a PAUSE frame (IEEE 802.3x) to avoid buffer overflow (transmit queue overflow) in the transmit queue holding frames that are not subject to priority processing. Namely, a PAUSE frame that stops transmission to the corresponding input transmission link is sent when the buffer size used for frames not subject to priority processing is equal to or more than a predetermined value Thmax and a PAUSE-OFF frame, which removes the suspension of transmission to transmission links, is sent when it reaches a predetermined value Thmin (Thmax>Thmin).

As shown in FIG. 47 through FIG. 49, when the transmit queue holding frames that are not subject to priority processing becomes equal to or more than a predetermined value Thmax (upper threshold), PAUSE frame control, set to the default value “Reset”, is configured to “Set”, and a PAUSE frame is sent to the corresponding source MAC address, halting transmission from the terminal associated with that MAC address. In addition, when the transmit queue reaches the predetermined value Thmin (lower threshold), PAUSE frame control is set to “Reset”, and a PAUSE-OFF frame that removes the suspension of transmission is sent to the terminal again. Here, as illustrated in FIG. 50, Thmax>Thmin. Also, PAUSE frame control consists in controlling the transmission of PAUSE frames by comparing frames sent to transmit queues with a threshold value. As a result, when the total traffic of frames with guaranteed maximum transmission capacity increases, an accumulation of frames takes place in the low-priority transmit queue; however, there is no buffer overflow, and transmitting a PAUSE frame at the moment when the transmit queue reaches a predetermined value Thmax before the buffer overflows makes it possible to avoid the buffer overflow. The frame received prior to the transmission of the PAUSE frame is dropped if the transmit queue overflows. In the same manner, a frame would be dropped in case of overflow in the transmit queue that holds priority-marked frames, but normally this does not happen unless there is a capacity management failure or a malfunction. By doing so, the transmission capacity of the switching hubs can be utilized in an efficient manner.

### Embodiment 18

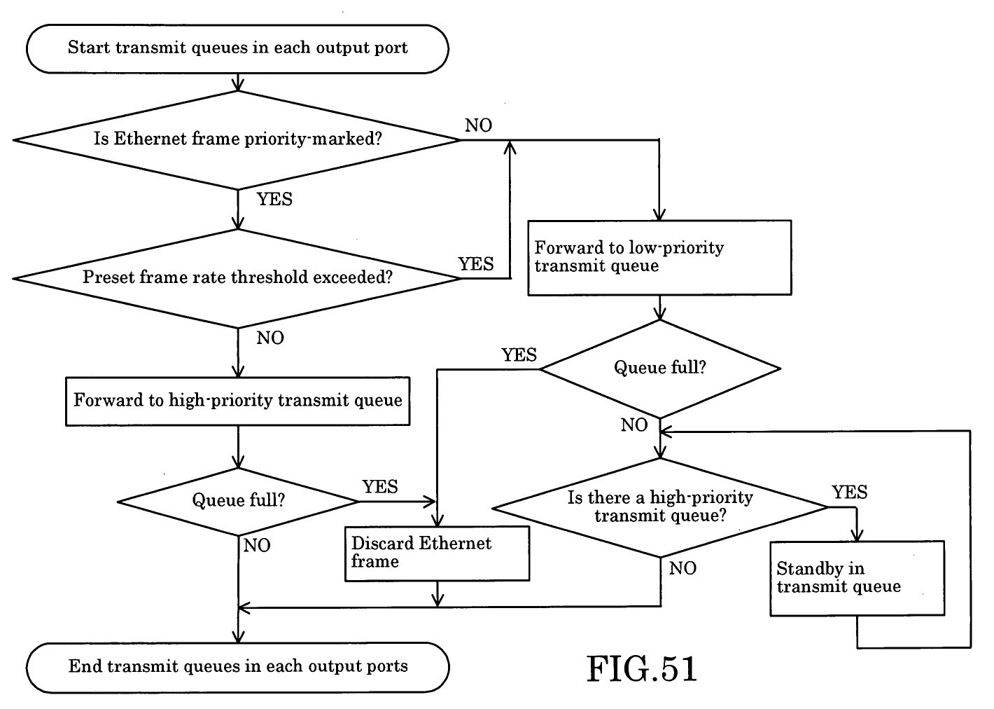

FIG. 51 is used to explain operation wherein, in the twelfth embodiment and thirteenth embodiment, in order to prevent terminals with guaranteed maximum transmission capacity from being affected by terminals in an abnormal condition, a threshold value is configured for the input frame rate of the switching hubs and the same processing as in case of non-priority (Best Effort type) frames is carried out if the threshold is exceeded in case of frames with priority markings. Namely, in the present embodiment, there are provided means for configuring the threshold value of the input frame rate of ports connected to terminals either manually or via access by the above-mentioned network resource management means, and frames having priority markings and frame rates exceeding the threshold value get non-priority treatment.

As illustrated in FIG. 51, the frames, whose output ports have been decided by the forwarding process, are read to determine whether the frames have priority markings. In case of priority-marked frames, prior to forwarding the frames to the high-priority queue, the switching hubs perform comparison in order to determine whether the frames exceed a preconfigured frame rate threshold. If they do not exceed the threshold, the switching hubs forward the frame to the high-priority queue. If they do exceed it, then the switching hubs forwards the frames to the low-priority queue and send them to the next node in the same manner as Best Effort type frames.

The threshold value sets the frame rate that has to be guaranteed in a transmission link. For instance, if a maximum transmission capacity of 10 Mbps is guaranteed for a certain transmission link, the threshold value will be 10 Mbps. Although this function may reside in any of the switching hubs, deploying it at the edge of the network is more effective.

### Embodiment 19

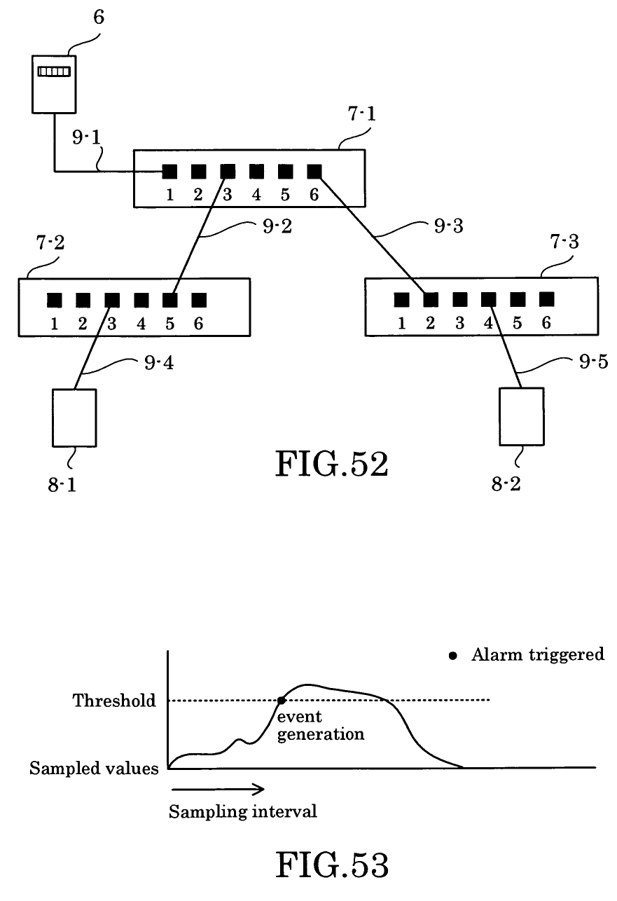

FIG. 52 through FIG. 55 are used to explain an eighteenth embodiment, which uses a threshold value for the input frame rate, set via access through the network resource management device, as well as SNMP, RMON, or RMON2, which are used as notification protocols in case this rate is exceeded.

In FIG. 52, 6 is SNMP-compliant network management device, 7-1 to 7-3 are switching hubs having SNMP and RMON functionality provided therein, 8-1 and 8-2 are terminals, and 9-1 to 9-5 are transmission links. In other words, the present embodiment makes use of a threshold value for the input rate, which is set via access from the network resource management device, as well as SNMP (Simple Network Management Protocol: RFC 1157), RMON (Remote Network Monitoring: RFC 2819), or RMON2 (Remote Network Monitoring MIB Version 2).

The switching hubs support Group 1 (Statistics), Group 2 (History), Group 3 (Alarm), and Group 9 (Events) with RMON functionality. Group 1 (Statistics) provides data on all the ports. Group 2 (History) provides data on ports during certain historical periods. Group 3 (Alarm) creates alarms and can set conditions for generating alarms upon detection of changes based on MIB objects. Group 9 creates events and can configure event actions that take place when an associated alarm is triggered.

Using the Alarm in RMON allows for MIB objects to be monitored in order to determine whether they are in the target transient state. The Alarm periodically takes samples from the variables of the objects and compares them with preset threshold values. Under RMON, there are two types of sampling, of which one is based on absolute values and the other is based on delta (differential) values. In the present embodiment, the sampled values are compared with the threshold values using the absolute value sampling technique illustrated in FIG. 53. When a sampled value exceeds an alarm threshold, an associated event is generated. The threshold values are set based on transmission capacity assured by the network resource management device. For instance, if the transmission capacity assured by the network resource management device is 10 Mbps, the threshold value is 10 Mbps. In addition, SNMP is used as a means of notifying the network resource management device when access to RMON takes place, when threshold values are set up, and when events are generated.

Network resource management device 6 is connected to port #1 of switching hub 7-1, with cascade connections provided between port #3 of switching hub 7-1 and port #5 of switching hub 7-2, as well as between port #6 of switching hub 7-1 and port #2 of switching hub 7-3. In addition, terminal 8-1 is connected to port #3 of switching hub 7-2 and terminal 8-2 is connected to port #4 of switching hub 7-3.

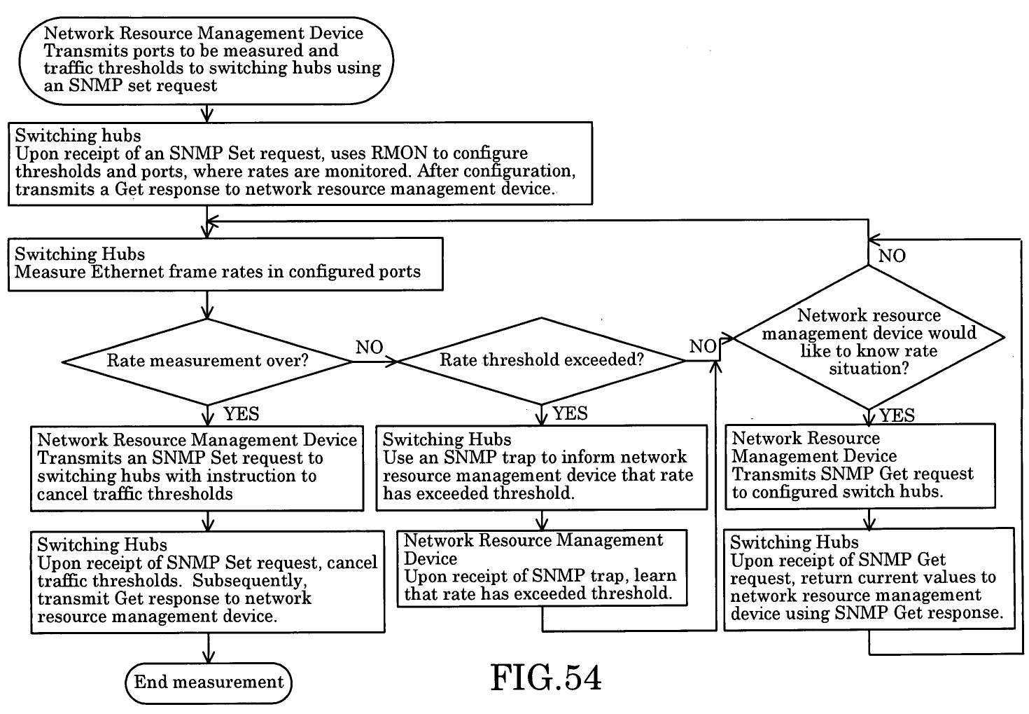

In such a network configuration, transmission capacity used when transmitting stream data from terminal 8-1 to terminal 8-2 is measured by a technique illustrated in FIG. 54 based on setting a rate threshold with the help of the network resource management device 6. Namely, as shown in FIG. 54, the network resource management device sends traffic thresholds and ports to be measured to the switching hubs using an SNMP Set request. Upon receipt of the SNMP Set request in a switching hub, RMON configures the threshold values and the ports to be measured, and, upon completion of configuration, transmits a Get response to the network resource management device. The rates of frames transiting through the configured ports are measured in the switching hubs.

At such time, when a rate exceeds the threshold value, the switching hub uses an SNMP trap to notify the network resource management device of the fact that the rate has exceeded the threshold value. Upon receipt of the SNMP trap, the network resource management device, which receives it, learns that the rate has exceeded the threshold value. In addition, if the network resource management device wants to learn about the rate situation when rates are not exceeding the threshold value, the network resource management device transmits an SNMP Get request to predetermined switching hubs. The switching hubs receiving the SNMP Get request return current values to the network resource management device using an SNMP Get response.

In addition, when rate measurement is over, the network resource management device transmits an SNMP Set request to the switching hubs in order to cancel the traffic threshold values. Upon receipt of the SNMP Set request in the switching hub, the threshold value is canceled, and a Get response is transmitted to the network resource management device.

In this manner, based on a threshold value configured using an SNMP Set request sent from the network resource management device 6, frame rates are measured in the ports of switching hubs located along a single path between terminal 8-1 and terminal 8-2 (port #3 of switching hub 7-2, port #3 of switching hub 7-1, and port #2 of switching hub 7-3). If a frame rate exceeds a preset threshold value, the switching hubs notify the network resource management device using an SNMP trap. As a result, the network resource management device can discover abnormalities in the frame send rates of the terminals. This provides a safeguard against excessive frame traffic.

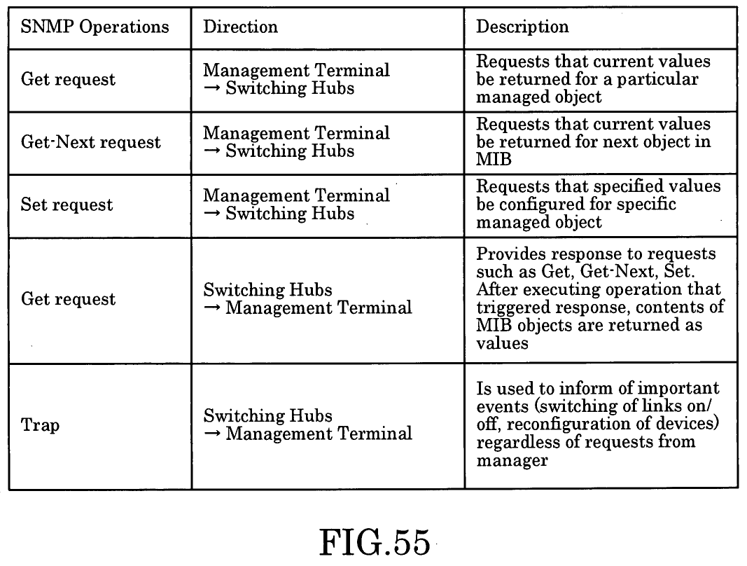

In addition, if the network resource management device inquires the switching hubs about the frame rate situation using an SNMP Get request, in response to such an inquiry, the switching hubs use an SNMP Get response to send current values to the network resource management device. Such frame rate measurement continues so long as the switching hubs do not receive an SNMP Set request to cancel the preset threshold value from the network resource management device and no SNMP Get response is sent to the network resource management device. Here, SNMP operation is illustrated in FIG. 55.

As described above, frame rate thresholds are set in the ports of all the switching hubs along the path and, when a frame rate exceeding a threshold value is received, the network resource management device can be notified using SNMP, RMON, or RMON2.

### Embodiment 20

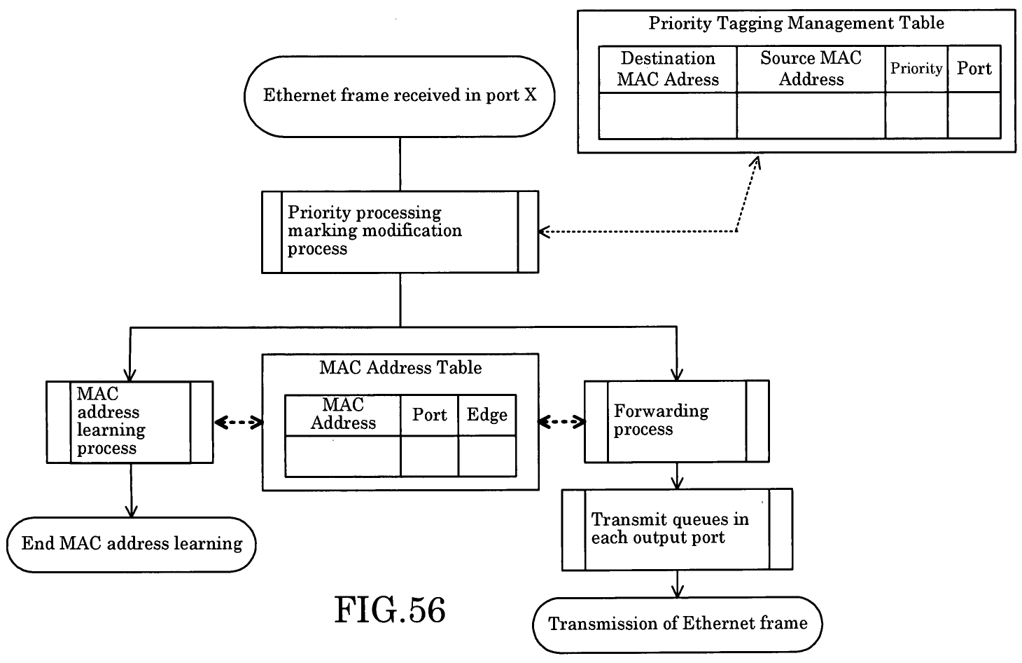

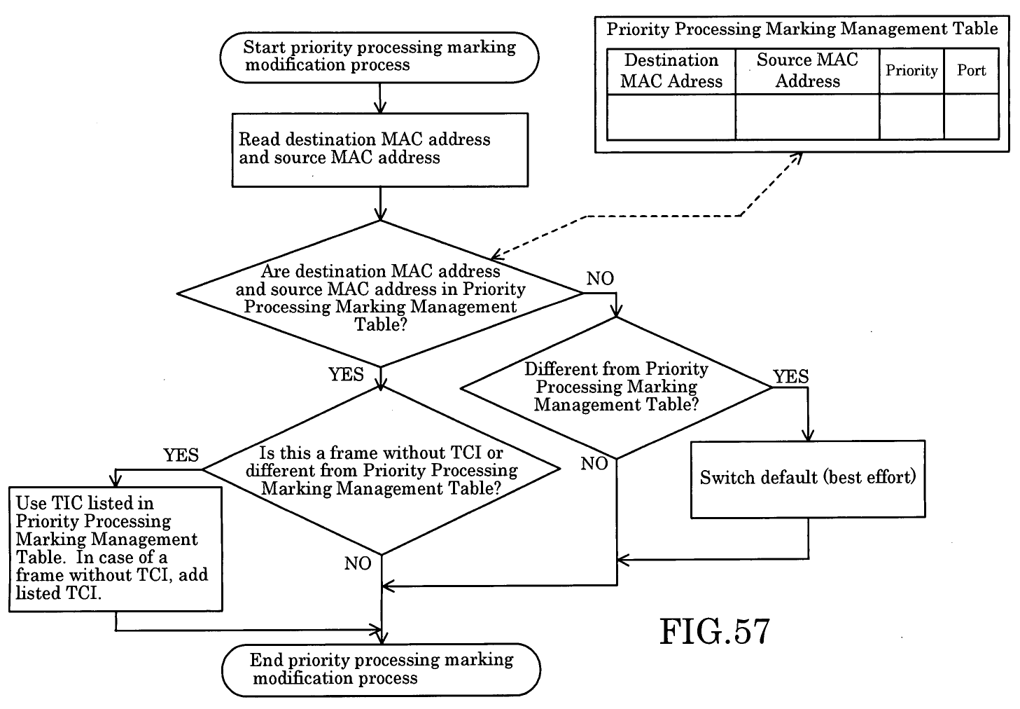

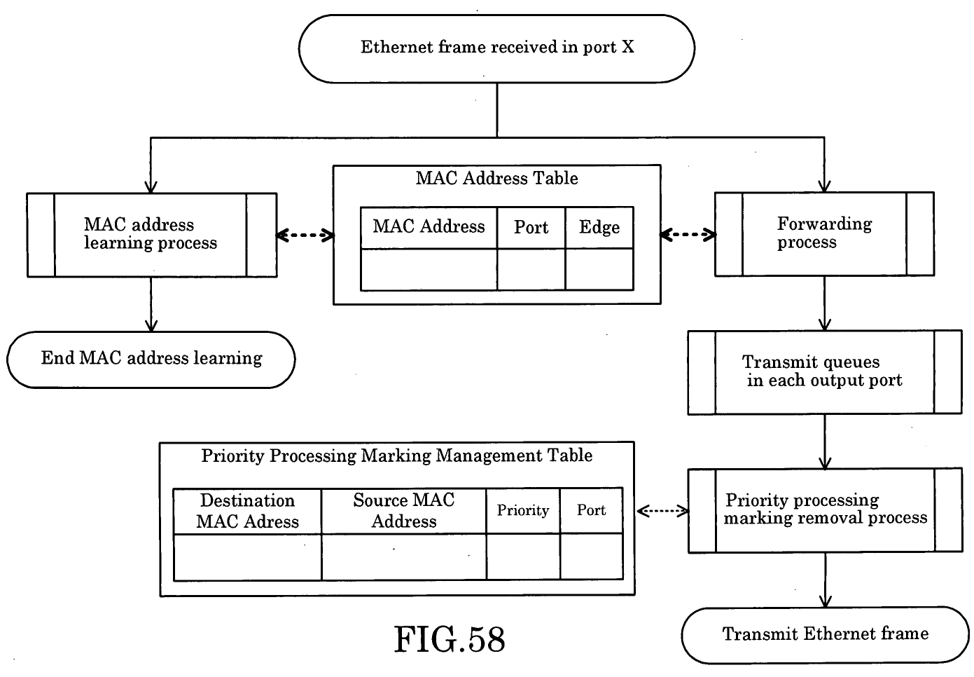

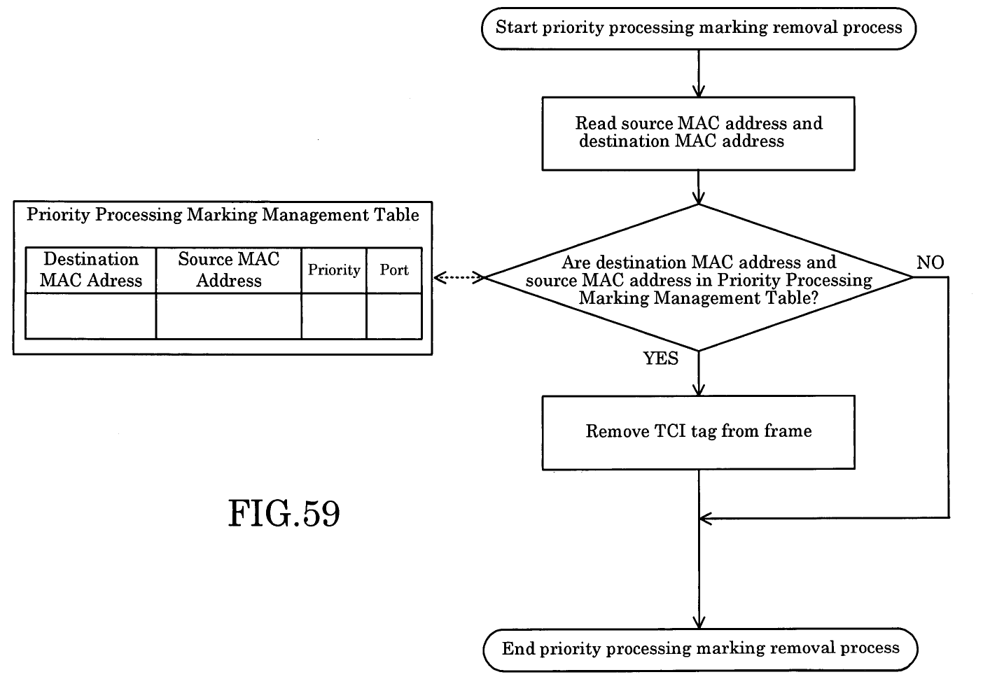

Now, explanations will be provided regarding a method for increasing the reliability of operation of initiating end-to-end communication between terminals with maximum transmission capacity or terminating communication with maximum transmission capacity, as well as a method for increasing the reliability of operation in case maximum transmission capacity cannot be assured due to malfunction or disrupted transmission. When switching hubs located at the edge of the network in the twelfth embodiment and thirteenth embodiment receive a notification from the network resource management device regarding priorities, source MAC addresses, and destination MAC addresses, for which maximum transmission capacity has to be guaranteed, this information is stored in a Priority Processing Marking Management Table. FIG. 56 through FIG. 59 are used to provide explanation of operation used for modifying the priority processing markings of frames having such MAC addresses. It should be noted that the thick dotted arrows (thick lines) shown in FIG. 56 and FIG. 58 refer to the operation “Record in or Consult MAC Address Table” and the thin dotted arrows (thin lines) refer to the operation “Consult Priority Processing Marking Management Table”. In addition, the dotted arrows in FIG. 57 and FIG. 59 refer to the operation “Consult Priority Processing Marking Management Table”. Namely, in the present invention, the priority processing marking of frames having such MAC addresses is activated at the edge of the network based on a Priority Processing Marking Management Table configured by the network resource management device. There is provided means which, upon receipt of a notification from the network resource management device regarding MAC addresses without guaranteed maximum transmission capacity, deletes information corresponding to these MAC addresses from the Priority Processing Marking Management Table and removes priority processing markings from these frames at the edge of the network.

Here, explanations are provided regarding the Priority Processing Marking Management Table.

The Priority Processing Marking Management Table, which is illustrated in FIG. 56 through FIG. 59, is used for recording MAC addresses with guaranteed maximum transmission capacity via telnet access, as well as through SNMP Set requests, by the network resource management device. Otherwise, priority is deleted from the Priority Processing Marking Management Table or changed by providing information on end-to-end MAC addresses without guaranteed maximum transmission capacity, thereby changing the priority marking of frames.

As a result, switching hubs that receive a notification of end-to-end MAC addresses with guaranteed maximum transmission capacity from the network resource management device activate the priority marking of frames that have these MAC addresses. Also, switching hubs that receive a notification of end-to-end MAC addresses without guaranteed maximum transmission capacity from the network resource management device can remove priority markings from frames that have these MAC addresses.

Explanations will be now provided regarding the operation of switching hubs located on the transmit-side network edge with respect to frames having priority markings (TCI-tagged frames).

When a TCI-tagged frame is sent to a network composed of switching hubs having such Priority Processing Marking Management Tables, as shown in FIG. 56 and FIG. 57, in one of the ports of a switching hub located on the transmit-side network edge, the Priority Processing Marking Management Table is consulted using a source MAC address and a destination MAC address.

If no end-to-end MAC addresses corresponding to the frame are recorded in the Priority Processing Marking Management Table, the frame is forwarded to the subsequent step of processing (MAC address learning and forwarding). The frame does not have a guaranteed transmission capacity, and, therefore, if the received frame has priority indicated therein, the priority marking is removed and the frame is assigned the switch default (best-effort).

If end-to-end MAC addresses corresponding to the frame have been recorded in the Priority Processing Marking Management Table, the frame is deemed to be a frame with guaranteed transmission capacity (frame subject to priority processing), and, therefore, the switching hub performs a comparison between the priority of the received frame and the priority recorded in the Priority Processing Marking Management Table. If the two priorities are the same, the frame is forwarded to the subsequent steps of processing as is and sent to the next node on a preferential basis.

If the priority of the received frame and the priority recorded in the Priority Processing Marking Management Table are different, communication with guaranteed maximum transmission capacity is made possible by changing it so as to match the information recorded in the Priority Processing Marking Management Table. Otherwise, if it differs from the Priority Processing Marking Management Table as a result of malfunction, disrupted communication, etc., the frame is forwarded to the subsequent steps of processing after replacing the priority with the priority recorded in the Priority Processing Marking Management Table. Thus, no inconsistencies arise in priority processing management for the frame.

Additionally, explanations will be now provided regarding operation used to perform priority processing (provision of maximum transmission capacity guarantees) of conventional frames (Best Effort frames or frames sent from terminals that are not compliant with TCI tagging) in switching hubs located at the transmit-side network edge.

When one of the ports of a switching hub equipped with a Priority Processing Marking Management Table located on the transmit-side network edge receives a conventional frame (lacking a TCI tag), as illustrated in FIG. 56 and FIG. 57, the Priority Processing Marking Management Table is consulted using a source MAC address and a destination MAC address. If no end-to-end MAC addresses corresponding to the frame are recorded in the Priority Processing Marking Management Table, the frame is considered destined for conventional best-effort type communication and is forwarded as is to the subsequent steps of processing (MAC address learning and forwarding).

If end-to-end MAC addresses corresponding to the frame are recorded in the Priority Processing Marking Management Table, the frame is deemed to be a frame with guaranteed transmission capacity, and, therefore, the switching hub gives the frame a TCI tag indicating the priority recorded in the Priority Processing Marking Management Table.

In this manner, frames sent from switching hubs located at the transmit-side network edge are forwarded to the receive-side network edge via the switching hubs of the network.

Next, explanations are provided regarding switching hub operation at the receive-side network edge, where frames are transmitted to terminals that are not compliant with TCI tagging.

After picking up a frame from a transmit queue, a switching hub located at the receive-side network edge, as illustrated in FIG. 58 and FIG. 59, consults the Priority Processing Marking Management Table using a source MAC address and a destination MAC address. The switching hub located at the receive-side network edge keeps a pair of end-to-end terminal MAC addresses with guaranteed maximum transmission capacity, as well as the ports to which the terminals are connected, pre-recorded in the Priority Processing Marking Management Table. At the start of communication with guaranteed transmission capacity, the network resource management device is notified of the fact that the end-to-end terminals are not compliant with TCI tagging. The switching hubs remove the TCI tags from TCI-tagged frames only in case of frames used for communication with such terminals. All other frames are transmitted as is.

As can be seen from the above, the switching hubs attach the priority recorded in the Priority Processing Marking Management Table to the received frames, and, therefore, it is possible to modify priority during the end-to-end transmission and reception. In addition, processing performed by the switching hubs consists only in modifying priority and frame forwarding can be carried out without affecting TCI-tagged frames sent by terminals belonging to VLANs.

As explained above, the present invention permits implementation of inter-terminal transmission with guaranteed capacity without control over hubs, based on the single-path configuration function of networks composed of switching hubs with an MAC address learning function and centralized management of transmission capacity. It has the advantage of eliminating the need for conventional control over hubs along the path and for configuring paths beforehand. As a result, the communication procedure can be simplified and device configuration can be simplified as well, which makes it possible to alleviate the network load.

In addition, pre-allocation of transmission capacity to currently unused communication paths that may be switched to in the future ensures maximum transmission capacity even in network environments based on the spanning tree protocol. This provides the ability to construct high-reliability networks and improve the quality of services offered to users.

Furthermore, as a result of introducing priority control into processing performed by switching hubs equipped with an MAC address learning function and a priority processing function and sending priority-marked frames used in inter-terminal communication with guaranteed maximum transmission capacity to transmission links on a preferential basis, conventional Best Effort type terminals get non-priority treatment, thereby avoiding the influence of traffic from conventional terminals, and, even if the two types of terminals do co-exist, communication with guaranteed maximum transmission capacity is feasible so long as only the switching hubs of the present invention are located between the terminals. In addition, input frames are sent to transmission links on a preferential basis only if they have priority markings and the destination MAC addresses have been learned. As a result, even if there are frames with unlearned MAC addresses at the start of communication, the flooding is the same as the non-priority flooding in case of frames from conventional terminals and it is possible to avoid adverse influence on communication between already communicating terminals with guaranteed maximum transmission capacity, which are subject to priority processing. Consequently, equipping conventional networks with the switching hubs of the present invention permits implementation of networks with co-existing conventional Best Effort type terminals and terminals with guaranteed maximum transmission capacity without making drastic changes, which makes it possible to address the needs of various users in a flexible manner and improve the quality of services offered to the users.

1. A transmission capacity allocation method for configuring a path with guaranteed transmission capacity between a call request terminal and a call requested terminal via one or more switching hubs learning respective MAC (Media Access Control) addresses of terminals in communication with each other and configuring a single path between learned terminals, wherein:
network resource management means managing connections between the terminals and the switching hubs, as well as between the switching hubs, and transmission capacity of transmission links associated with the connections, is provided on a network;
the call request terminal transmits a call request containing information on the transmission capacity whose allocation is requested in order to perform communication, along with its own terminal address and the address of the call requested terminal;
the network resource management means, in response to the call request from the call request terminal, makes an assessment as to whether transmission capacity to be used can be assured along the path traversing switching hubs between the call request terminal and the call requested terminal and transmits the call request to the call requested terminal if it can be assured, or transmits an incoming call rejection to the call request terminal if it cannot be assured;
the call requested terminal transmits a receive acknowledgement to the call request terminal through the network resource management means if it is itself communication-enabled, and transmits a call rejection if it is itself communication-disabled;
the network resource management means, along with forwarding a receive acknowledgement or a call rejection from the call requested terminal to the corresponding call request terminal, releases transmission capacity assured for the call request associated with the call rejection when the call rejection is received from the call requested terminal;
the call request terminal, upon receipt of the receive acknowledgement from the call requested terminal, recognizes that communication with guaranteed transmission capacity has been established and initiates transmission of data frames to the call requested terminal;
the call request terminal or the call requested terminal, upon completion of communication, transmits a clear request to a peer terminal via the network resource management means; and,
upon receipt of the clear request, the network resource management means releases transmission capacity in case transmission capacity corresponding to the clear request has been assured.

2. The transmission capacity allocation method according to claim 1, wherein:
during communication with the call requested terminal, if necessary, the call request terminal requests changes in the transmission capacity of the communication path, and,
in response to this request, the network resource management means changes the transmission capacity of the communication path to the extent that the maximum assurable capacity is not exceeded.

3. The transmission capacity allocation method according to claim 1, wherein:
along with the receive acknowledgement, the call requested terminal requests allocation of transmission capacity in the direction of the call request terminal from the call requested terminal, and
in response to this request, the network resource management means makes an assessment as to whether the transmission capacity can be assured and notifies said call requested terminal of the results.

4. The transmission capacity allocation method according to claim 1, wherein:
the call request terminal is a terminal carrying out stream data delivery service,
the call requested terminal, prior to receiving the stream data delivery service, issues a notification of completion of preparations for receiving the delivery service using a broadcast frame or a frame destined for the call request terminal, and,
in response to the notification, the switching hubs along the path between the call request terminal and the call requested terminal finish learning the MAC address of the call requested terminal.

5. The transmission capacity allocation method according to claim 1, wherein:
while communication is in progress, at intervals within the aging time of the MAC address learning function of the switching hubs on the network, the call requested terminal transmits the data of at least one frame to the call request terminal, and
the switching hubs along the path between the call request terminal and the call requested terminal continue learning the MAC address of the above-mentioned call requested terminal using the data of at least one frame.

6. The transmission capacity allocation method according to claim 1, wherein:
the network resource management means manages the usage status of VLAN (Virtual Local Area Network) identifiers represented by TCI (Tag Control Information), and, when a receive acknowledgement is forwarded from the call requested terminal to the call request terminal, along with attaching a VLAN tag containing TCI corresponding to an unused VLAN identifier to the receive acknowledgement, stores the VLAN identifier as being in use;
the call request terminal reads the VLAN identifier from the VLAN tag attached to the receive acknowledgement obtained from the network resource management means and, when transmitting a frame to the call requested terminal, attaches a VLAN tag thereto that corresponds to the VLAN identifier that has been read;
if a VLAN tag is attached to the received frame, the switching hubs learn the source MAC address and the VLAN identifier as a pair when carrying out MAC address learning for the frame and set the VLAN identifier with a time-out period in the input ports that received the received frame and the output ports selected during forwarding;
the call request terminal, in order to maintain the VLAN set up by the switching hubs, transmits one or more frames, to which VLAN tags corresponding to the VLAN are attached, within the time-out period;
upon receipt of a frame with a VLAN tag attached thereto from the call request terminal, the call requested terminal reads the VLAN identifier from the VLAN tag, and, when a frame is transmitted to the call request terminal, a VLAN tag corresponding to the VLAN identifier that has been read is attached thereto;
when the call request terminal or the call requested terminal cuts off communication with a peer terminal, it transmits a clear request to the network resource management means by attaching thereto a VLAN tag corresponding to the VLAN identifier that has been used for communication and stops attaching VLAN tags to frames upon transmission of the clear request; and,
upon receipt of the clear request with a VLAN tag attached thereto, the network resource management means stores the VLAN identifier as being unused.

7. The transmission capacity allocation method according to claim 1, wherein transmission capacity is allocated in advance even to currently unused communication paths that may be switched to in the future based on the spanning tree protocol, in accordance with which networks are rebuilt so as not to form loops logically even if the physical network does form a loop.

8. The transmission capacity allocation method according to claim 7, wherein, when the currently used communication path overlaps with a currently unused communication path that may be switched to in the future, allocation of transmission capacity to said currently unused communication path is prohibited.

9. The transmission capacity allocation method according to claim 1, wherein, when the call request terminal issues a request for multicast communication, transmission capacity is assured along the transmission links of each path used for the requested multicast communication.

10. The transmission capacity allocation method according to claim 1, wherein the network resource management means uses IGMP (Internet Group Management Protocol), GMRP (GARP Multicast Registration Protocol), or GVRP (GARP VLAN Registration Protocol) to perform address management during multicast delivery of stream data.

11. The transmission capacity allocation method according to claim 1, wherein, in order to transmit information regarding correspondents, transmission capacity, assurability of capacity, acceptance/rejection of incoming calls, and release of capacity, the network resource management means and the terminals use SIP (Session Initiation Protocol).

12. The transmission capacity allocation method according to claim 1, wherein connection of the switching hubs and detection of the transmission capacity, configuration of the switching hubs via access by the network resource management means, as well as notification of the network resource management means by the switching hubs, are performed by the network resource management means and the switching hubs based on SNMP (Simple Network Management Protocol), RMON (Remote Network Monitoring), or RMON2 (Remote Network Monitoring MIB Version2).

13. The transmission capacity allocation method according to claim 1, wherein:
the co-existence of frames with guaranteed maximum transmission capacity and non-guaranteed Best Effort type frames is permitted,
with the call request terminal transmitting frames with guaranteed maximum transmission capacity by appending priority markings thereto,
such that the call request terminal, the network resource management means, and the call requested terminal can process transmission capacity allocation only for frames, to which the priority markings are appended.

14. A communications network comprising a plurality of terminals, one or more switching hubs that learn respective MAC (Media Access Control) addresses of the terminals in communication with each other and configure a single path between learned terminals, and network resource management means configuring a path traversing any one or more of the one or more switching hubs between the call request terminal and the call requested terminal amongst the plurality of terminals, wherein:
each one of the plurality of terminals comprises: means for transmitting a call request containing information on the transmission capacity whose allocation is requested in order to perform communication, along with its own terminal address and the address of the call requested terminal, when the terminal itself operates as a call request terminal; means for transmitting a receive acknowledgement when it is itself communication-enabled, and a call rejection when it is itself communication-disabled, to the call request terminal associated with a call request via the network resource management means when a call request is received and the terminal itself operates as a call requested terminal; means for recognizing that communication with guaranteed transmission capacity has been established and initiating transmission of data frames to the call requested terminal upon receipt of a receive acknowledgement from the call requested terminal when operating as a call request terminal; and means for transmitting a clear request to a peer terminal via the network resource management means upon completion of communication; and
the network resource management means comprises: means for storing the connection between the terminals and the switching hubs, as well as between the switching hubs, and the transmission capacity of the transmission links associated with this connection; means for consulting the storage means in response to a call request from a call request terminal and making an assessment as to whether the transmission capacity to be used can be assured along a path traversing switching hubs between a call request terminal and a call requested terminal; means for increasing the transmission capacity to be used in the storage means by an amount corresponding to said assurance and transmitting a call request from said call request terminal to said call requested terminal if, in accordance with the assessment results of the assessment means, it can be assured, or transmitting an incoming call rejection to said call request terminal if it cannot be assured; means for forwarding a receive acknowledgement or a call rejection from the call requested terminal to the corresponding call request terminal; means for releasing transmission capacity assured for the call request associated with the call rejection and withdrawing it from the storage means when a call rejection is received from the call requested terminal; and means for releasing transmission capacity and withdrawing it from the storage means when a clear request is received from the other terminal participating in communication in case transmission capacity corresponding to the clear request has been assured.

15. The communications network according to claim 14, wherein the network resource management means is provided in any one of the one or more switching hubs.

16. The communications network according to claim 14, wherein one or more switching hubs are connected to the tree structure, with the network resource management means located in the vicinity of the root (root) of the tree structure.

17. The communications network according to claim 14, wherein:
the plurality of terminals are terminals compliant with frames having guaranteed maximum transmission capacity and,
on the network, Best-Effort type terminals compliant only with frames having no guaranteed maximum transmission capacity may co-exist therewith and
the terminals compliant with frames having guaranteed maximum transmission capacity can have means for appending priority markings to frames with guaranteed transmission capacity.

18. The communications network according to claim 17, wherein:
each of the switching hubs comprises means for sending input frames, if the input frames have priority markings, to transmission links in preference to input frames without priority markings.

19. The communications network according to claim 18, wherein:
each of the switching hubs comprises means which, whenever input frames have priority markings and the destination MAC addresses have been learned, sends said input frames to transmission links in preference to input frames without priority markings.

20. The communications network according to claim 18, wherein each of the switching hubs comprises means for processing the MAC address learning of priority-marked frames in preference to frames without priority markings.

21. The communications network according to claim 17, wherein the three bits of TCI that represent priority are used for priority indication.

22. The communications network according to claim 21, wherein means for attaching or removing TCI from non-TCI-compliant frames is provided in switching hubs at the edge of the network.

23. The communications network according to claim 18, wherein each one of the switching hubs comprises means for sending a PAUSE frame that halts transmission to the corresponding input transmission links when the buffer size of frames not subject to priority processing becomes equal to or more than a predetermined value Thmax and sending a PAUSE frame that disables the suspension of transmission to the corresponding transmission links when a predetermined value Thmin (Thmax>Thmin) is reached.

24. The communications network according to claim 18, wherein each one of the switching hubs comprises means for configuring the threshold value of the input frame rate of ports connected to the terminals manually or via access by the network resource management means, as well as means for handling frames with priority markings and frame rates exceeding the threshold value as non-priority frames.

25. The communications network according to claim 18, wherein, amongst the switching hubs, hubs at the edge of the network comprise means which, upon receipt of a notification of source MAC addresses and destination MAC addresses for which the maximum transmission capacity is guaranteed from the network resource management means, activates the priority processing markings of frames with these MAC addresses, and, upon receipt of a notification of MAC addresses without guaranteed maximum transmission capacity from the network resource management means, removes the priority processing markings of the frames with these MAC addresses.

26. A network resource management device for configuring a path traversing one or more transmission links and one or more switching hubs between terminals on a network,
wherein the terminals are terminals comprising means for reserving transmission capacity to be used upon a call request,
the switching hubs are switching hubs with an MAC address learning function that learn the respective MAC (Media Access Control) addresses of terminals in communication with each other and configure a single path between the learned terminals,
with the network resource management device comprising:
means for storing connections between the terminals and the switching hubs, as well as between the switching hubs, and the transmission capacity of the transmission links associated with the connections;
means for consulting the storage means in response to the call request from the call request terminal and making an assessment as to whether the transmission capacity to be used can be assured along the path traversing switching hubs between the call request terminal and the call requested terminal;
means for increasing the transmission capacity to be used in the storage means by an amount corresponding to said assurance and transmitting a call request from said call request terminal to said call requested terminal if, in accordance with the assessment results of the assessment means, it can be assured, or transmitting an incoming call rejection to said call request terminal if it cannot be assured;
means for forwarding a receive acknowledgement or a call rejection from the call requested terminal to the corresponding call request terminal and means for releasing transmission capacity assured for the call request associated with the call rejection and withdrawing it from the storage means when a call rejection is received from the call requested terminal;
and means for releasing transmission capacity and withdrawing it from the storage means when a clear request is received from the other terminal participating in communication in case transmission capacity corresponding to the clear request has been assured.

27. The network resource management device according to claim 26, comprising means for managing the usage status of VLAN identifiers represented by TCI, wherein:
the managing means includes:
means for attaching a VLAN tag containing TCI corresponding to an unused VLAN identifier to a receive acknowledgement when a receive acknowledgement is forwarded from the call requested terminal to the call request terminal;
means for storing the VLAN identifier corresponding to the attached VLAN tag as being in use; and
means which, upon receipt of a clear request with the VLAN tag attached thereto, stores the VLAN identifier as being unused.
